(19) United States
(12) Patent Application Publication
(10) Pub. No.: US 2018/0189587 A1
(43) Pub. Date: Jul. 5, 2018

(54) TECHNOLOGIES FOR FEATURE DETECTION AND TRACKING

(71) Applicant: Intel Corporation, Santa Clara, CA (US)

(72) Inventors: Dipan Kumar Mandal, Bangalore (IN); Om J. Omer, Bangalore (IN); Lance E. Hacking, Spanish Fork, UT (US); James Radford, Santa Clara, CA (US); Sreenivas Subramoney, Bangalore (IN); Eagle Jones, Santa Clara, CA (US); Gautham N. Chinya, Hillsboro, OR (US)

(73) Assignee: Intel Corporation, Santa Clara, CA (US)

(21) Appl. No.: 15/826,524

(22) Filed: Nov. 29, 2017

(30) Foreign Application Priority Data
Dec. 29, 2016 (IN) 201641044794

(51) Int. Cl. G06K 9/00; G06K 9/46; G06K 9/20; G06K 9/62

(52) U.S. Cl. CPC G06K 9/00973; G06K 9/46; G06K 9/6202; G06K 9/6267; G06K 9/2054

(57) ABSTRACT

Aspects of the present disclosure relates to technologies (systems, devices, methods, etc.) for performing feature detection and/or feature tracking based on image data. In embodiments, the technologies include or leverage a SLAM hardware accelerator (SWA) that includes a feature detection component and optionally a feature tracking component. The feature detection component may be configured to perform feature detection on working data encompassed by a sliding window. The feature tracking component is configured to perform feature tracking operations to track one or more detected features, e.g., using normalized cross correlation (NCC) or another method.

### CROSS-REFERENCE TO RELATED APPLICATIONS

This present application claims the benefit of, and priority to, Indian Patent Application No. 201641044794, filed on Dec. 29, 2016, the entire disclosure of which is incorporated herein by reference.

### FIELD

The present disclosure generally relates to feature detection and tracking technologies and, in particular, to feature detection and tracking technologies that are useful for computer vision applications such as Simultaneous Localization and Mapping (SLAM). Methods, devices, and systems utilizing such technologies are also described.

### BACKGROUND

Simultaneous Localization and Mapping (SLAM) is a computer vision task that is concerned with the computational problem of constructing and/or updating a map of an environment while also keeping track of an agent/platform within that map. A wide variety of SLAM algorithms are known, and are often used to facilitate computer vision in the context of various platforms such as automated robots, self-driving vehicles, virtual reality (VR) headsets, augmented reality (AR) headsets, and the like. Many SLAM algorithms are tailored to resources available to the platform on which they are implemented. For example a visual SLAM algorithm may be configured utilize image data provided by one or more cameras on a platform to determine a three dimensional map of the environment surrounding the platform, as well as the position (pose) of the camera within that map. In such instances the map of the environment and the three-dimensional (3D) position of the platform and/or a camera may be estimated by analyzing a temporal sequence of images provided by the camera, e.g., as the platform and/or the camera moves.

Feature (e.g., corner) detection is often an initial image processing step in many visual SLAM algorithms. A large number of feature (e.g., corner) detectors have therefore been developed, though practical implementation of such detectors remains challenging in some applications. For example some feature detectors for visual SLAM are configured to detect features in a 30 frames per second (30 FPS) video graphics array (VGA) image stream provided by a camera on a frame by frame basis. When such feature detectors perform a pixel by pixel determination as to whether any features (e.g., corners) are present in each frame, large quantities of compute cycles, input/output (I/O) operations, electric power, etc. may be consumed. Indeed despite enormous increases in computing power over time, many existing feature detectors can still consume much or even all of the processing bandwidth of a processor. Implementation of feature detectors for visual SLAM in software (e.g., by a general purpose processor) may also be too slow for latency sensitive applications, such as but not limited to VR, AR, and/or real-time feature detection/tracking applications.

Similar challenges exist with regard to other aspects of visual SLAM. For example in addition to one or more feature detectors, some systems for implementing visual SLAM may include one or more feature trackers to track the position of detected features in image data. Like the feature detectors noted above, many feature tracking techniques are computationally expensive, consume significant I/O operations, and/or consume significant electrical power.

Implementation of feature detection and/or feature tracking operations for visual SLAM therefore remains challenging in some applications. This is particularly true with regard to the implementation of visual SLAM on platforms with limited computing and/or power resources (e.g., mobile platforms such as smart phones, robots, laptop computers, tablet computers, etc.), and/or which are latency sensitive (e.g., AR, VR, real-time detection and/or tracking, etc.).

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1A is a block diagram of a system for performing feature detection using a visual SLAM algorithm consistent with the prior art.

FIG. 1B depicts one example of a neighborhood of pixels including a candidate pixel suitable for performing FAST corner detection consistent with the prior art.

FIG. 2A is a block diagram of one example of a system for performing feature detection and/or tracking consistent with the present disclosure.

FIG. 2B is a high level block diagram of a SLAM hardware accelerator (HWA) consistent with the present disclosure.

FIG. 3 is a block diagram of one example of a feature detection component of a SLAM HWA consistent with the present disclosure.

FIG. 4 is a flow diagram of example operations in accordance with one example method of performing feature tracking using a sliding window, consistent with the present disclosure.

FIGS. 5A-5H illustrate the use a sliding window during the performance of feature tracking consistent with example embodiments of the present disclosure.

FIG. 6A-6E stepwise illustrate the performance of feature detection operations on working data within a sliding window, consistent with the present disclosure.

FIG. 7 is a flow chart of example operations of an example method of performing feature detection including feature scoring consistent with the present disclosure.

FIG. 8 is a block diagram of an example feature tracking component consistent with the present disclosure.

FIG. 9 is a flow chart of operations of a method of performing feature tracking consistent with the present disclosure.

FIG. 10 is a flow diagram of example operations in accordance with one method of performing feature tracking using integer precision NCC.

FIG. 11 is a block diagram of a system for performing integer precision NCC consistent with the present disclosure.

FIG. 12 is a block diagram of a system for performing on the fly feature detection and tracking consistent with the present disclosure.

FIG. 13 is a flow diagram of example operations of one example of a method of performing on the fly feature detection and tracking consistent with the present disclosure.

### DETAILED DESCRIPTION

As discussed briefly in the background, feature (e.g., corner) detection is often an initial processing step in many computer vision processes, such as visual SLAM. One example of a feature detector that is suitable for use in SLAM is the Features from Accelerated Segment Test, also known as the FAST corner detector. Conventionally the FAST corner detector is implemented in software, i.e., by the performance of image processing operations by a general purpose processor.

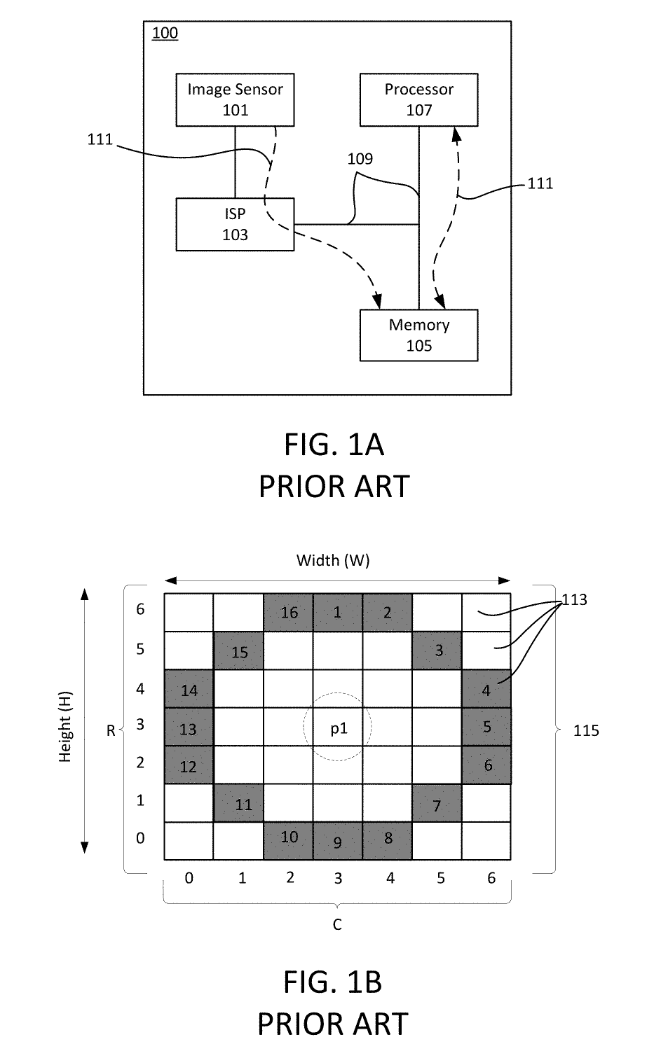

Although implementation of a FAST corner detector in software is well understood, the present disclosure will proceed to describe the operation of one example of FAST corner detector for the sake of clarity and context. Reference is therefore made to FIG. 1A which is a block diagram of one example prior art system 100 for performing FAST corner detection in software using a general purpose processor, e.g., in connection with visual SLAM. System 100 includes an image sensor 101, an image signal processor (ISP) 103, a memory 105, a processor 107, and a bus 109. Image sensor 101 is operable to transmit a sensor signal to ISP 103, which is operable to process the sensor signal to produce image data that is stored in memory 105. The image data may be stored as a data structure corresponding to a two dimensional (2D) field of pixels, also referred to herein as a digital image.

To perform FAST corner detection, processor 107 fetches (reads) image data corresponding to an entire neighborhood of pixels within the digital image is from memory 105. Processor 107 then performs FAST corner detection operations on a single candidate pixel in the neighborhood to determine whether the candidate pixel is a corner, and the resulting determination (output) is written to memory 105. The image data corresponding to the entire neighborhood of pixels under consideration is then discarded, and the processor fetches image data corresponding to an entirely new neighborhood from memory 105. Feature detection operations are then performed on the new neighborhood. The process iterates until many or all of the pixels in the digital image have been analyzed for “cornerness” by processor 107. The general flow of information through system 100 (i.e., from image sensor 101, to ISP 103, to memory 105, and to/from processor 107) is shown by hashed lines 111.

FIG. 1B depicts one example of a neighborhood 115 of pixels 113 upon which FAST corner detection operations may be performed in accordance with the prior art. Neighborhood 115 includes a plurality of pixel rows R and a plurality of pixel columns C. More specifically, neighborhood 115 includes seven pixel rows (R0-R6) and seven pixel columns (C1-C6), wherein each pixel row R includes seven pixels (R0,C0; R0,C1; R0,C2, etc.), and each pixel column C includes seven pixels (C0,R0; C0,R1; C0,R2, etc.). Neighborhood 115 is therefore the minimum size in which a Bresenham circle of radius 3 may be defined. Shaded blocks (numbered 1-16) are used in FIG. 1B to depict pixels 113 on the periphery of a Bresenham circle of radius 3, relative to a center pixel p1 (also referred to herein as a candidate pixel).

To perform FAST corner detection, processor 107 compares the intensity of each of the pixels (1-16) on the periphery of the Bresenham circle to the intensity (Iₚ) of candidate pixel p1, plus or minus a threshold (t). Processor 107 may classify candidate pixel p1 as a corner if there exists a set containing a threshold number (n) of contiguous pixels on the periphery of the Bresenham circle that each have an intensity that is greater than Iₚ+t, or which each have an intensity that is less than Iₚ−t.

Analysis of the “cornerness” of pixel p1 via the FAST corner detector may therefore involve fetching 49 pixels worth of image data from memory and the performance of up to 32 intensity comparisons—up to 16 for the comparison of the intensity of each of pixels 1-16 to Iₚ+t, and up to 16 for the comparison of the intensity of each of pixels 1-16 to Iₚ−t. Although all 32 comparisons may be performed on candidate pixel p1, optimizations of the FAST corner detector have been developed that can potentially reduce the number of intensity comparisons needed to determine whether a candidate pixel p1 is or is not a corner. For example by setting n to a sufficiently high value (e.g., 12), it can be determined that candidate pixel p1 is not a corner if the intensity of any one of pixels 1, 5, 9, or 13 in the Bresenham circle is not greater than the intensity of pixel p1+t or less than the intensity of p1−t. Processor 107 may therefore first compare the intensity of pixels 1, 5, 9, and 13 to Iₚ+/−t to determine whether the intensity of all of such pixels are or are not greater than Iₚ+t or less than Iₚ−t. If not, p1 may be quickly classified as not being a corner. Regardless, the performance of numerous intensity comparisons by processor 107 may still be needed to determine whether pixel p1 is or is not a corner.

In the context of the present disclosure, pixels are assumed to have a quadrilateral shape and that two pixels are “contiguous” to one another if one or more of their sides or corners are adjacent to (e.g., touch) one another. Pixel 2 in FIG. 1B is therefore contiguous with pixels 1 and 3, but is not contiguous with pixel 16. Likewise pixel 9 in FIG. 1B is contiguous with pixels 10 and 8, but is not contiguous with pixels 11 and 7. In contrast, the term “directly adjacent” is used herein to describe two or more pixels that have at least one adjacent side, top, and/or bottom. Accordingly pixel 8 in FIG. 1B is contiguous with pixels 9 and 7, but is directly adjacent to only pixel 9. Similarly, pixel 9 is contiguous with and directly adjacent to pixels 10 and 8.

It should also be understood that neighborhood 115 is but one neighborhood in a digital image under consideration and that p1 is but one pixel in such a neighborhood. To analyze the “cornerness” of each (or most) pixels in a digital image stored in memory 205, a large number of neighborhoods and candidate pixels similar to neighborhood 115 and pixel p1 may need to be analyzed by processor 107. This is particularly true when each neighborhood is a relatively small subset of pixels within the digital image under consideration. Moreover in the context of FIG. 1A it should be understood that following performance of FAST corner detection on pixel P1 in neighborhood 115, all the image data corresponding to neighborhood 115 is discarded, an image data corresponding to an entirely new neighborhood is read from memory, and FAST corner detection is performed on a candidate pixel in the new neighborhood. That process may iterate until the cornerness of all or most pixels in the image under consideration has been determined. Large numbers of compute cycles, I/O operations (i.e., reads of image data from memory), and/or electrical power may therefore be consumed as processor 107 performs FAST corner detection on a single digital image. Such issues may be compounded in instances where processor 107 is to perform FAST corner detection on a plurality of digital images, e.g., in a video stream provided by image sensor 101 and ISP 103.

Aspects of the present disclosure relates to technologies (systems, devices, methods, etc.) for performing feature detection and/or feature tracking based on image data. In embodiments, the technologies include or leverage a SLAM hardware accelerator (SWA) that includes a feature detection component and optionally a feature tracking component. The feature detection component may be configured to perform feature detection on working data encompassed by a sliding window.

Feature detection operations such as FAST corner detection may be performed on working data encompassed by a sliding window, e.g., using one or more feature detection processes as described herein. Use of the sliding window described herein can enable significant amounts of image data to be reused for feature detection operations. For example, unlike feature detectors which rely on the fetching of a completely new set of image data each time a feature detection operation is performed, the technologies described herein use at least a portion of previously fetched image data as working in multiple feature detection operations. Only a relatively small amount of new data may therefore need to be read from memory or otherwise input, prior to the performance of each feature detection operation.

In embodiments the technologies described herein include a feature detection array that is configured to perform feature detection operations on a plurality of candidate pixels within working data (e.g., by individual feature detection processors within the feature detection array). Performance of feature detection operations may therefore be offloaded from a general purpose processor of the system/device. The number of compute cycles needed to perform such operations may also be reduced, particularly in instances where the feature detection array includes a plurality of feature detection processors that perform feature detection operations on multiple candidate pixels in working data in parallel.

In further embodiments the technologies described herein may also enable the scoring of features detected in an image. For example in embodiments the technologies described herein may include one or more feature detection processors (e.g., in a feature detection array) that are configured to perform feature detection operations using a FAST corner detection methodology. The feature detection processors may be configured to classify a candidate pixel as a corner, e.g., by comparing the intensity (Iₚ) of the candidate pixel plus or minus a threshold (t) to the intensity of pixels on the periphery of a Bresenham circle of radius 3, as discussed above with regard to FIG. 1A. If a threshold number n of pixels on the periphery of the Bresenham circle each have an intensity value greater than Iₚ+t or less than Iₚ−t, the feature detection processor may classify the candidate pixel in question as a corner. In embodiments, the feature detection processor(s) may determine a corner strength score for a detected corner, wherein the corner strength score represents a degree to which it is believed that a detected corner is a corner. This may be accomplished, for example, by increasing or decreasing the threshold t used to classify a candidate pixel as a corner, and re-performing FAST corner detection on the candidate pixel using the adjusted threshold. That process may iterate until an adjusted threshold is used that does not result in the candidate pixel being classified as a corner. The highest threshold at which the candidate pixel was still classified as a corner may then be used as the corner strength score.

In embodiments the SLAM HWA also includes a feature tracking component that is configured to track one or more features detected by the feature detection component. In embodiments, one or more features detected by the feature detection component may be stored in a data structure (e.g., a detected feature list) in a memory that is shared by the feature detection component and the feature tracking component. The feature tracking component may be configured to sort features in the detected feature list in accordance with their pixel coordinates within a digital image. For example, the tracking component may be configured to sort detected features based on an order in which lines (also referred to as rows) of image data are produced (rastered) by an image sensor and/or an image signal processor (ISP). In instances where lines of image data are rastered from top to bottom, for example, the tracking component may be configured to sort detected features in the detected feature list by their vertical pixel coordinate. Detected features proximate an upper edge of a prior image may then be tracked by the tracking component first. Put in other terms, features in the detected feature list may be tracked in the same order in which they are predicted to appear in new image data, potentially reducing tracking latency. The tracking component may therefore be useful to track features in the detected feature list in real time (i.e., as new image data is provided), leading to the useful application of the technologies herein in real time and latency sensitive feature detection and/or tracking applications.

The feature tracking component may also be configured to perform feature tracking operations to track one or more detected features, e.g., using normalized cross correlation (NCC) or another method. In those instances the feature tracking component may include a tracking element and a detection element. The tracking element may be configured to identify a selected feature for tracking from a detected feature list, e.g., stored in a shared memory with the detection element. In such instances the detected feature list may include image data including features detected by a feature detection component, as well as a neighborhood (patch) of pixels around each detected feature. In embodiments, the tracking element may use image data containing a selected feature for tracking and its neighborhood as a “reference patch,” e.g., for the performance of NCC operations. With that in mind, the tracking element may be further configured to determine a predicted image location at which a selected feature is predicted to appear within new image data. The tracking element may cause the detection element to call (e.g., read) new image data corresponding to the predicted location, e.g., from a shared memory. The new image data may correspond to a plurality of neighborhoods of pixels (patches) within the new image that are at or around the predicted image location. In embodiments, the detection element may include a sliding window module that is configured to perform feature detection operations on each of those plurality of neighborhoods using one or more sliding windows, e.g., in much the same manner as the feature detection components described herein. Features detected by the detection element may be reported to the tracking component, e.g., as one or more test patches. The tracking element may compare the test patches and the reference patch using an NCC methodology. In embodiments, the tracking element may use an integer precision NCC methodology to compare the test and reference patches, potentially leading to further improvements.

The feature detection and/or tracking technologies described herein may be implemented in one or more electronic devices. As used herein, the terms “device,” “devices,” “electronic device” and “electronic devices” are interchangeably used refer individually or collectively to any of the large number of electronic devices that may implement or include feature detection and/or tracking technologies consistent with the present disclosure. Non-limiting examples of such devices include any kind of mobile device and/or stationary d1evice, such as cameras, cell phones, computer terminals, desktop computers, electronic readers, facsimile machines, kiosks, netbook computers, notebook computers, internet devices, payment terminals, personal digital assistants, media players and/or recorders, servers, set-top boxes, smart phones, tablet personal computers, ultra-mobile personal computers, wired telephones, autonomous robots, autonomous vehicles, virtual and/or augmented reality platforms (headsets, eyewear, etc.) combinations thereof, and the like. Such devices may be portable or stationary. Without limitation, in some embodiments the feature detection and/or tracking technologies described herein are implemented in or with one or more mobile electronic devices, such as one or more cellular phones, desktop computers, electronic readers, laptop computers, smart phones, tablet personal computers, wearable electronic devices, autonomous robots, autonomous vehicles, virtual and/or augmented reality platforms (headsets, eyewear, etc.

As used herein, the term “and/or” when used in the context of the two elements (A) and (B), means (A) or (B), or (A) and (B). Likewise, the term “and/or” when used in the context of three or more elements such as (A), (B), and (C), means (A) or (B) or (C), (A) and (B) or (C), (A) and (C) or (B), (B) and (C) or (A), or (A), (B), and (C).

The present disclosure may utilize perspective-based descriptions (e.g., top, bottom, in, out, over, under, and the like) to describe the relative position of one element to another. It should be understood that such descriptions are used to for the sake of clarity and ease of understanding, and are not intended to restrict the application of embodiments described herein to any particular orientation unless expressly indicated otherwise.

As used herein the phrases “in an embodiment” and “in embodiments” are used interchangeably to refer to one or more of the same or different embodiments. Furthermore the terms “comprising,” “comprises,” “including,” “includes,” “having” and the like, are interchangeably used herein in connection with descriptions of embodiments of the present disclosure, and are synonymous.

The terms, “first,” “second,” “third,” “new,” “previous” and the like are generally used herein to distinguish between elements, and not necessarily to describe a particular sequential or chronological order. It should be understood that such terms may be interchangeably used in appropriate circumstances, and that various the aspects of the present disclosure may be operable in an order other than which is explicitly described.

As used herein the terms “substantially” and “about” when used in connection with a value or range of values mean plus or minus 5% of the denoted value or the end points of the denoted range. To the extent ranges are recited, it should be understood that the ranges are not limited to the indicated end points but include each point therein and ranges between any two points therein as though such points and ranges are expressly recited. For example, the range 1 to 10 should be understood to include 2, 3, 4, etc., as well as the ranges 2-10, 3-9, etc.

As used in any embodiment herein, the term “module” may refer to software, firmware, circuitry, and combinations thereof, which is/are configured to perform one or more operations consistent with the present disclosure. Software may be embodied as a software package, code, instructions, instruction sets and/or data recorded on non-transitory computer readable storage mediums, which when executed may cause an electronic device to perform operations consistent with the present disclosure, e.g., as described in the methods provided herein. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, software and/or firmware that stores instructions executed by programmable circuitry. The modules may, collectively or individually, be embodied as circuitry that forms a part of one or more devices, as defined previously. In some embodiments one or more of the modules described herein may be in the form of logic that is implemented at least in part in hardware to perform feature detection and/or feature tracking operations consistent with the present disclosure

As used herein, the term “digital image” refers to a data structure including image data that may be represented as a two dimensional (2D) array of pixels. Each pixel in the image data may therefore be described by its corresponding pixel coordinates.

As used herein, the term “image data” refers to all or a portion of data within a digital image, e.g., provided by an image sensor and/or image signal processor (ISP).

As used herein the terms “image width” and “image height” mean the total width and height (in pixels) of a digital image, respectively, as defined by the resolution of the digital image.

As used herein the term “image edge” refers to a vertical or a horizontal edge of an image.

As used herein the terms “vertical access depth” and “VAdepth” are interchangeably used to refer to a threshold position along a vertical axis of a digital image. In contrast, the term “horizontal access width” and “HAwidth” are interchangeably used to refer to a threshold position along a horizontal access of a digital image.

As used herein the term “sliding window” refers to an amount of image data (working data) corresponding to a subset of pixels within a digital image under consideration. As will be explained, a (previous) sliding window may be “offset” or “redefined” so as to define a new sliding window that is offset in one more directions. The new sliding window may encompass a different subset of image data of an image under consideration than a previous sliding window. That is, the new sliding window may encompass new working data, wherein the new working data includes a portion of working data that was included in a previous sliding window, as well as new image data.

The sliding windows described herein may include one or more pixel rows and one or more pixel columns, such that they have an overall an overall shape. In some embodiments, the sliding windows described herein are quadrilateral in shape. In such instances the sliding windows have a sliding window width (SW_{W}) and a sliding window height (SW_{H}). The terms “sliding window height” and “SW_{H}” are interchangeably used to refer to the number of pixel rows included in working data encompassed by a sliding window. In contrast, the terms “sliding window width” and “SW_{W}” are interchangeably used to refer to the number of pixel columns included in working data encompassed by a sliding window.

In the context of hardware, the term “sliding window” is used to refer to working data that is present within a sliding window buffer, e.g., at a particular period in time. In such context, a sliding window may be “offset” or “redefined” by changing at least a portion of the working data within the sliding window buffer. Moreover in that context, the terms “sliding window width” and “sliding window height” refer to the amount (number) of pixel columns of image data (width) and amount (number) of pixel rows of image data (height) that may be stored in a sliding window buffer. As such, in embodiments the dimensions of a sliding window may be set by the size of a sliding window buffer.

The terms “current,” “first” “new,” “previous,” and “subsequent” when used in conjunction with the term “sliding window” are utilized for the sake of reference only. In particular, such terms are used to refer to different sliding windows (i.e., sliding windows that encompass different sets of working data) that are utilized at different periods of time. In the context of hardware, such terms may be understood to refer to working data that is or will be present within a sliding window buffer at different times. The term “first sliding window” therefore does not necessarily refer to the very first sliding window that is defined upon initiation of the analysis of image data consistent with the present disclosure. Rather, the term “first sliding window” is generally used to refer to a sliding window that was used prior to (e.g., immediately prior to) the use/definition of a new sliding window. Similarly, the term “new sliding window” is used herein to refer to a sliding window that is used after (e.g., immediately after) the use of a first sliding window. Moreover, the terms “previous sliding window” and “subsequent sliding window” are generally used herein to refer to a sliding window that was used prior to a first sliding window or after a current sliding window, respectively.

As used herein, the term “working data” refers to image data encompassed by a sliding window and, in the context of hardware, to working data that is or will be present within a sliding window buffer. Working data therefore includes all of the pixel rows and pixel columns (i.e., all of the image data) encompassed by a sliding window. The number of pixel rows in the working data is generally defined by the sliding window height, and the number of pixel columns in the working data is generally defined by the sliding window width.

The terms “first working data” and “new working data” are used herein to distinguish between working data that is encompassed by one or more sliding windows (or, in the case of hardware, a sliding window buffer) at different periods of time. In embodiments, the term “new working data” means working data in a sliding window that includes a combination of new data (i.e., new image data associated with an offset applied to a previous sliding window to define the new sliding window) and reuse data, i.e., a portion of working data that was included in one or more previous sliding windows. Depending on the circumstances, the reuse data may be “horizontal reuse data,” “vertical reuse data,” or a combination thereof, as described later.

As used herein, “horizontal reuse data” is one or more pixel columns of image data that was previous used in conjunction with a (e.g., first) sliding window, and which can be concatenated with new data to produce new working data for the performance of feature detection operations. In embodiments, horizontal reuse data is one or more pixel columns of image data stored in a reuse buffer, a sliding window buffer, or a combination thereof. In some embodiments, horizontal reuse data may be concatenated with new data by aligning pixel rows of the horizontal reuse data with corresponding pixel rows of a right most or left most pixel column of new image data.

As used herein the term “vertical reuse data” is one or more pixel rows of image data that was previous used in conjunction with a (e.g., first) sliding window, and which can be concatenated with new data to produce new working data for the performance of feature detection operations. In embodiments, vertical reuse data is one or more pixel row of image data stored in a reuse buffer, a sliding window buffer, or a combination thereof. In some embodiments, vertical reuse data may be concatenated with new data by aligning pixel columns of the vertical reuse data with corresponding pixel columns of an upper most or lower most pixel column of new image data.

As used herein, the term “offset” means a value that may be applied to pixel coordinates of all pixels in a (first) sliding window, so as to define a new sliding window that includes new working data. In embodiments, a vertical, horizontal, or diagonal offset may be used. As used herein, a “vertical offset” or “VO” is an offset that may be applied to pixel coordinates of all pixels in a first sliding window, so as to define a new sliding window that is vertically offset (upwards or downwards), relative to the first sliding window. A “horizontal offset” or “HO” is an offset applied to pixel coordinates of all pixels in a first sliding window, so as to define a new sliding window that is horizontally offset (left or right) from the first sliding window. A “diagonal offset” or “DO” is an offset that includes a HO and a VO. When used independently, a VO may be less than the sliding window height of a current sliding window. Likewise when used independently, a HO may be less than the sliding window width of a current sliding window. In the context of a diagonal offset, at least one of the HO component of the diagonal offset and the VO component of the diagonal offset may be less than the corresponding dimension (i.e., sliding window height, sliding window width) of a current sliding window.

As used herein, the terms “neighborhood” and “pixel neighborhood” are interchangeably used to refer to a minimum amount of image data needed to perform feature detection operations. In instances where image detection operations are or include FAST corner detection operations using a Bresenham circle of radius 3, a neighborhood is an amount of image data corresponding to a minimum of a 7×7 field of pixels (i.e., a 2D field containing 7 pixel rows that are 7 pixels long, and 7 pixel columns that are 7 pixels deep). In general, working data in the sliding windows described herein includes one or a plurality of pixel neighborhoods.

As used herein, the term “candidate pixel” refers to a pixel within a neighborhood upon which feature detection operations may be performed. Candidate pixels may be any pixel within working data that is surrounded by a neighborhood of pixels. For example in instances where FAST corner detection operations are performed using a Bresenham circle of radius 3, a candidate pixel is any pixel within working data that is bounded by three pixels on each of the candidate pixel's four sides (top, bottom, left, right) (See FIG. 1B).

One aspect of the present disclosure relates to a system for performing feature detection and/or tracking. Such systems may suitable for use in computer vision applications such as visual SLAM, or other applications in which the detection and/or tracking of features within image data may be desired.

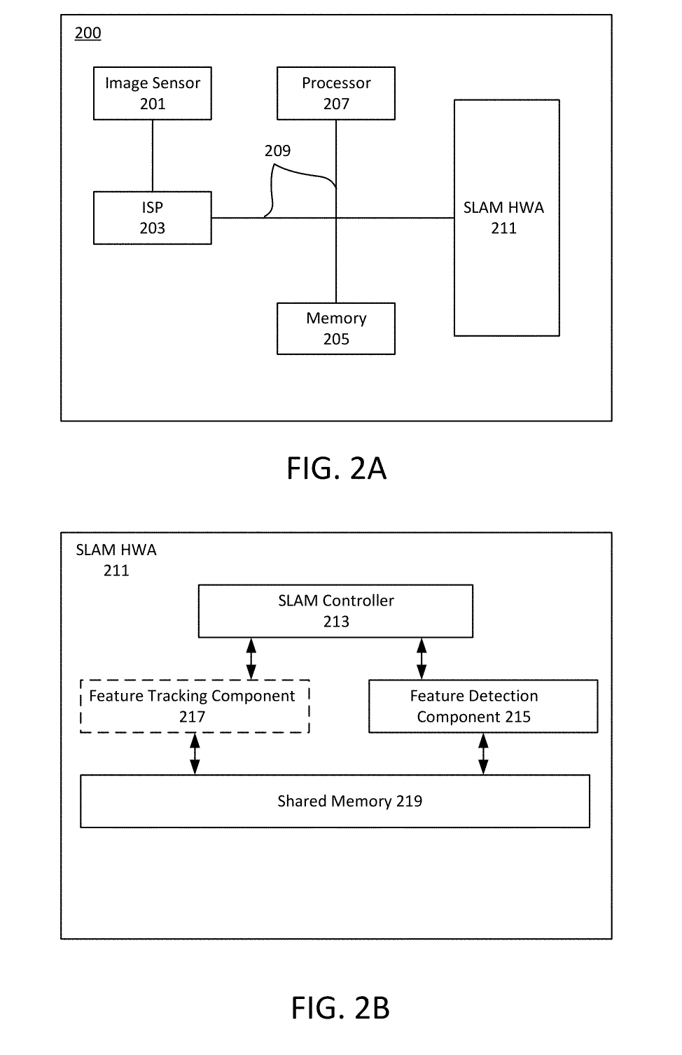

Reference is therefore made to FIG. 2A, which depicts a block diagram of one example of a system 200 for performing feature detection and/or tracking consistent with the present disclosure. As shown, system 200 includes, image sensor 201, image signal processor (ISP) 203, memory 205, processor 207, bus 209, and SLAM hardware accelerator (SLAM HWA) 211.

In general image sensor 201 and ISP 203 function to provide image data for the performance of feature detection and/or tracking operations consistent with the present disclosure. Image sensor 201 may therefore be any type of sensor that is suitable for detecting and conveying information that constitutes an image within its field of view. For example image sensor 201 may be configured to convert variable attenuation of light waves into one or more sensor signals. Non-limiting examples of suitable image sensors that may be used as image sensor 201 include one or more semiconductor charge coupled devices (CCD), flat panel detectors, active pixel sensors, e.g., in complimentary metal-oxide-semiconductor (CMOS) or n-type metal oxide semiconductor (NMOS) technologies, combinations thereof, and the like. In embodiments, image sensor 201 and/or ISP are configured to provide image data in the form of one or more digital images for the performance of feature detection and/or tracking.

As further shown in FIG. 2A sensor signals from image sensor 201 may be conveyed (e.g., via bus 209 or another communication modality) to ISP 203. ISP 203 may generally be configured to process the sensor signal(s) into image data corresponding to the environment imaged by sensor signal 201. A wide variety of ISP's are known and any suitable ISP may be used as ISP 203. It is noted that while FIG. 2A depicts image sensor 201 and ISP 203 as discrete components, such a configuration is not required. In some embodiments image sensor 201 and ISP 203 may integral with one another or an overarching sensor platform. For example, image sensor 201 and ISP 203 may each be included in a camera or other image sensor platform that is communicatively coupled to other elements of system 200.

Memory 205 may be any suitable type of computer readable memory. Example memory types that may be used as memory 205 include but are not limited to: semiconductor firmware memory, programmable memory, non-volatile memory, read only memory, electrically programmable memory, random access memory, flash memory (which may include, for example NAND or NOR type memory structures), magnetic disk memory, optical disk memory, combinations thereof, and the like. Additionally or alternatively, memory 205 may include other and/or later-developed types of computer-readable memory. Without limitation, in some embodiments memory 205 is configured to store data such as computer readable instructions in a non-volatile manner.

Image data produced by ISP 203 may correspond to all or a portion of a digital image of the environment within image sensor 201's field of view. In embodiments the image data may be stored in memory 205, e.g., as a digital image. Alternatively or additionally, all or a portion of the image data may be stored in a shared memory 219 of SLAM HWA 211, after which components of SLAM HWA 211 (e.g., a feature detection component or a feature tracking component) may perform feature detection and/or feature tracking operations consistent with the present disclosure thereon. In further embodiments image data may be provided (e.g., on a line by line basis) from ISP 201 to one or more components of SLAM HWA 211, such as a feature detection or a feature tracking component of SLAM HWA 211.

Image sensor 201 and/or ISP 203 may be configured to provide a single image or a temporal sequence of images (e.g., a video or other data stream), such as but not limited to a video graphics array (VGA) stream at 30 frames per second or another frame rate. The resolution of the images and/or the frame rate provided by image sensor 201 and ISP 203 may vary considerably, and any suitable resolution and/or frame rate may be used. Increasing the resolution and/or frame rate may increase processing load associated with feature detection and/or tracking. It may therefore be desirable to select the resolution and/or frame rate of the image data provided by image sensor 201 and ISP 203 such that a desired balance between such features and image processing workload is achieved.

FIG. 2B depicts one example of a SLAM HWA consistent with the present disclosure. As shown, SLAM HWA 211 includes SLAM controller 213, feature detection component 215, optional feature tracking component 217, and shared memory 219. SLAM controller 213 generally functions as a top level controller, and controls the operation and/or configuration of feature tracking component 217, feature detection component 215, and optionally other components of SLAM HWA (not shown). For example, SLAM controller 213 may function to configure and control the feature detection component 215, the feature tracking component 217, or both. For example, in embodiments SLAM controller 213 may manage the sequencing with which feature detection component 215 and feature tracking component 217 perform their respective operations. SLAM controller 213 may also be used to set, for example, one or more parameters used by feature detection component 215 (e.g., offsets applied, threshold positions, etc.) and/or one or more parameters used by feature tracking component 217 (e.g., tracking order, region of interest selection, etc.).

In embodiments image data from image sensor 201 and/or ISP 203 may be stored in shared memory 205, and/or may be input directly into SLAM HWA 211 (e.g., feature detection component 215 and/or feature tracking component 217). In the former case (storage in memory 205), SLAM controller 213 and/or processor 207 may cause all of a portion of the image data to be written to shared memory 219. In the latter case (e.g., image data input director to SLAM HWA 211), the image data may be transmitted from an image sensor and/or ISP to shared memory 219 and/or one or more buffers (or other memory structures) of feature detection component 215 and/or feature tracking component 217. In either case SLAM HWA 211 is configured to perform feature detection and/or feature tracking operations on the image data as described herein.

Like memory 205, memory 219 may be any suitable type of computer readable memory. Example memory types that may be used as memory 219 include but are not limited to: semiconductor firmware memory, programmable memory, non-volatile memory, read only memory, electrically programmable memory, random access memory, flash memory (which may include, for example NAND or NOR type memory structures), magnetic disk memory, optical disk memory, combinations thereof, and the like. Additionally or alternatively, memory 402 may include other and/or later-developed types of computer-readable memory. Without limitation, in some embodiments memory 219 is configured to store data such as computer readable instructions in a non-volatile manner.

The present disclosure will now proceed to describe examples of the performance of feature detection and tracking operations using feature detection and tracking components consistent with the present disclosure. It is emphasized that the following description is for the sake of example only, and that the feature detection and feature tracking components are not limited to the specific examples described herein. For convenience, the discussion will begin with a description of one example of a feature detection component that may be used as feature detection component 215, as well as the operation thereof to perform feature detection operations with one or more sliding windows consistent with the present disclosure. Methods of performing feature detection (e.g., using a feature detection component) will then be described. An example of a suitable feature tracking component that may be used as feature tracking component 217 will then be described, as well as the operation thereof to perform feature tracking operations consistent with the present disclosure. Methods of performing feature tracking (e.g., using a feature tracking component) are then presented.

As noted above some feature detection algorithms work on a neighborhood of pixels when determining whether a candidate pixel in the neighborhood is or is not a feature. For example and as discussed above in connection with FIG. 1B, the FAST corner detector operates on a neighborhood of pixels that is a minimum of a 7×7 array of pixels when determining whether a single candidate pixel therein is or is not a corner. Following the performance of FAST corner detection on a candidate pixel in the neighborhood, the neighborhood is discarded and a new neighborhood is fetched.

Unlike conventional FAST corner detection, the feature detection components of the present disclosure take advantage of the fact that a portion of the image data fetched for the analysis of a first candidate pixel in a first neighborhood can be reused for the analysis of one or more pixels that are adjacent and/or proximate to the first candidate pixel. Specifically and as will be described below, (first) working data suitable for the analysis of one or more candidate pixels may be loaded into a sliding window buffer. Following analysis of the candidate pixel(s) in the (first) working data, all or a portion of the (first) working data in the sliding window buffer may be discarded. The discarded portion of the (first) working data corresponds to an offset applied to change the working data within the sliding window buffer, i.e., an offset applied to define new working data (and hence, a new sliding window) within the sliding window buffer. New image data corresponding to the applied offset may then be loaded into the sliding window buffer to replace the discarded portion, resulting in the presence of new working data within the sliding window buffer, wherein the new working data includes new image data, as well as reuse data. Depending on the nature of the applied offset, the reuse data may include horizontal reuse data (i.e. image data stored in a reuse buffer), vertical reuse data (i.e., a portion of the first working data retained in the sliding window buffer), or a combination thereof. In any case, the new working data may include image data corresponding to one or more new candidate pixels, upon which feature detection operations may be performed.

Use of the sliding windows (sliding window buffers) can reduce the number of reads to memory needed to provide a pixel neighborhood that is sufficient to perform FAST corner detection, relative to the performance of such operations by a general purpose processor. For example, in conventional FAST corner detection a general purpose processor fetches new image data corresponding to 49 pixels (i.e., a neighborhood of 7 rows of 7 pixels) from memory each time it is to perform FAST corner detection on a single candidate pixel therein. In contrast, using the sliding window(s) (sliding window buffer) and offsets described herein, new image data corresponding to only a portion of a neighborhood may need to be read from memory in order to provide a sufficient amount of image data needed to perform FAST feature detection on new candidate pixels.

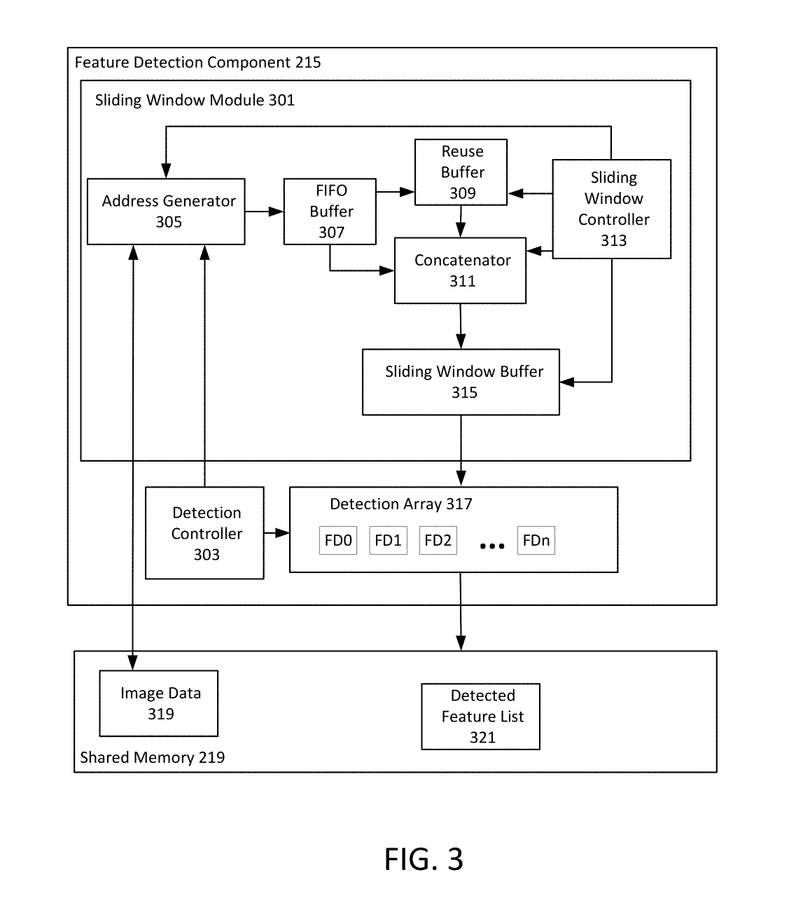

Reference is now made to FIG. 3, which depicts one example of a feature detection component 215 that may operate to perform feature detection operations using one or more sliding windows consistent with the present disclosure. As shown, feature detection component 215 includes sliding window module 301, detection controller 303, and detection array 317. Sliding window module 301 includes address generator 305, first in first out (FIFO) buffer 307, reuse buffer 309, concatenator 311, sliding window controller 313, and sliding window buffer 315. For the sake of clarity, FIG. 3 depicts an embodiment in which feature detection component 215 will operate to perform feature detection operations on image data 319 that is read from shared memory 219 of SLAM HWA 211. It should be understood that such description is for the sake of example, and that feature detection component need not operate on image data that is (previously) stored in shared memory 219. In embodiments image data 319 may be provided directly from an ISP or other component to sliding window module 301. For example, in some embodiments image data from an ISP (e.g., ISP 203) may be input directly and on a line by line basis to address generator 305 and/or FIFO buffer 307.

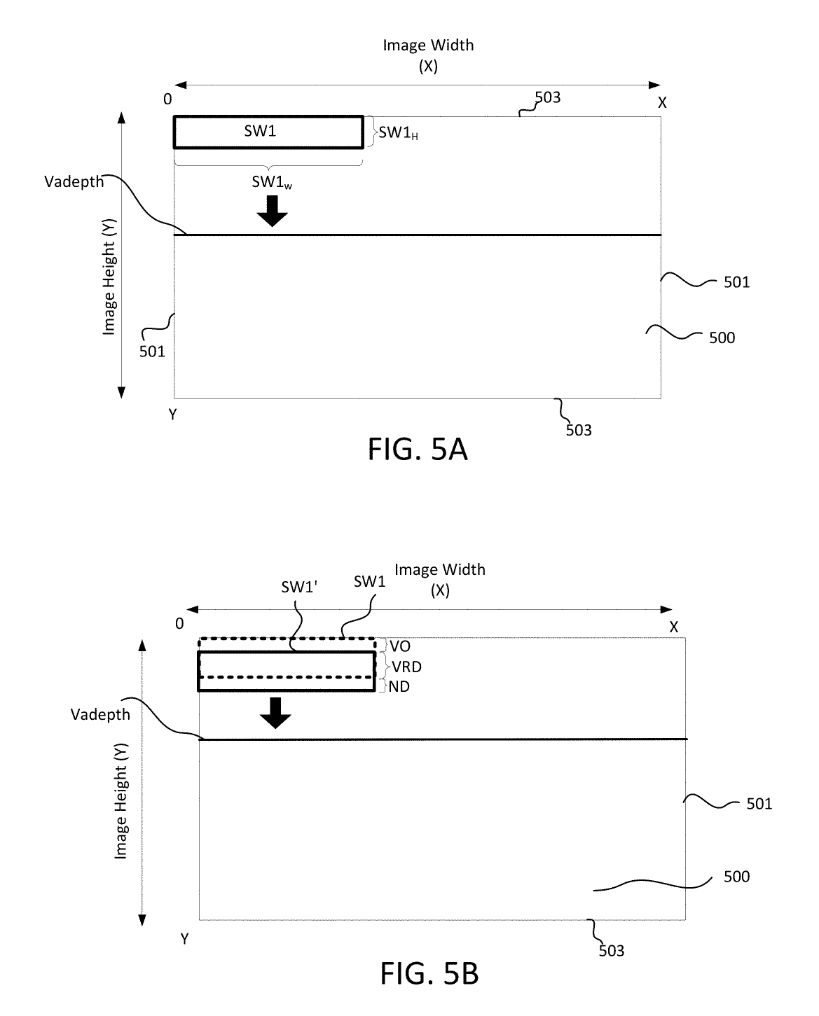

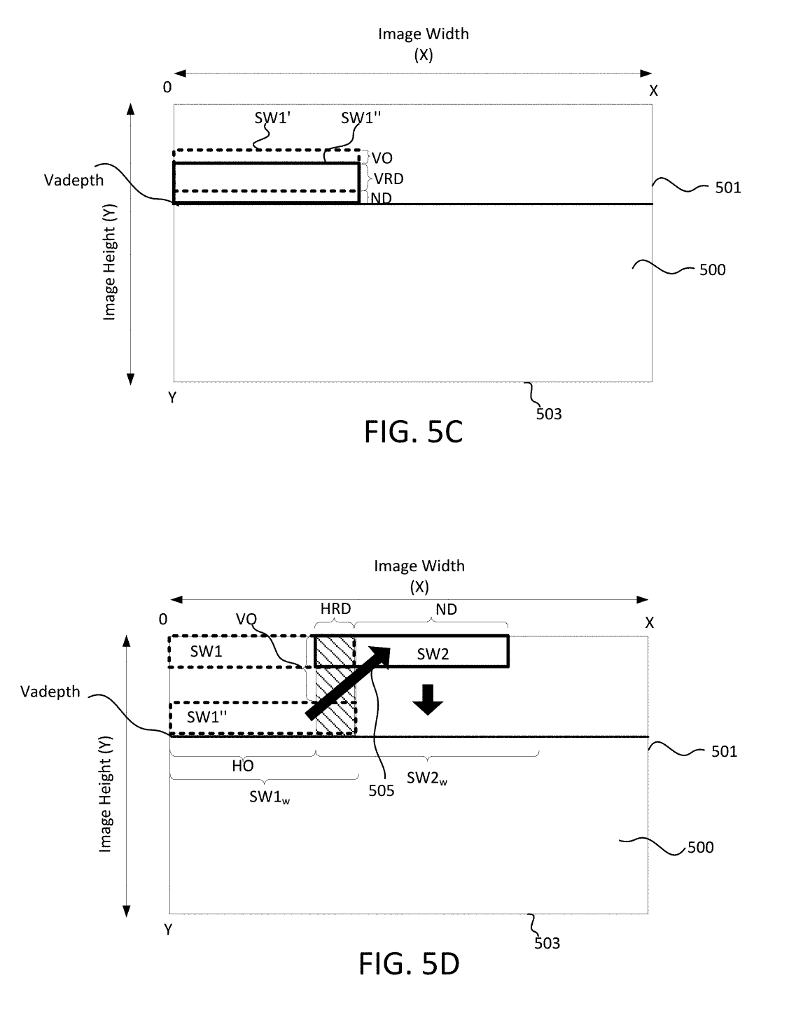

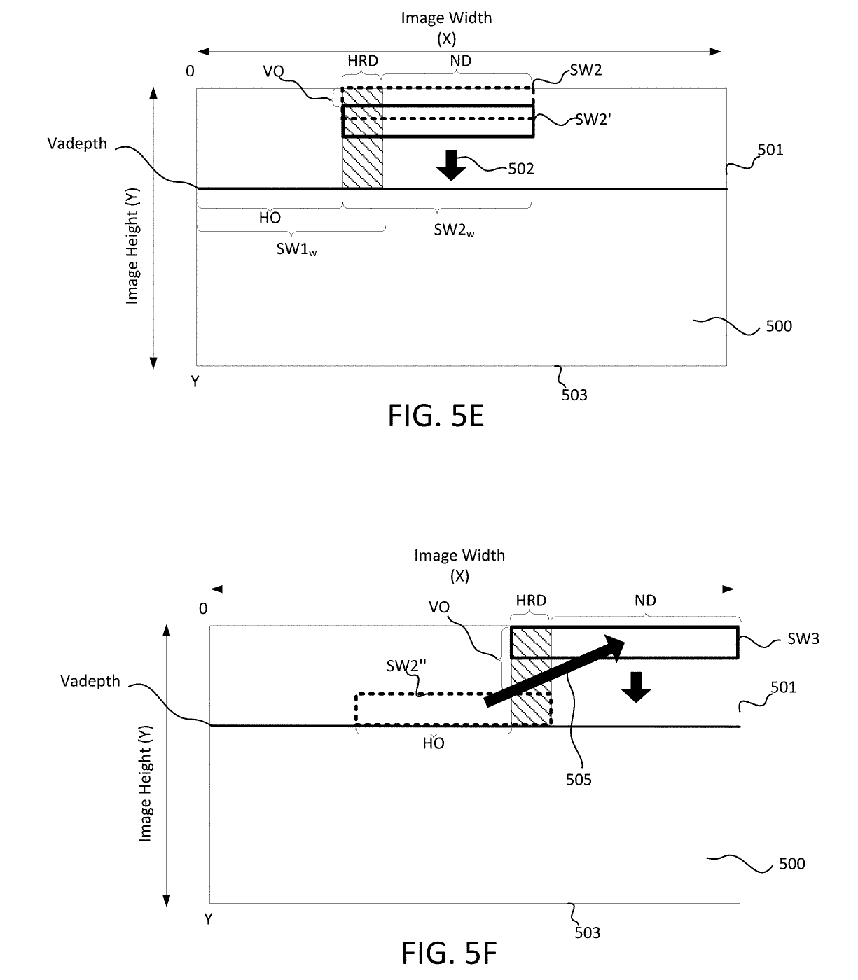

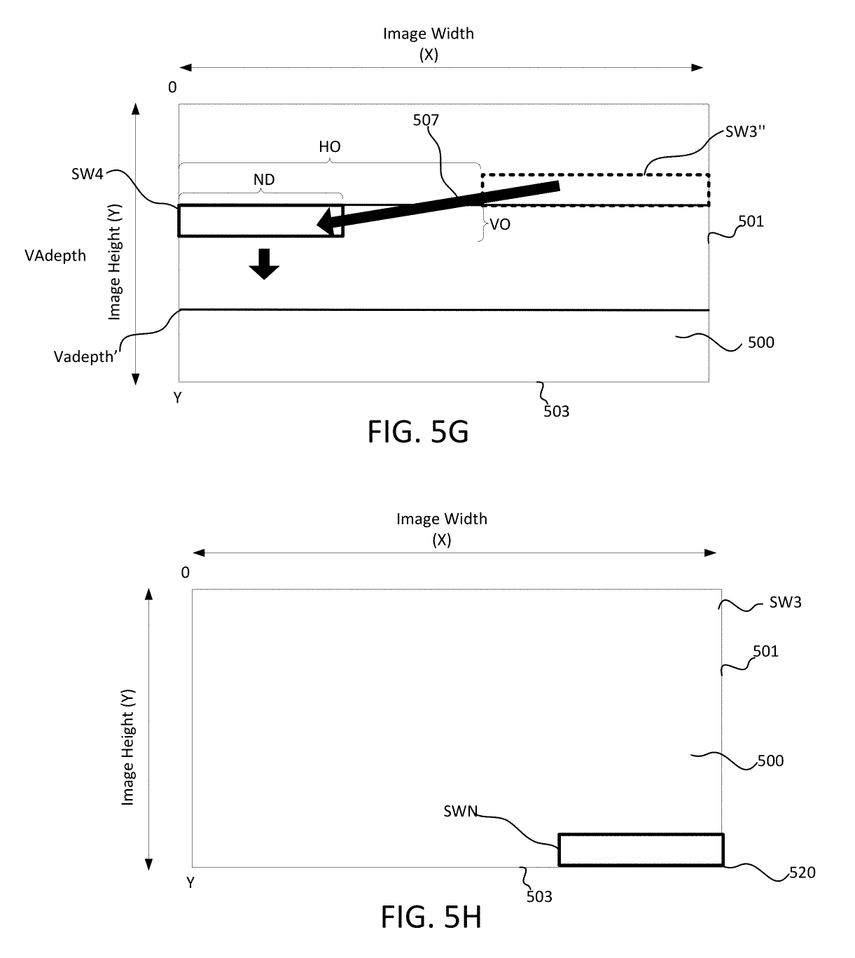

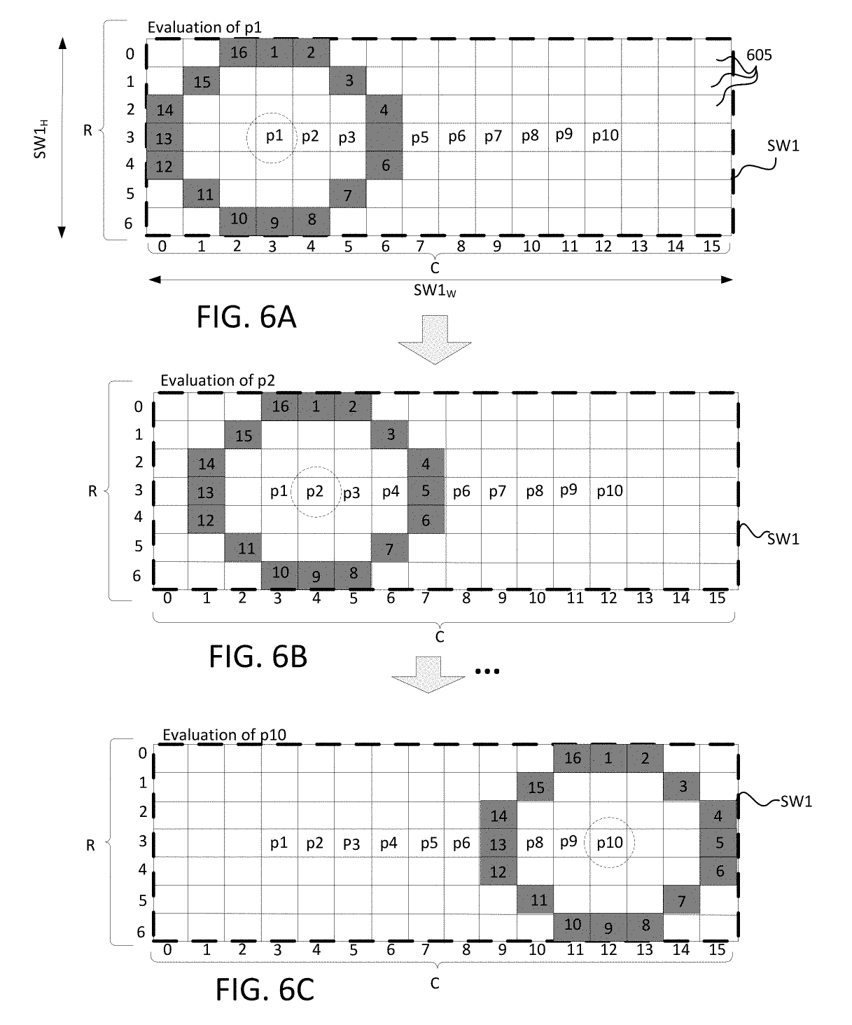

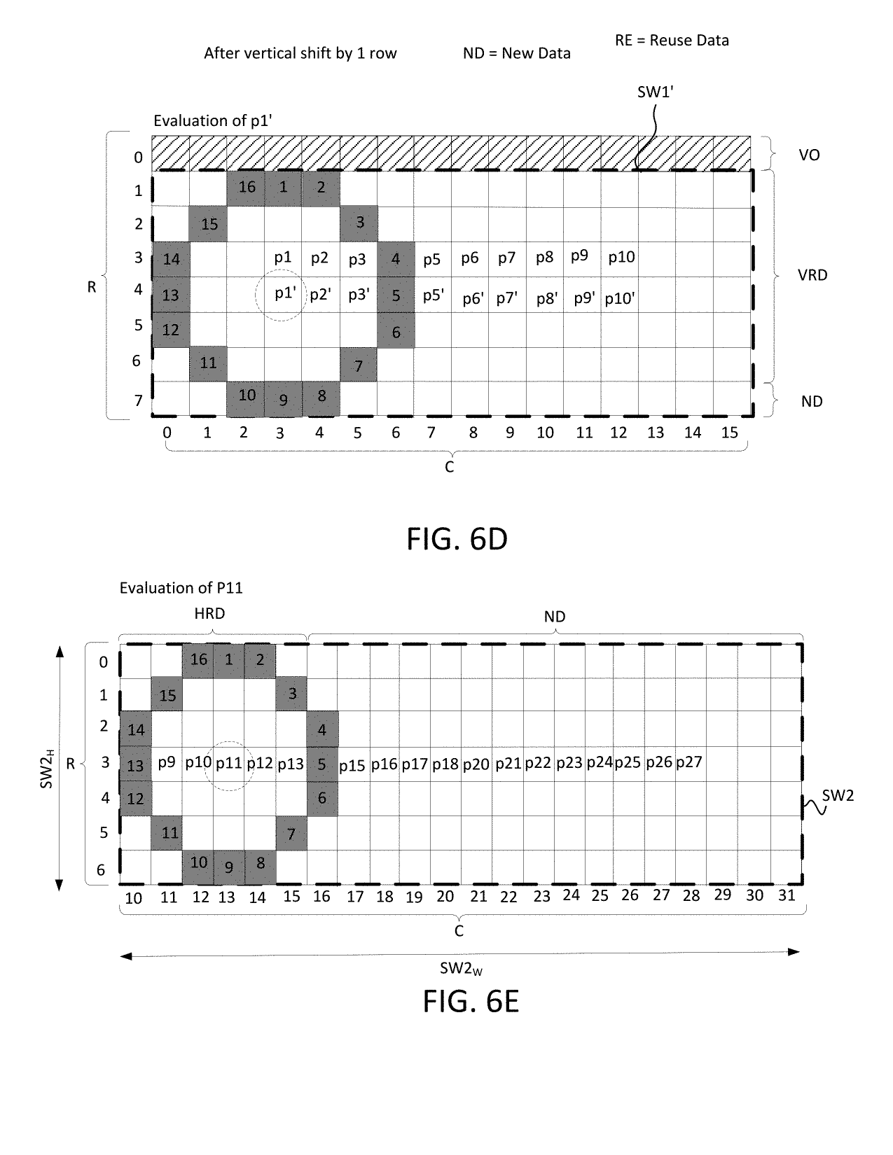

Feature detection component 215 is generally configured to perform feature detection operations on image data using one or more sliding windows (i.e., areas of working data). In embodiments sliding window controller 313 is configured to define one or more sliding windows and one or more threshold positions within the image data 319 of a digital image. Defining the sliding window(s) may involve, for example, establishing the dimensions of such sliding windows (e.g., sliding window width, sliding window height, etc.), details of which are provided later, e.g., in connection with FIGS. 5A-5D. For example each sliding window described herein may be dimensioned to encompass working data that includes at least one pixel neighborhood sufficient to perform feature detection operations, such as FAST corner detection on one or more candidate pixels (See e.g., FIGS. 6A-6E). The sliding window height and width may also be set based at least in part on the size of a sliding window buffer, such as but not limited to sliding window buffer 315.

In embodiments, defining one or more threshold positions in the image data includes identifying one or more threshold depth/vertical access positions (VAdepth) and/or threshold width/horizontal access positions (HAwidth) within the image data in question. The one or more threshold position(s) may affect how much image data is reused for the performance of feature detection operations, which data is reused for feature detection operations, and how a sliding window is offset (i.e., how working data within a sliding window buffer is redefined). FIG. 5A depicts one example of that concept, and shows an example in which a threshold vertical access depth (VAdepth) is defined on a vertical axis (Y) of a 2d representation of a digital image 500. It is noted that VAdepth in FIG. 5A is but one example of a (first) threshold position that may be employed, and that other threshold positions may also be used as discussed below. Moreover, the position of VAdepth in FIG. 5A is for the sake of example only.

Sliding window controller 313 may also function to define one or more sliding windows at one or more positions of a digital image under consideration. That concept is shown in FIG. 5A, which depicts an example in which a sliding window SW1 is defined at an initial position relative to a 2D representation of image data of digital image 500. In the illustrated example, SW1 has a quadrilateral (rectangular shape) with a sliding window width SW1_{W} and sliding window height SW1_{H}. SW1 therefore encompasses working data, i.e., image data of digital image 500 that is within the bounds of SW1. The working data within the sliding windows described herein generally includes image data corresponding to at least one pixel neighborhood. That concept is shown in FIG. 6A, which illustrates one example in which a sliding window SW1 includes image data corresponding to 7 pixel rows (R) and 16 pixel columns (C) of image data of digital image 500, i.e., image data sufficient enable the performance of FAST feature detection on ten candidate pixels p1 . . . p10 using a Bresenham circle of radius 3.

Sliding window controller 313 may therefore “define” a sliding window by identifying a subset of (contiguous) pixel addresses within an image that are to be used (e.g., loaded into/present in) a sliding window buffer, such as sliding window buffer 315. Each pixel address may correlate to one or more pixels, and hence, the number of pixel addresses may correspond to the size of the sliding window buffer to be employed. Sliding window controller 313 may “define” new sliding windows by selecting new combinations of pixel addresses that are to be used in a sliding window buffer. In embodiments, sliding window controller 313 defines a sliding window by identifying pixel addresses (within image data) that correspond to one or a plurality of pixel rows and one or a plurality of pixel columns. The number of pixel columns and/or pixel rows in the sliding windows defined by sliding window controller 313 may be selected such that they include at least one pixel neighborhood sufficient for the performance of feature detection operations (e.g., FAST corner detection operations) on a candidate pixel. In total, the pixel addresses identified by sliding window controller 313 during the definition of a sliding window correspond to the working data within that sliding window and, hence, working data that is or is to be presented in a sliding window buffer such as sliding window buffer 315.

Sliding window controller 313 may also be configured to cause address generator 305 to provide image data corresponding to all or a portion of the working data within a (current) sliding window to FIFO buffer 307. For example sliding window controller 313 may issue or cause the issuance of one or more control signals to address generator 305, wherein the control signals are configured to cause address generator 305 to provide image data to FIFO buffer 307. In embodiments the control signal(s) provided to address generator 305 include or otherwise specify one or a plurality of pixel addresses (e.g., a pixel address range) within a digital image under consideration.

Address generator 305 may be configured, independently or in response to receipt of a control signal from sliding window controller, to provide image data to FIFO buffer 307, e.g., on a row by row or column by column basis. The image data may be stored in shared memory 219 (as shown in FIG. 3) or provided in some other manner, e.g., from a memory 205 (e.g., digital random access memory (DRAM), from ISP 203, etc.). Generally, the image data provided by address generator 305 corresponds to all or a portion of working data within a sliding window. In embodiments, address generator 305 may be in the form of or include a memory controller of shared memory 219.

For example and with reference to the embodiment of FIG. 6A, sliding window controller 313 may issue one or more control signals to address generator 305 that specify the pixel addresses of pixels 605 within the working data of SW1. In response to those control signals, address generator 305 may cause image data 319 corresponding to each row R or column C of the working data to be read from memory 219 and provided to FIFO buffer 307. The amount of image data in each row or column provided by address generator 305 may vary, and in some embodiments may correspond to the number of pixels is a row or column of working data in a sliding window. For example, address generator 305 may read an i^{th} row(s)/column(s) of image data 119, wherein each i^{th} row/column corresponds to the pixels in a row R or column C of SW1 in FIG. 6A. Address generator 305 may then provide that i^{th} row/column of image data to FIFO buffer 307. Subsequently, additional i^{th} rows/columns of the working data in SW1 may be read by address generator 305 and fed to FIFO buffer 307.

Sliding window controller 313 may also apply one or more offsets to define new sliding windows, i.e., a new subset of pixel addresses within an image upon which feature detection is to be performed. Depending on the nature of the applied offset, a portion of the pixel addresses in the new sliding window may correspond to image data that was previously loaded into a sliding window buffer (e.g., sliding window buffer 315), and/or which was previously loaded into a reuse buffer (e.g., reuse buffer 309). In such instances, the control signals issued by sliding window controller may cause address generator to only fetch image data from memory that is not already present in the reuse buffer and/or the sliding window buffer, i.e., new data. In such instances, the fetched new data may be concatenated with the (reuse) data in the sliding window buffer, the reuse buffer, or both.

Put differently, sliding window controller 313 may define a new sliding window that encompasses new working data, wherein the new working data includes new data and reuse data. The reuse data is data that has been previously written to a reuse buffer (309) or a sliding window buffer (315). The new data is image data encompassed by the new sliding window, but which has not been previously written to a reuse buffer (309) or a sliding window buffer (315). The control signal(s) issued by the sliding window controller 313 may therefore cause address generator 305 to fetch only the new image data from shared memory 219 (or another location), and to provide that new image data to FIFO buffer 307. The new data may then be concatenated with reuse data in reuse buffer 309, reuse data in sliding window buffer 315, or both, thereby resulting in the presentation of the new working data within sliding window buffer 315. Which reuse data is concatenated with the new image data may depend on the offset applied by the sliding window controller to define the new sliding window.

As noted above, Sliding window controller 313 may also define one or more threshold positions within a digital image under consideration. In embodiments, defining one or more threshold positions in the image data includes setting a location of one or more threshold depth/vertical access positions (VAdepth) and/or threshold width/horizontal access positions (HAwidth) along a vertical or horizontal axis of a digital image under consideration. Alternatively, a horizontal or vertical edge of an image may be used as a threshold position.

In embodiments, one or more of the threshold position(s) may affect how much image data is retained within reuse buffer 309, e.g., as reuse data. For example, a threshold position (e.g., VAdepth) may determine how much image data is retained as horizontal reuse data within reuse buffer 309, e.g., as a vertical offset is applied to define new sliding windows. It may therefore be desirable to set VAdepth based at least in part on the size of reuse buffer 309. Conversely, it may be desirable to set the size of reuse buffer 309 based at least in part on the location at which a threshold such as VAdepth is or is to be set.

The threshold positions described herein may also impact how a sliding window is offset (i.e., how working data within a sliding window buffer is redefined) as feature detection is performed on digital image under consideration. For example, a sliding window controller may be configured to apply a first offset to a current sliding window to define a new sliding window that is offset in a first direction, when the current sliding window has not yet reached a threshold position. When a current sliding window has reached a threshold position however, the sliding window controller may apply a second (different) offset to the current sliding window, so as to define a new sliding window that is offset in a different direction. Still further, when a current sliding window has reached both a threshold position and an edge of an image, sliding window controller may apply a third (different) offset to the current sliding window, so as to define a new sliding window that is offset in yet another direction.

FIGS. 5A-5H generally illustrate the foregoing concepts, in the context of one example in which a sliding window controller applies different offsets to define different sliding windows based on the position of a current sliding window relative to a threshold position and/or an edge of an image. For convenience such figures depict a digital image 500 under consideration using a two dimensional (2D) coordinate system. As shown, image 500 includes horizontal edge 501 and a vertical edge 503. In this embodiment, a sliding window controller has defined a sliding window SW1 such that it encompasses a subset of contiguous pixels in the upper left hand corner of image 500, as shown in FIG. 5A. It should be understood, of course that the starting position of SW1 is not limited to the position shown in FIG. 5A.

In the embodiment of FIGS. 5A-5D the sliding window controller has defined a first threshold position along the vertical axis (Y) of image 500. Because the first threshold position defines a point along the vertical axis at which offsetting of a sliding window may change, it is referred to herein as a vertical access depth, or “VAdepth.” It is noted that VAdepth is but one example of a (first) threshold position that may be employed, and that other threshold positions may also be used. Moreover, the position of VAdepth in FIG. 5A is for the sake of example only.

Feature detection operations may be performed on the working data encompassed by SW1 (and presented in a sliding window buffer). Following such operations the sliding window controller may determine whether SW1 has reached Vadepth. Determining that SW1 has not reached VAdepth, the sliding window controller in this embodiment applies a vertical offset (VO) to pixel coordinates included within sliding window SW1, so as to define a new sliding window SW1′ that is offset in a first direction. In this case the first direction downwards from SW1, such that SW1′ is vertically offset from but overlaps with SW1. SW1′ may therefore encompass new working data that includes new image data corresponding to VO, and reuse data corresponding to a portion of the working data encompassed by SW1 and which is present in a sliding window buffer, i.e., vertical reuse data. Feature detection operations may then continue, and the process may iterate, resulting in the production of additional vertically offset sliding windows, until a current sliding window reaches VAdepth as shown in FIGS. 5B and 5C. In that regard, FIG. 5C depicts one example in which a sliding window SW1″ has reached VAdepth.

To determine whether a sliding window has reached a threshold position, a sliding window controller may compare pixel coordinates of pixels within a current sliding window to pixel coordinates corresponding to a threshold position. In that regard a threshold position may be defined as a line projecting perpendicularly from a vertical or horizontal axis of a 2D representation of an image under consideration. This concept is shown in FIGS. 5A-5D, which depict threshold VAdepth as a horizontal line extending perpendicularly from a vertical axis of image 500. Sliding window controller may determine that a current sliding window has reached a threshold position when pixel coordinates within the current sliding window include or abut pixel coordinates corresponding to the threshold position. In FIGS. 5C and 5D, for example, a sliding window controller may determine that sliding window SW1″ has reached VAdepth because one or more pixel coordinates within SW1″ include or about one or more pixel coordinates corresponding to VAdepth.

Following the performance of feature detection operations on candidate pixels within a sliding window that has reached a threshold position (e.g., SW1″), sliding window controller may apply a second offset to pixel coordinates of a current sliding window, so as to define a new sliding window that is offset in a second direction, wherein the second direction is different than the first direction obtained via application of the first offset. For example where a first applied offset was a vertical offset, the second offset may be a horizontal or diagonal offset. Where the first applied offset was a horizontal offset, the second offset may be a vertical or a diagonal offset, and where the first applied offset was a diagonal offset, the second offset may be a horizontal or a vertical offset. FIG. 5D depicts one example of this concept, in which a sliding window controller applies a diagonal offset to a pixel coordinates of a sliding window SW1″, so as to define a new sliding window SW2 that is diagonally offset from SW1″. In this embodiment the diagonal offset 505 includes a vertical offset component VO that is greater than the sliding window height of SW1″, and a horizontal component HO that is less than the sliding window width of SW1″. The VO component of the diagonal offset in this embodiment is configured such that the new sliding window SW2 is positioned adjacent to or proximate a top vertical edge 503 of image 500. Specifically, the VO component in this embodiment is equal to the number of pixel rows of between an uppermost pixel row contained in SW1″, and an upper most pixel row (i.e., a top edge) of image 500. In contrast, the HO component of the diagonal offset was configured such that the new sliding window, SW2, encompasses at least a portion of the working data of a previous sliding window, e.g., SW1. Of course, the use of diagonal offset 505 and the positioning of SW2 are for the sake of example only, and another type of offset (resulting in different positioning of SW2) may be used.

Feature detection operations may then be performed on working data within sliding window SW2. Following such operations, sliding window controller 313 may determine whether SW2 has reached a threshold position. If not, sliding window controller 313 may again apply a first offset to pixel coordinates within current sliding window, so as to define a new sliding window that is offset in a first direction, relative to the current sliding window. This concept is shown in FIG. 5E, wherein a vertical offset VO is applied to pixel coordinates of SW2, so as to define a new sliding window SW2′. Once a current sliding window reaches a threshold position, however, a second offset may again be applied to the pixel coordinates in the current sliding window, so as to define a new sliding window that is offset in a different direction. This concept is shown in FIG. 5F, which depicts the application of a diagonal offset 505 to pixel coordinates of SW2″, so as to define a new sliding window SW3.

The above process may iterate until a current sliding window reaches both a threshold position and an edge of an image. In such instances (and provided an end of the image in question has not been reached), the sliding window controller may apply a third offset to pixel coordinates of the current sliding window, so as to define a new sliding window that is offset from the current sliding window in a third direction that is different from the first and second directions obtained by application of the first and second offsets.

That concept is shown in FIG. 5G, which depicts an example in which a current sliding window (SW3″) has reached a threshold position (in this case VAdepth) as well as a right horizontal edge 501 of image 500. In this embodiment a sliding window controller applies a third offset 507 (a diagonal offset), so as to define a new sliding window SW4 that is offset in a third direction, wherein the third direction differs from the first and second directions obtained by application of the first and second offsets, respectively. In this example, the horizontal offset component HO of the third offset 507 is configured such that a left most pixel column of SW4 is adjacent a left horizontal edge 501 of image 500. Moreover, the vertical component VO of the third offset 507 is configured such that at least a portion of SW4 is below a previously defined threshold position (in this case, at least partially below VAdepth). At this point, the sliding window controller may define a new threshold position along an axis of the image in question. This concept is shown in FIG. 5G, which illustrates the specification of a new vertical access depth, i.e., VAdepth′ along the vertical axis of image 500.

Processing of image 500 may then continue in the manner discussed above (i.e., with a sliding window controller defining new sliding windows by the appropriate application of (first, second, third, etc.) offsets, and feature detection operations being performed on the working data encompassed in the new sliding windows until a current sliding window reaches an end of the image under consideration. The sliding window controller may determine that a current sliding window has reached an end of an image in any suitable manner. For example, sliding window controller may determine that current sliding window has reached an end of an image when it encompasses pixel coordinates of an image that correspond to one or more corners of the image under consideration. For example as shown in FIG. 5H, a sliding window controller may determine that a sliding window SWN has reached an end of image 500 when it includes pixel coordinates that encompass or abut a corner 520 of image 500. In this case, corner 520 corresponds to an opposing corner at which sliding window SW1 was originally defined.

The sliding window controller may of course determine that a current sliding window has reached an end of an image in another manner. For example, a sliding window controller may track pixel coordinates of pixels in image 500 that have not yet been included in a sliding window. In such instances the sliding window controller may determine that a sliding window has reached an end of an image when all pixels within the image have been included in one or more sliding windows. Still further, sliding window controller may determine that a sliding window has reached an end of an image when all potential candidate pixels in the image have been subject to feature detection operations such a FAST feature detection. In that regard a sliding window controller may predict which within an image under consideration will be candidate pixels, based on the sliding windows that are expected to be applied and the resolution of the image.

Returning to FIG. 3, FIFO buffer 307 generally functions to store one or more rows and/or columns of image data provided by address generator 305 on a first in, first out basis. The size of FIFO buffer 307 may vary widely and in some embodiments corresponds to the size of one column or one row of image data included in the working data of a sliding window and/or sliding window buffer 315. The size of FIFO buffer 307 may therefore bear some relationship to the size of sliding window buffer 315. Moreover, the amount of data fetched by address generator 305 and provided to FIFO buffer 307 at one time may be determined at least in part by the size of FIFO buffer 307. Without limitation, in some embodiments FIFO buffer 307 is sized to contain image data corresponding to one pixel row or one pixel column of working data within a sliding window.

For example and with reference to FIGS. 5A and 6A, in embodiments sliding window controller 313 may operate to define a sliding window SW1 that encompasses working data in the form of 7 pixel rows R that are 16 pixels wide, and 16 pixel columns that are 7 pixels deep, wherein each pixel is represented by eight bights of image data. In such instances FIFO buffer 307 may be sized to store image data corresponding to one pixel row R or one pixel column C of working data within SW1. That is, FIFO buffer 307 may be a 128 bit FIFO buffer (1 row) or a 56 bit FIFO buffer (1 column).

Of course the size of the sliding windows is not limited to the embodiment of FIG. 6A and hence, the size of FIFO buffer 307 is also not limited to the above noted values. For example, during the performance of feature detection operations sliding window controller 313 may define sliding windows that differ in size. With reference to FIGS. 5C and 6E, for example, sliding window controller 313 may define a sliding window SW2 that encompasses working data in the form of 7 pixel rows R that are 22 pixels wide, and 22 pixel columns that are 7 pixels deep. In such instances FIFO buffer 307 may for example be a 176 bit FIFO buffer (1 pixel row) or a 56 bit FIFO buffer (1 pixel column).

Such sizes are of course enumerated for the sake of example only, and FIFO buffer 307 may have any suitable size. Moreover, it should be understood that when a complete set of working data cannot be provided (e.g., when a current sliding window overlaps an edge/end of a digital image under consideration), it should be understood that data fed to FIFO buffer (and/or to sliding window buffer) may be padded, e.g., with zeros or other data. Moreover in instances where sliding window controller 313 may define sliding windows of different dimensions during the performance of feature detection operations on an image, it may be desirable to set the size of FIFO buffer 307 based on the dimensions of the smallest and/or largest sliding window that may be defined by sliding window controller 313.

Returning to FIG. 3, as noted above address generator 305 may fetch image data from memory in response to control signals from sliding window controller 313, and provide the fetched image data to FIFO buffer 307. When FIFO buffer 307 is full, at least a portion of the image data therein is conveyed to reuse buffer 309, and all of the image data in FIFO buffer 307 is conveyed to concatenator 311.

In general, reuse buffer 309 functions to store “reuse data” i.e., image data fetched by address generator 305 for use as working data in connection with a previous sliding window, and which may be reused as a portion of new working data in one or more new sliding windows. Whether or not reuse data in reuse buffer 309 is used in new working data will depend on whether pixel addresses of the reuse data in reuse buffer 309 are included in the pixel addresses of a new sliding window defined by sliding window controller 313, e.g., after the application of an offset. In embodiments and as will be described below, reuse data in reuse buffer 309 may be used as working data in a new sliding window that is horizontally and/or diagonally offset from a previous sliding window. In such instances, all or a portion of the data in reuse buffer 309 may be referred to herein as “horizontal reuse data” or “HRD.”

The portion of the image data in FIFO buffer 307 that is conveyed to reuse buffer 309 (i.e. the portion of the image data that will be stored as reuse data) may depend on the position of a new/offset sliding window (encompassing new working data) relative to a current sliding window (encompassing current/first working data). More specifically, the portion of the image data in FIFO buffer 307 that is conveyed to reuse buffer will depend on the manner in which sliding window controller 313 defines new sliding windows.

As discussed above, sliding window controller 313 may define new sliding windows by the application of one or more offsets. For example and as shown in FIGS. 5A-5H, sliding window controller 313 may apply first, second, and/or third offsets to pixel coordinates of a current sliding window to define pixel coordinates of a new sliding window that is offset from the current sliding window in one or more directions. Generally and as shown in FIGS. 5A-5H, the applied offset(s) result in the definition of a new sliding window that includes that contains new working data, wherein the new working data includes new image data (i.e., new image data read from memory 219) and reuse data (i.e., image data maintained in reuse buffer 309 or retained in sliding window buffer 315. Put in other terms, sliding window controller 313 may apply one or more offsets to define a new sliding window that overlaps with one or more of the top, left side, right side, or bottom or a previous sliding window.

FIG. 5B shows one example in which a new sliding window SW1′ overlaps a lower portion of a first sliding window SW1 following application of a vertical offset VO to pixel coordinates of SW1. In contrast, FIG. 5D depicts one example in which a new sliding window SW2 overlaps a side portion of a previous sliding window (SW1) following application of a diagonal offset 505 to pixel coordinates of a sliding window SW1″.

In instances where a new sliding window overlaps a lower or upper portion of a previous sliding window, the reuse data may be one or more rows of image data previous used as working data of a previous sliding window, and which correspond to one or more pixel rows of new working data in the new sliding window (i.e., vertical reuse data). In instances where a new sliding window overlaps a side portion of a previous sliding window, the reuse data may be one or more columns of image data previously used as working data of a previous sliding window, and which corresponds to or one or more pixel rows of the new working data (i.e., horizontal reuse data).

Sliding window controller 313 may be further configured to issue one or more reuse control signals, e.g., to reuse buffer 309, address generator 305, and/or FIFO buffer 307. The reuse control signals may include a reuse information indicator that specifies which portion of the image data in FIFO buffer 307 is to be stored in reuse buffer 309. The portion of the image data in FIFO buffer 307 that is stored in reuse buffer may depend on the relative position of a new sliding window, relative to a current sliding window. Put in other terms, the portion of image data in FIFO buffer 307 that is stored in reuse buffer 309 may correspond to vertical reuse data, horizontal reuse data, or a combination thereof.

For the sake of example, the present disclosure will focus on describing the operation of sliding window controller 313 in connection with the retention of vertical and horizontal reuse data in the context of the embodiment of FIGS. 5A-5H. In this example embodiment, a portion of the image data in FIFO buffer 307 corresponding to horizontal reuse data (i.e., one or more pixel columns) is stored in reuse buffer 309, whereas vertical reuse data (i.e., one or more pixel rows) will be retained within sliding window buffer 315. This description is of course not limiting, and the reuse data retained in FIFO buffer 307 and/or sliding window buffer 315 is not limited to horizontal and vertical reuse data, respectively. For example, in embodiments where a horizontal offset is applied to pixel coordinates of a current sliding window to define a new sliding window, the horizontal offset may be less than the sliding window width of the current sliding window, in which case horizontal reuse data may be retained within sliding window buffer 315 and vertical reuse data may be retained in reuse buffer 309.

Turning to FIG. 5A, as noted sliding window controller 313 may define a first sliding window SW1 having a sliding window width SW1_{W} and a Sliding Window Height SW1_{H} at an upper left corner of image 500. In response to control signals from sliding window buffer 313, address generator 319 may fetch new image data 319 corresponding to the working data of SW1 from shared memory 219. The new image data may be fed to FIFO buffer 307 on a line by line basis. In this embodiment, a portion of the rightmost pixel columns of the image data in FIFO 307 may be stored to reuse buffer 307, and all of the image data in FIFO 307 is written to sliding window buffer 315. The number of right most pixel columns stored to reuse buffer 309 corresponds to a horizontal offset to be later applied when a current sliding window reaches a threshold position (VAdepth) as described below.

When sliding window buffer 315 is full (i.e., contains all of the working data of SW1) feature detection operations may be performed on the candidate pixels therein, as described later in connection with FIGS. 6A-6E. Following such operations, sliding window controller 313 may determine that SW1 has not reached a threshold vertical position within a digital image (e.g., VAdepth or a vertical edge of image 500), and may apply a vertical offset VO to define a new sliding window SW1′ as discussed above and shown in FIG. 5B. The applied VO is or corresponds to a subset of the total number of pixel rows that are included in the working data of the first sliding window. New sliding window SW1′ is therefore vertically offset from SW1 by VO and includes new working data, wherein the new working data includes vertical reuse data (VRD), and new data (ND), as shown in FIG. 5B.

Prior to application of the VO, sliding window buffer 315 is full of the working data encompassed by SW1, i.e., first working data. Sliding window controller 313 may therefore issue a reuse control signal to sliding window buffer 315, wherein the reuse control signal is configured to cause sliding window buffer 315 to discard a portion of the first working data therein that corresponds to the VO to be applied, and to retain the remaining portion of the first working data as vertical reuse data. Depending on the sign of VO, the reuse control signal may also cause sliding window buffer 315 to shift the vertical reuse data upwards or downwards, e.g., by a number of pixel rows corresponding to VO. Sliding window controller 313 may then cause address generator to fetch only the new data (ND) encompassed by SW1′ from memory 219. The new data may then be provided to FIFO 307. A portion of the new data in FIFO 307 may be stored in reuse buffer 309, and all of the new data may be conveyed to concatenator 311. As discussed below, concatenator 311 may concatenate the new data with the vertical reuse data in sliding window buffer 315, resulting in the presentation of new working data (encompassed by SW1′) in sliding window buffer 315.

One example of the movement of image data within sliding window buffer 315 in connection with the application of a vertical offset may be seen by comparing FIGS. 6A and 6D. In the embodiment of FIG. 5A, sliding window controller 313 has defined a sliding window SW1 at an upper left corner of image 500. As shown in FIG. 6A, SW1 may include working data corresponding to a 7×16 array of pixels, i.e., working data sufficient to include 10 candidate pixels for the performance of FAST corner detection. Feature detection operations such as FAST corner detection may be performed on candidate pixels in the working data of SW1, as shown in FIGS. 6A-6C.

Following such operations sliding window controller 313 may apply a vertical offset VO to define a new sliding window SW1′ as discussed above. As also discussed sliding window controller 313 may be configured to cause (e.g., by the issuance of reuse control signals) sliding window buffer 315 to discard a portion of the first working data stored therein that corresponds to the applied VO (i.e., a number of pixel rows equal to the value of the vertical offset), and to retain a portion of the first working data stored therein as vertical reuse data. That concept is illustrated in FIG. 6D, which depicts the movement of data in sliding window buffer 315 in one example in which a VO equal to one pixel column of working data in SW1 (i.e., pixel row R0 of FIG. 5A) is applied to define a new sliding window SW1′ that is offset downwards by one pixel row.

As shown in FIG. 6D, sliding window controller 313 may (via reuse control signals) cause sliding window buffer 315 to discard the uppermost row (R0) of first working data currently stored therein and to retain the other rows (R1-R6) as vertical reuse data. In addition, sliding window buffer 315 may (in response to reuse control signals) shift rows R1-R6 of the first working data upwards by one pixel row. New image data (ND) in FIFO 307 corresponding to one pixel row (i.e., pixel row 7) may then be concatenated with the vertical reuse data, and stored in sliding window buffer 315 as a lowermost pixel row. As a result, new working data within SW1′ is presented in sliding window buffer 315. Moreover as shown in FIG. 6D, the new working data includes a plurality of new candidate pixels p1′ . . . p10′, each of which are vertically offset by one row relative to previously analyzed candidate pixels p1 . . . p10 in SW1.

The foregoing discussion has focused on the use of vertical reuse data in sliding window buffer 315 in the context of the application of a vertical offset, but it should be understood that other types of reuse data may also be used. Indeed sliding window controller 313 may be configured to cause a portion of the image data in FIFO buffer 307 to be stored in reuse buffer 309, e.g., for reuse in other scenarios.

For example sliding window controller 313 may, following performance of first feature detection operations on first candidate pixel(s) in first working data of a first sliding window (SW1), determine that the first sliding window has reached a threshold position within a digital image (e.g., VAdepth, or a vertical/horizontal edge). In such instances, sliding window controller may apply a second (e.g., horizontal and/or diagonal) offset to pixel coordinates of the first sliding window, so as to select a new subset of pixels within digital image 500 for analysis, i.e., to define a new sliding window that is offset in another direction from the first sliding window. The second offset may include, for example, a horizontal offset that is less than the width of a previously applied sliding window, i.e., which is equal to a portion of the number of pixel columns included in a previous sliding window. As a result, the pixel addresses defining the new sliding window may encompass pixel addresses of one or more previous sliding windows. The new sliding window may therefore include new working data that includes (overlaps) reuse data (i.e., working data of one or more previous sliding windows) and new image data. More particularly, the new sliding window may overlap a left or right side of a previously used sliding window. In such instances the reuse data may be understood to include at least a portion of the left most or right most pixel columns of the working data of one or more previous sliding windows, i.e., which is to the left or right of the new image data included in the new working data. For that reason, such reuse data is referred to as “horizontal reuse data.”

When only a horizontal offset is applied by a sliding window controller to define a new sliding window, the value of the horizontal offset may correspond to a portion of the pixel columns within a current sliding window. Depending on its sign, the horizontal offset may correspond to a number of right most or left most columns of working data within a sliding window buffer. In such instances sliding window controller 313 may cause (via reuse control signals) a number of pixel columns in the sliding window buffer 315 that correspond to the horizontal offset to be discarded, and the remaining pixel columns in the sliding window buffer 315 to be retained as horizontal reuse data. Sliding window controller 313 may then cause new data corresponding to the horizontal offset to be fetched (e.g., by address generator 305 from shared memory 219) and input to a FIFO buffer. The fetched new data may then be concatenated with the horizontal reuse data (e.g., as shown in FIG. 6E and discussed below), resulting in the presence of new working data (corresponding to the new sliding window) in the sliding window buffer.

In other embodiments and as shown in FIGS. 5D and 5F, sliding window controller 313 may apply a diagonal offset (i.e., a combination of a vertical offset and a horizontal offset) to define a new sliding window. In the embodiment of FIGS. 5D and 5F, sliding window (SW1″, SW2″ has reached a threshold position (in this case, VAdepth) along a vertical axis of image 500. Having determined that the sliding window has reached a threshold position (and has not reached an edge or end of image 500), sliding window controller 313 may apply a diagonal offset 505 to the pixel coordinates defining the previous sliding window (SW1″, SW2″) to define a new sliding window (SW2, SW3) that is diagonally offset from the previous sliding window.

In this example, the VO component of diagonal offset 505 is greater than the sliding window height of the previous sliding window (SW1″, SW2″) but the HO component of diagonal offset 505 is less than the sliding window width of the previous sliding window (SW1″, SW2″). The new sliding window (SW2, SW3) therefore encompasses new working data that extends from an upper edge of image 500 and which includes both new data ND and horizontal reuse data (HRD). In this case, the HRD corresponds to one or more of the right most pixel columns of the working data encompassed by SW1, i.e., a previous sliding window, which may be previous stored in a reuse buffer such as reuse buffer 309. SW2 therefore overlaps a portion of the right most pixel columns of the working data in SW1.

Notably the new working data in the new sliding window (SW2, SW3) does not include any of the working data in the previous sliding window (SW1″, SW2″) and, thus, does not include any of the working data currently stored in a sliding window buffer (e.g., sliding window buffer 315). Therefore upon application of diagonal offset 505, sliding window controller 313 may cause (via reuse control signals) all of the working data within a sliding window buffer to be discarded. Moreover, sliding window controller 313 may cause (via control signals) address generator 305 to fetch new image data corresponding to the new data encompassed by SW2 from memory. The fetched new image data may be fed to a FIFO buffer (e.g., FIFO 307) and concatenated with the HRD in a reuse buffer (e.g., reuse buffer 309), as generally shown in FIG. 6E. More specifically, pixel rows (R0-R6) of a left most column C16 of the new data ND are concatenated with pixel rows (R0-R6) of horizontal reuse data HRD, as shown.

The sliding window controller 313 may define a new sliding window such that is has the same or different dimensions as a previously used sliding window. One example of that concept is shown by comparison of FIGS. 6A, 6D and 6E. Without limitation, in some embodiments the dimensions of each sliding window (e.g., the amount of unpadded working data in a sliding window buffer) is the same as shown in FIGS. 6A and 6D. In other embodiments, the dimensions of each sliding window may differ from one another (e.g., the amount of padding applied to image data in a sliding window buffer may differ). In the embodiment of FIG. 6E, for example, sliding window SW2 has a sliding window width (SW2_{W}) that is different (in this case greater than) the sliding window width of a previously sliding window (SW1, SW1′, SW1″—see FIGS. 6A-6C). In any case the working data of SW2 may include additional candidate pixels, including pixels that were not candidate pixels in the working data encompassed by the previous sliding window (SW1) (e.g., p11, p12, p13 . . . ).

The sliding window controllers describe herein may also be configured to implement an offset scheme, wherein new sliding windows are defined by the controlled application of one or more offsets, e.g., in a predefined manner. One example of that concept is shown in FIGS. 5A-5H and 6A-6E. As explained previously, analysis of an image 500 may begin with the definition of a sliding window SW1 as shown in FIG. 5A. Image data corresponding to the working data in SW1 may be fetched from memory and loaded into a FIFO. One or more pixel columns of the image data in the FIFO (corresponding to a horizontal offset that is to be later applied) may be loaded into a reuse buffer for later use as horizontal reuse data (HRD). All of the image data in the FIFO is then loaded into a sliding window buffer. When the sliding window buffer is full, feature detection operations (e.g., FAST corner detection operations) are performed on candidate pixels within the working data in the sliding window buffer, e.g., as shown in FIGS. 6A-6C.

In connection with the offset scheme, a vertical offset VO may be applied to the pixel coordinates of SW1 by a sliding window controller, so as to define a new sliding window SW1′ vertically offset therefrom as shown in FIG. 5B. One or more rows of image data corresponding to the applied VO may be discarded from the sliding window buffer, and the remaining rows (vertical reuse data) may be shifted (in this case upwards) by an amount corresponding the discarded rows). New image data corresponding to the new data in the new sliding window SW1′ may be fetched from memory and concatenated with the vertical reuse data, such that working data corresponding to SW1′ is presented. Feature detection operations may then be performed on candidate pixels of the new working data in the same manner shown in FIGS. 5A-5C.

The process may iterate until a sliding window reaches a threshold VAdepth, as shown by SW1″ in FIG. 3. At that point, the sliding window controller may apply (in connection with the offset scheme) a diagonal offset 505 to define a new sliding window SW2, as shown in FIG. 5D. The new sliding window SW2 encompasses new working data that includes HRD, i.e., image data that was previously encompassed by SW1 (and stored in a reuse buffer) as well as new data ND. New image data corresponding to ND is read (with a portion stored to reuse buffer 309 for later use as HRD), and is concatenated with HRD in the reuse buffer to present new working data corresponding to SW2 in the sliding window buffer. Feature detection on candidate pixels within the working data of SW2 may then be performed, as shown in FIG. 6E. Vertical offsetting may then be applied to SW2 to define new sliding windows (SW2′, SW2″) as shown in FIGS. 5E-5F, and in the same manner discussed above with regard to the application of vertical offsets to SW1, SW1′, etc.

As FIFO buffer 307 receives new lines of image data 319 from address generator 305 for the population of sliding windows SW1, SW1′, SW1″, etc., sliding window controller 313 may cause a portion of the image data in FIFO buffer 307 to be stored in reuse buffer 309. Specifically, sliding window controller 313 may cause image data corresponding to one or more right most pixel columns of the working data of SW1, SW1′, etc. to be stored in reuse buffer 309 for later use as HRD in the working data of SW2, SW2′, etc. The horizontal working data may be concatenated to new data included in SW2, SW2′, etc. as appropriate. Sliding window controller 313 may also define SW2, SW2′, SW″ such that one or more of its dimensions is/are the same as or greater than the dimensions of SW1, SW′, etc.

One example of this concept is illustrated in FIG. 6E, which illustrates sliding window SW2 as including 7 pixel rows (R0-R7) and 22 pixel columns (C10-C31), indicating that a horizontal offset of 10 pixel columns was applied to SW1″. The resulting new working data includes horizontal reuse data (i.e., pixel rows 10-15—corresponding to the 6 right most pixel rows of the working data in SW1) and new data (i.e., pixel row 16-31), wherein a right most pixel column of the HRD (i.e., column 15) is concatenated to a left most pixel row of the new data (i.e., column 16). In that example, sliding window controller 313 may cause the 6 right most columns of each new row of pixel data in FIFO 307 to be written to reuse buffer 309, for later use as horizontal reuse data in one or more new (horizontally offset) sliding windows.

Returning to FIG. 3, reuse buffer 309 may be any buffer or other memory device that is suitable for storing (horizontal) reuse data consistent with the present disclosure. The size of reuse buffer 309 may be chosen/set based, for example, on the amount of (horizontal) reuse data that is anticipated to be stored therein. The amount of reuse data may depend, for example, on the size of the sliding windows, the position of the threshold points in the image data, the value of offsets that may be applied to define new sliding windows, the resolution of the digital images considered, combinations thereof, and the like. For example, when VAdepth is shallow (i.e., close to a top edge of an image), a relatively small amount of horizontal reuse data may be stored therein, as relatively few new sliding windows will be defined by vertical offsetting until the VAdepth is reached. Conversely when VAdepth is deep (e.g., equal to the total height (Y) of an image), the amount of horizontal reuse data to be stored in a reuse buffer will be relatively large, as a relatively large number of new sliding windows may be defined by vertical offsetting before VAdepth is reached. In sum, increasing VAdepth may increase the amount of data stored in reuse buffer 309 (dictating the use of a larger buffer), whereas decreasing VAdepth may decrease the amount of reuse data stored in reuse buffer (allowing the use of a smaller buffer).

Returning to FIG. 3, as previously discussed all of the image data in FIFO buffer 307 may be conveyed to concatenator 311. In general, concatenator 311 functions to concatenate new image data from FIFO buffer 307 with reuse data, e.g., horizontal reuse data in reuse buffer 309, vertical reuse data retained in sliding window buffer 315, or both. Concatenation may involve, for example, linking reuse data with new image data, e.g., while maintaining appropriate alignment (or indicators of alignment) between pixel columns/rows of new data and pixel columns/rows of reuse data. Alternatively or additionally, concatenation may involve padding new image data with zeros or other data, e.g., in instances where a sliding window encompasses image data that is smaller than a size of a sliding window buffer (315), and/or wherein a sliding window encompasses an edge of an image under consideration.

Sliding window controller 313 may therefore be configured to monitor and/or determine a positional relationship between pixels of new image data (input via FIFO 307) and pixels of reuse data (e.g., input via reuse buffer 309 or retained in sliding window buffer 315), so as to determine how new image data is to be concatenated with reuse data. The manner in which the alignment is performed may depend on whether concatenation involves vertical or horizontal reuse data.

When new image data is to be concatenated with vertical reuse data (e.g., following application of a vertical offset), sliding window controller 313 may cause concatenator 311 (e.g., via control signals) to align a number of pixel columns of new image data in FIFO buffer 307 with corresponding pixel columns of an upper most or lower most pixel row of the vertical reuse data in sliding window buffer 315. Whether concatenation is with the upper most or lower most pixel row of vertical reuse data may depend on the sign of the applied vertical offset. An example of that concept is shown in FIG. 6D.

When new image data in FIFO buffer 307 is to be concatenated with horizontal reuse data (e.g., following application of a horizontal and/or diagonal offset), sliding window controller 313 may cause concatenator 311 to align a number of pixel rows of new image data input through FIFO buffer 307 with corresponding rows of a left most or right most pixel column of horizontal reuse data in reuse buffer 309. Whether concatenation is with the left most or right most pixel column of reuse data may depend on the sign of the applied horizontal offset. An examples of that concept is shown in FIG. 6E.

FIFO buffer 307 may therefore receive new image data from address generator 305 on a row by row or column by column basis, and the retention of horizontal and/or vertical reuse data and the concatenation of reuse data with new image data may also be performed on a row by row or column by column line basis. Concatenator 311 may therefore be understood to concatenate one or more lines of new data with one or more lines of reuse data, resulting in the production of (new) working data which is stored in sliding window buffer 315.

Sliding window buffer 315 is generally configured to store image data corresponding to the working data within a sliding window consistent with the present disclosure. Any suitable buffer or other memory device may be used as sliding window buffer 315. Without limitation, in some embodiments sliding window buffer 315 is a buffer (e.g., a FIFO buffer) that is configured to store an amount of image data that is equal or substantially equal to the amount of working data in a sliding window. The size of sliding window buffer 315 may therefore be based at least in part on the amount of image data that is included in a sliding window used to perform feature detections consistent with the present disclosure. For example, the size of sliding window buffer 315 may equal or be substantially equal to the number of pixels included in the working data of a sliding window, times the amount of data corresponding to each pixel.

In instances where a sliding window is dimensioned to encompass working data including 7 pixel rows that are each 16 pixels wide (as shown in FIGS. 6A-6D), the working data in the sliding window will contain 112 pixels. In such instances and where pixel is represented by 8 bits of data, sliding window buffer 315 may be a buffer that is configured to store 896 bits of data (112 pixels×8 bits per pixel). Alternatively in instances where a sliding window is dimensioned to encompass working data including 7 pixel rows are each 22 pixels wide (as shown in FIG. 6E), the working data in the sliding window will contain 154 pixels. In such instance and where pixel is represented by 8 bits of data, sliding window buffer 315 may be a buffer that is configured to store 1232 bits of data (154 pixels×8 bits per pixel). In instances where sliding windows of different dimensions are used, the size of sliding window buffer 315 may be set based at least in part on the dimensions of the largest sliding window that may be employed. Of course, those sizes are enumerated for the sake of example only and any suitably sized buffer/memory device may be used as sliding window buffer 315. In instances when a sliding window encompassing working data that is smaller than the size of a sliding window buffer, a portion of the image data in sliding window buffer may be padded with zeros or other data.

Sliding window controller 313 may also be configured to monitor sliding window buffer 315 and determine whether it is full or not. When sliding window buffer 315 is not full, sliding window controller 313 may issue further control signals to address generator 305, causing address generator 305 to provide additional new image data (new data) to FIFO buffer 307. The additional new data may be concatenated with reuse data by concatenator 311 as noted above, and the resulting working data may be stored in sliding window buffer 315. The provision of new data may continue until sliding window buffer 315 is full. At that point sliding window controller 313 may cause the working data therein to be conveyed to detection array 317 for the performance of feature detection operations, e.g., by detection array 317.

Detection array 317 is generally configured to perform or cause the performance of feature detection operations on candidate pixels within working data contained in and/or conveyed by sliding window buffer 315. In that regard detection array 317 includes one or a plurality of feature detection processors FD0, FD1, FD2 . . . FDn, wherein each feature detection processor is configured to perform feature detection operations one on or more candidate pixels in working data.

In embodiments the working data in sliding window buffer 315 includes a plurality of candidate pixels, and the one or more feature detection processor(s) are configured to operate on each of the plurality of candidate pixels in series. Alternatively, in embodiments detection array 317 includes a plurality of feature detection processors, wherein each feature detection processor is configured to operate on a respective one of the plurality of candidate pixels in the working data in parallel. In such instances initiation of the operation of any one feature detection processor on one candidate pixel may not be conditioned on completion of feature detection operations by another feature detection processor on another candidate pixel. The amount of time needed to perform feature detection operations on all candidate pixels within the working data may therefore be reduced, relative to serial processing of such candidate pixels and/or the performance of feature detection operations by a general purpose processor. For example, in some embodiments feature detection array 317 may be configured such that feature detection operations on each candidate pixel within working data in sliding window buffer 315 may be completed by feature detection processors FD0 . . . FDn in a single compute cycle.

The number of feature detection processors is not limited, and one or more feature detection processors may be included in feature detection array 317. In some embodiments the number of feature detection processors in feature detection array is set based at least in part on a maximum number of expected candidate pixels within working data of a sliding window (i.e., within the image data stored in sliding window buffer 315). For example where sliding window buffer 315 can store image data that is expected to contain a maximum of 10 candidate pixels, ten feature detection processors may be used in feature detection array 317. In instances where sliding window buffer can store image data that is expected to contain a maximum of 16 candidate pixels, 16 feature detection processors may be used. In instances where the number of candidate pixels in the sliding window buffer 315 is expected to change, the number of feature detection processors in feature detection array 317 may correspond to the largest number of candidate pixels that may be present in the image data within sliding window buffer 315. Thus, the number of feature detection processors used may be set based on the size of the working data in sliding window buffer 315 and the nature of the feature detection operations performed.

The type and nature of the feature detection operations performed by feature detection processors FD0 . . . FDn, etc. is not limited, and any suitable type of feature detection operations may be used. Without limitation, in some embodiments feature detection processors FD0 . . . FDn are configured to perform or otherwise implement corner or other feature detection operations on image data, e.g., using one or more versions of the FAST corner detector as described herein. In some embodiments feature detection processors FD0 . . . FDn perform FAST9 or FAST12 corner detection operations on candidate pixels within working data of a sliding window. In such instances, the terms “9” and “12” refer to the number n of pixels on a Bresenham circle surrounding a candidate pixel P that must each have an intensity greater than the intensity Iₚ of the candidate pixel plus a threshold (t) (i.e., Iₚ+t), or which each have an intensity less than Iₚ−t in order for a feature detection processor to classify the relevant candidate pixel as a corner. Without limitation, in embodiments each feature detection processor is a hardware processor that is purpose built to perform feature detection operations consistent with one or more feature detectors, such as a FAST corner detector.

FIGS. 6A-6E depict one example of the performance of feature detection operations on candidate pixels within working data of sliding windows consistent with the present disclosure, e.g., using one or more feature detection processors that are configured to implement FAST corner detection using a Bresenham circle of radius 3. As discussed above working data encompassed by a first sliding window SW1 may be provided to sliding window buffer 315. As shown in FIGS. 6A-6C, the working data includes 10 candidate pixels p1 . . . p10. As shown, pixels p1 and p10 are the first and last candidate pixels in the working data, as they are the first and last pixels which may be bounded by a Bresenham circle of radius 3 (illustrated by shaded pixels 1-16). Consistent with the foregoing discussion, feature detection processors within feature detection array 317 may perform FAST corner detection on candidate pixels, e.g., serially or in parallel. Without limitation, in some embodiments feature detection array includes at least 10 feature detection processors, wherein each feature detection processor performs FAST feature detection on a corresponding one of candidate pixels p 1 . . . p10. In such instances FAST corner detection may be performed on candidate pixels p1 . . . p10 in parallel.

As described above a sliding window controller may apply vertical, horizontal, or other offsets to define new sliding windows that include new working data. In any case, application of an offset will result in the presentation of new working data in a sliding window buffer, wherein the new working data includes new candidate pixels for the performance feature detection operations such as FAST corner detection. In the case of a vertical offset, the new candidate pixels will be offset vertically relative to previously considered candidate pixels. That concept is shown in FIG. 6D, which shows the performance of FAST corner detection on new candidate pixels p1′ . . . p10′ in new working data of sliding window SW1′, wherein the new candidate pixels are present in 1 pixel row below previously considered candidate pixels p1-p10.

Of course the number of candidate pixels in working data is not limited to the 10 candidate pixels shown in FIGS. 6A-6C. Indeed in some embodiments the number of candidate pixels in working data may vary, with the number of candidate pixels depending on the dimensions of the working data in a sliding window. For example as discussed above in connection with FIG. 5D, a diagonal and/or horizontal offset may be applied to define a new sliding window that includes encompasses new working data that is greater in size than the working data in a previous sliding window.

For example, a new sliding window SW2 may be defined that has a larger sliding window width (SW2_{W}) than the width (SW1″_{W}) of a previous sliding window SW1″. The number of candidate pixels in SW2 may therefore be increased, relative to the number of candidate pixels in SW1″. That concept is shown in FIG. 6E, which illustrates SW2 to encompass working data that is 7 pixel rows high and 22 pixel columns wide, which is larger than the sliding window width of previously used sliding windows (SW1, SW1′, SW1″, as shown in FIGS. 6A-6D). SW2 therefore encompasses working data that includes 16 candidate pixels (p11 . . . p27), as opposed to the working data of SW1 . . . SW1″ which include 10 candidate pixels (p1 . . . p10). It is noted that FIG. 6E shows pixels p9 and p10 for the purpose of illustrating the inclusion of horizontal reuse data (HRD) in the working data of SW2. However, pixels p9 and p10 are not candidate pixels for the performance of FAST corner detection in FIG. 6E as they cannot be bounded by a Bresenham circle of radius 3. Thus in the embodiment of FIG. 6E, pixels p11 and p27 are the first and last candidate pixels within the working data of SW2.

As further shown in FIG. 3 system 300 includes a detection controller 303. In general, detection controller 303 is configured to monitor performance of feature detection operations by detection array 317, to control the recordation of detected features in memory, and to inform address generator 305 when feature detection operations on all candidate pixels in the working data under consideration is complete.

In embodiments detection controller 303 is configured to monitor the performance of feature detection operations by detection array 317 and, when one or more candidate pixels are classified a feature (e.g., a corner), to cause the recordation of such feature in a memory device such as shared memory 219. For example, feature detection array 317 may issue a detection signal to detection controller 303, wherein the detection signal includes a detection indicator that specifies when a feature detection processor of feature detection array 317 has and/or has not classified a candidate pixel as a feature. Candidate pixels classified as a feature by a feature detection controller are referred to herein as “detected features.”

In response to receipt of a feature detection signal including a feature detection indicator indicating a detected feature, detection controller 303 may cause a record of the detected feature(s) to be stored in shared memory 219. The record may be included in a data structure such as but not limited to detected feature list 321. In embodiments, detected feature list 321 is in the form of a lookup table or other data structure in which detected features are recorded by the pixel coordinates of their corresponding candidate pixel.

In additional embodiments, detection controller 303 may record or cause the recordation (e.g., in detected feature list 321) of the pixel coordinates of a detected feature, along with the pixel coordinates of each of the pixels in the pixel neighborhood used by feature detection array 317 to classify the corresponding candidate pixel as a detected feature (hereinafter, “corresponding neighborhood”). And in still further embodiments, detection controller may cause the storage (e.g., in detected feature list 321) of the pixel coordinates of a candidate pixel classified as a detected feature, the pixel coordinates of each of the pixels in the corresponding neighborhood, as well as supplemental information. Non-limiting examples of supplemental information include intensity information, i.e., the intensity of the candidate pixel identified as a feature as well as the intensity of each of the pixels within the corresponding neighborhood. Supplemental information may also include a strength score for a detected feature, e.g., a strength score determined by iterative scoring of a detected feature as discussed below. The information in detected feature list 321 (e.g., detected feature coordinates, pixel neighborhood coordinates, supplemental information, etc.) may be used by a tracking component of the present disclosure as a “reference patch” e.g., for the performance of feature tracking operations such as normalized cross correlation (NCC).

Detection controller 303 may be further configured to monitor the performance of feature detection operations by feature detection array 317 on candidate pixels in working data, and inform address generator 305 when the performance of such feature detection operations on all candidate pixels by detection array 317 is complete. In that regard, the feature detection signal produced by feature detection array 317 may include a completion indicator indicating whether feature detection operations on all candidate pixels within working data under consideration are or are not complete. In response to receipt of a feature detection signal including a completion indicator indicating completion of feature detection operations, feature detection controller 303 may signal such completion to address generator 305 and/or sliding window controller 313. For example, detection controller 303 may issue one or more detection complete signals to address generator 305 and/or sliding window controller 313, signaling the completion of feature detection operations by feature detection array 317 on current working data.

In response to one or more detection complete signals, the sliding window controller 313 may apply an offset to the sliding window in question to define a new sliding window as explained above. The specification and/storage of reuse data, the performance of feature detection operations, etc., may then proceed as described above, and may iterate until an end of the image under consideration is reached (FIG. 5H).

As may be appreciated from the foregoing, significant amount of image data may be reused in the performance of feature detection operations on candidate pixels. For example when a vertical offset is applied to a current sliding window, only the working data in a sliding window buffer that corresponds to the vertical offset is discarded, and the remainder of the working data is retained in the sliding window buffer as vertical reuse data. As a result, only a relatively small amount of new image data may need to be input (e.g., via FIFO 317) to produce new working data that includes different candidate pixels for the performance of feature detection operations. As a result, significantly fewer reads of new image data may need to be performed, relative to feature detection processes which rely on the fetching of a completely new neighborhood of image data prior to the performance of each feature detection operation.

Moreover when a horizontal offset is applied, horizontal reuse data (e.g., within a reuse buffer) may be concatenated with new image lines of image data to produce a new set of working data. Due to the speed and/or location of the reuse buffer (storing horizontal reuse data), the performance of feature detection operations may be accelerated relative to the feature detection processes that rely on the fetching of a completely new neighborhoods of image data prior to the performance of each feature detection operation. The use of horizontal reuse data may also present larger numbers of candidate pixels for analysis, further increasing the speed with which feature detection can be performed (particularly when a plurality of feature detection processors can operate on a plurality of candidate pixels in parallel).

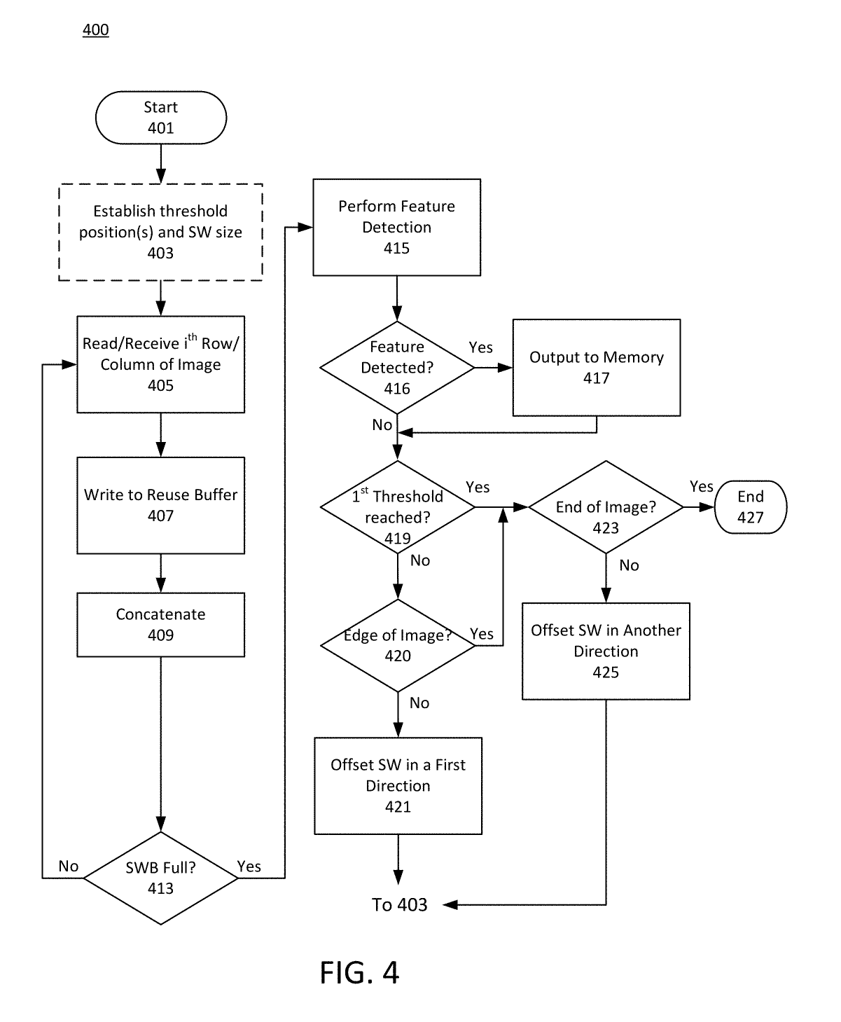

Another aspect of the present disclosure relates to methods for performing feature detection using one or more sliding windows. In that regard reference is made to FIG. 4, which is a flow chart of operations of one example of a method 400 for performing feature detection consistent with the present disclosure. For convenience and ease of understanding, the operations of method 400 will be described briefly in conjunction with FIGS. 5A-5H and 6A-6E.

Prior to discussing the method of FIG. 4, as described above an image sensor and/or an ISP may provide all or a portion of image data of a digital image for the performance of image detection operations. The digital image may be represented as a two dimensional field of pixels, such that the digital image has a total image height Y (in pixels) and a total image width X (in pixels). This concept is shown in FIGS. 5A-5H, each of which depict a digital image 500 having a total image height Y and a total image width X. The resolution of (i.e., number of pixels within) image 500 may be determined by multiplying X and Y. It is noted that for the sake of clarity and ease of understanding, the following discussion of the method of FIG. 4 and the embodiment of FIGS. 5A-5H and 6A-6C focuses on the performance of feature detection operations on a single image 500. It should be understood that the technologies described herein are not limited to the performance of feature detection operations on single images, and that image 500 may be one of a plurality of images, e.g., in a video stream provided by an image sensor and/or ISP.

Returning to FIG. 4, method 400 may begin at block 401. The method may then proceed to optional block 403, pursuant to which one or more threshold positions may be identified, and the dimensions of a first sliding window may be determined. As discussed above, such operations may be performed by a sliding window controller of a detection component of a SLAM HWA. FIG. 5A depicts one example embodiment in which a first threshold (e.g., VAdepth) and a first sliding window SW1 are defined within digital image 500 wherein SW1 is positioned in an upper left hand corner of image 500. In this example a threshold vertical access depth (VAdepth) is defined at a vertical pixel coordinate that is below SW1. Of course the position of the first sliding window SW1 and VAdepth are not limited to the positions illustrated in FIGS. 5A and 5B. Indeed, the first sliding window SW1 may encompass working data at any suitable location within image 200, and VAdepth may be set to any suitable location. For example, in some embodiments SW1 may be initially located below VAdepth (e.g., where upward vertical offsets are to be applied to define new sliding windows). Similarly, points other than VAdepth may be used as a first threshold position. For example, in some embodiments a bottom vertical edge 503 of image 500 may be used as a first threshold. Still further, a horizontal access width (HAwidth, not shown) may be used as a first threshold, and may be defined at a point along horizontal edge 501 of image 500.

Returning to FIG. 4, following the operations of block 403 (or if such operations are not required) the method may proceed to block 405. Pursuant to block 405, i^{th} rows and/or columns of image data within the working data of a sliding window may be read and/or received (e.g., from memory) on a row by row or a column by column basis and provided to a buffer, such as a FIFO buffer. The nature of such operations is the same as described above with regard to the performance of address generator 305 and FIFO buffer 307, and therefore are not reiterated. Each i^{th} row/column may correspond to all or a portion of a single row/column of working data within a sliding window (e.g., SW1, SW1′, SW1″, SW2 . . . ).

Following the operations of block 405 the method may proceed to block 407. Pursuant to block 407 a portion of the i^{th} column/row of data within the FIFO buffer may be written to a reuse buffer, e.g., for later use as horizontal reuse data. This concept is described previously in connection with the storage of reuse data in reuse buffer 309 and is therefore not reiterated. The method may then proceed to block 409, pursuant to which the data in the FIFO buffer may optionally be concatenated with reuse data, resulting in the production of one or more rows/columns of new working data that is stored in a sliding window buffer. As discussed above the reuse data may include horizontal reuse data, vertical reuse data, padding (e.g., where the sliding window is smaller than sliding window buffer 315 and/or overlaps horizontal edge 501 or vertical edge 503 of image 500), or a combination thereof), etc.

The method may then proceed to block 413, pursuant to which a determination is made as to whether the sliding window buffer is full (e.g., of working data). If not, the method may loop back to block 405. But if so, the method may advance to block 415. Pursuant to block 415, feature detection operations may be performed on working data within the sliding window buffer, e.g., by one or more feature detection processors of a feature detection array. The feature detection operations may include FAST corner detection on candidate pixels within the working data, e.g., as shown in FIGS. 6A-6E and described above.

The method may then proceed to block 416, pursuant to which a determination may be made as to whether any features have been detected (i.e., whether any candidate pixels within working data have been classified as detected features (corners)). If so the method may advance to block 417, pursuant to which a record of the detected feature(s) may be made, e.g., in a shared memory. The record may be a data structure in the form of a detected feature list, wherein the detected feature list includes pixel coordinates of a candidate pixel classified as a detected feature, optionally in combination with pixel coordinates of a pixel neighborhood used to classify the detected feature and/or supplemental information as discussed above.

Following the recordation of a detected feature (or if no features are detected), the method may advance to block 419. Pursuant to block 419 a determination may be made as to whether a first threshold has been reached in a digital image under consideration. As discussed above in connection with FIGS. 6A-6C, the first threshold may correspond to a threshold vertical access depth VAdepth within a digital image 500 under consideration. This may be useful when a vertical offset is to be initially applied to define new sliding windows. Although not shown, in other embodiments a horizontal access width (HAwidth) may be used as a first threshold. That may be useful where a horizontal offset is to be initially applied to define one or more new sliding windows. In either case, the VAdepth or HAwidth be set to the total image height or width respectively, or at some position along the vertical or horizontal axis of the image under consideration. As discussed, the position of VAdepth and HAwidth may affect the amount of reuse data stored to a reuse buffer and, hence, may be determinative of the size of the reuse buffer.

If pursuant to block 416 it is determined that the first threshold has not been reached (See FIGS. 5A, 5B and 5E) the method may advance to block 420, pursuant to which a determination may be made as to whether a vertical or horizontal edge of the digital image under consideration has been reached. The determination of whether a current sliding window has reached an edge of an image may be performed as described previously (e.g., with a sliding window controller).

If a current sliding window has not reached an edge of an image, the method may proceed from block 420 to block 421, pursuant to which a first offset may be applied to a current sliding window, so as to define a new sliding window that is offset in a first direction relative to the current sliding window. That concept is illustrated in FIGS. 5B, 5C and 5E, which depict the application of a first offset (in this case vertical offset VO) to a current sliding window (e.g., SW1, SW1′, SW2) so as to define a new sliding window (SW1′, SW1″, SW2′) that is vertically offset relative to the current sliding window (SW1, SW1′, SW2). Of course, the first offset applied pursuant to block 421 need not be a vertical offset. Indeed in some embodiments, the first offset applied pursuant to block 421 is a horizontal offset, in which case a new sliding window may be defined that is horizontally offset relative to a current sliding window.

Following the operations of block 421 the method may loop back to block 403, pursuant to which one or more new thresholds may optionally be defined, after which the method may again advance to block 405. During the ensuing performance of the operations of block 405, however, only new image data included in the new working data of the new sliding window is read from memory pursuant to block 407, and the new data is concatenated with (horizontal or vertical) reuse data pursuant to block 409 as discussed above. Otherwise, the process may continue as described above with regard to the new sliding window.

Returning to blocks 419 and 420, if it is determined that a current sliding window has reached a first threshold (block 419) or an edge of an image (block 420), the method may proceed to block 423. Pursuant to block 423, a determination may be made as to whether an end of the image under consideration has been reached. Whether a current sliding window has reached an end of an image may be determined as described previously (e.g., with a sliding window controller).

If pursuant to block 423 it is determined that a current sliding window has not reached an end of an image, the method may advance to block 425. Pursuant to block 425 an (e.g., second, third, etc.) offset may be applied to a current sliding window, so as to define a new sliding window that is offset from the current sliding window in a direction that differs from the first offset direction applied pursuant to block 421. For example and as illustrated in FIGS. 5D and 5F, a second offset (in this case diagonal offset 505—blocks 419, 423, 425) may be applied to a current sliding window (SW1″, SW2″) that has reached a first threshold (in this case Vadepth) so as to define a new sliding window (SW2, SW3) that is diagonally offset relative to the current sliding window (SW1″, SW2″). Alternatively and as illustrated in FIG. 5G a third offset (blocks 420, 423, 425) that differs from the first and second offsets may be applied to a sliding window that has reached a first threshold and abuts an edge of an image 500, so as to define a new window (SW4) that is offset from the current sliding window.

Following the operations of block 425 the method may loop back to block 403 and iterate. In instances where a new sliding window has been defined below a previous threshold, one or more new threshold positions within the image data may be defined pursuant to block 403. That concept is shown in FIG. 5G, which depicts the application of a third offset 507 to a sliding window SW″, so as to define a new sliding window SW4 that is below a first threshold (Vadepth), as well as the establishment of a new threshold (VAdepth′). The method may then iterate as described above. As before, only new image data corresponding to new data in the new sliding window is read pursuant to block 405, and the new data is concatenated with reuse data (if any) pursuant to block 409.

Returning to block 423, when it is determined that a current sliding window has reached an end of an image, the method may proceed to block 427 and end.

As discussed above the feature detection component 215 includes a feature detection array that is configured to perform feature detection operations on one or more candidate pixels in working data within a sliding window buffer. For example, the feature detection processor(s) within the feature detection may be configured to perform FAST corner detection on candidate pixels within the working data in a sliding window buffer. As discussed above performance of FAST corner detection generally involves a comparison of the intensity of a plurality of pixels on the periphery of a Bresenham circle around a candidate pixel, p, to the intensity (Iₚ) of the candidate pixel plus or minus a threshold t. When a threshold number (n) of contiguous pixels on the periphery of the Bresenham circle each have an intensity that is greater than Iₚ+t or less than Iₚ−t, candidate pixel p may be classified as a corner.

Although the above implementation of the FAST corner detector can be effective to identify corners within an input image, in some instances a large number of false positives may be produced. For example, where the applied threshold t is set at a relatively low value, a large number of candidate pixels may be classified as a corner using the FAST corner detection methodology. Similarly if the threshold number (n) of contiguous pixels required to classify a candidate pixel as a corner is relatively small (e.g., less than or equal to 12), a large number of candidate pixels may be classified as corners using the FAST corner detection methodology. In either case, a large number of false positives (i.e. improperly classified candidate pixels) may be included in the output.

With the foregoing in mind the detection component 215 of the technologies described herein can significantly accelerate the performance of FAST corner detection operations on candidate pixels, relative to the performance of such operations by a general purpose processor. Indeed in embodiments, the feature detection arrays described herein can perform FAST corner detection on a plurality of pixels in parallel, such the each of the candidate pixels may be classified as a corner (or not) in a single compute cycle). This increase in performance has opened opportunities to improve the accuracy of the output produced by the performance of FAST corner detection operations on candidate pixels.

Another embodiment of the present disclosure therefore relates to a method of performing iterative FAST corner detection with a feature detection array. In general such a method includes the provision of working data to a feature detection array, wherein the working data includes a plurality of candidate pixels suitable for the performance of FAST corner detection operations. As discussed above in connection with feature detection array 317, the feature detection array used may include a plurality of feature detection processors, wherein each feature detection processor is configured to iteratively perform FAST corner detection operations (e.g. FAST9, FAST12, etc.) on a respective one of the plurality of candidate pixels in parallel.

In a first iteration, a feature detection processor may evaluate the “cornerness” of a candidate pixel in the working data using a first threshold (t1) and the FAST corner detection methodology. That is, a feature detection processor may compare the intensity of pixels on the periphery of a Bresenham circle of radius 3 to the intensity (Iₚ) of a candidate pixel (p) plus or minus the first threshold t1 (i.e. Iₚ+/−t1). If a threshold number (n) of contiguous pixels on the periphery of the Bresenham circle each have an intensity greater than Iₚ+t or less than Iₚ−t the candidate pixel may be classified as a corner.

The feature detection processor may then adjust the applied threshold upwards. That is, the feature detection processor may adjust t1 to t2, wherein t2 is a higher threshold than t1. The feature detection processor may then perform FAST corner detection on the same candidate pixel using the adjusted threshold t2. If the candidate pixel remains classified as a corner using the adjusted threshold t2, the feature detection processor may adjust the threshold upwards again. I.e., the feature detection processor may adjust t2 to t3, where t3 is a higher threshold than t2. FAST corner detection using t3 may then be performed. The process may iterate until a threshold is applied the causes the feature detection processor to not classify the candidate pixel as a corner.

At that point, the feature detection processor may determine a strength score indicative of the confidence with which a candidate pixel is believed to be a corner. In embodiments, the strength score may be or based at least in part on the last threshold applied at which a candidate pixel was classified as a corner by a feature detection processor. In some embodiments, the strength score of a detected feature (corner) may be recorded as supplemental data, etc. e.g., in a detected feature list such as detected feature list 321 discussed above.

In some instances all detected features may be recorded regardless of their strength score. Alternatively, in some embodiments only detected corners with a threshold strength score may be recorded, e.g., in detected feature list 321. Put in other terms, a detected corner with a strength score lower than the threshold strength score may be classified as a false positive by a feature detection processor, and therefore not recorded.

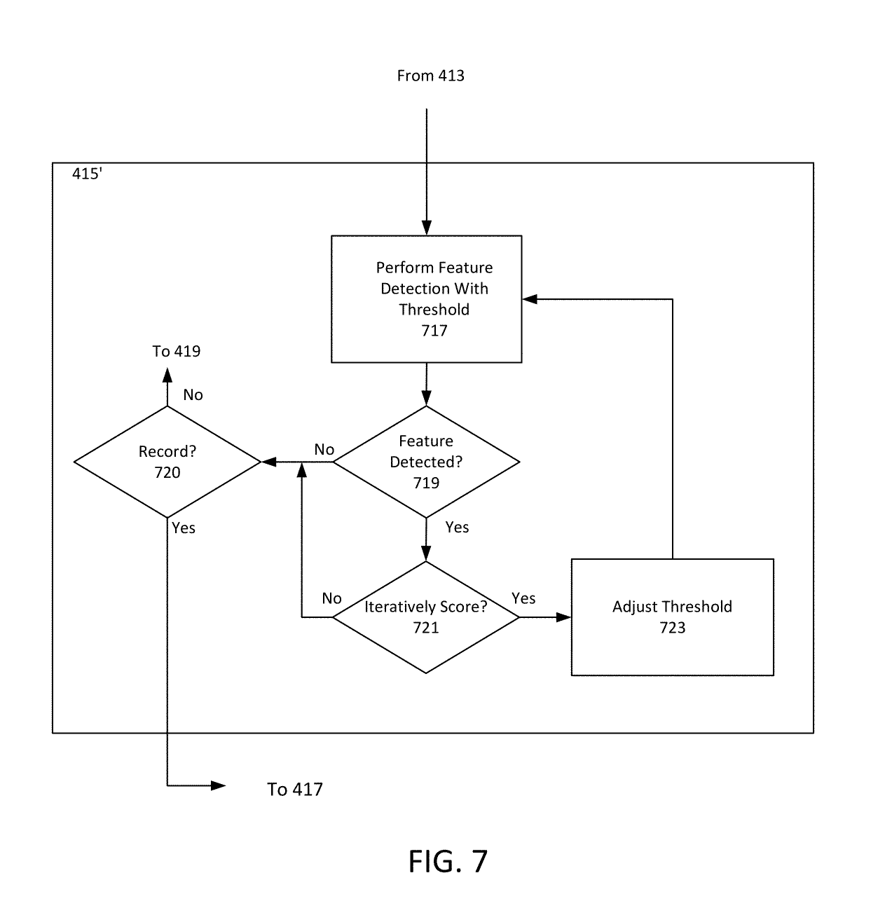

FIG. 7 depicts one example of the performance of iterative FAST corner detection in the context of the method 400 of FIG. 4. Before discussing that implementation, it is emphasized that implementation of the iterative fast scoring methodology described herein is not limited to methods in which a feature detection component consistent with the present disclosure is used, or to the method of FIG. 4.

As explained previously in connection with block 413 of FIG. 4, once a sliding window buffer is full of working data feature detection operations may be performed. As shown in FIG. 7, in some embodiments method 400 may proceed from block 413 to block 415′, pursuant to which iterative feature detection operations may be performed. Operations of block 415′ may begin with block 717, pursuant to which feature detection operations with a first threshold may be performed. In embodiments, the feature detection operations performed pursuant to block 717 may be FAST corner detection operations, such as FAST9 or FAST12 corner detection operations.

The method may then proceed from block 717 to block 719, pursuant to which a determination may be made as to whether a candidate pixel has been classified as a feature using the applied threshold, i.e., whether a feature (corner) has been detected. When it is determined that a candidate pixel has been classified as a feature using an applied threshold (i.e., a feature/corner has been detected), the method may proceed from block 719 to block 721, pursuant to which a determination may be made as to whether the detected feature is to be iteratively scored. If not the method may proceed to block 720. But if so the method may proceed to block 723, pursuant to which the applied threshold may be adjusted (e.g., increased). The method may then loop back to block 717, pursuant to which feature detection operations are performed using the adjusted threshold.

The process may iterate until pursuant to block 719 it is determined that a feature has not been detected, i.e., that a candidate pixel has not been classified as a corner using an applied threshold. At that point the method may proceed to block 720. Pursuant to block 720, a determination may be made as to whether record is to be made, e.g., in memory pursuant to block 417 of method 400. In some embodiments, the outcome of block 720 may depend on whether a strength score has been generated for a candidate pixel under consideration. As noted above, the strength score may be or correspond to the highest threshold at which a candidate pixel was classified as a feature. In embodiments where candidate pixel fails to be classified as a feature with the application of a default threshold, no strength score may be generated. In such instances a determination not to record may be made pursuant to block 720, and the method may proceed to block 419 of FIG. 4. Iterative scoring may therefore be quickly terminated when a candidate pixel fails to be classified as a feature/corner using a default threshold.

In instances where a strength score has been generated however (i.e., where a candidate pixel has been classified as a feature/corner using at least a default threshold or higher) the determination made pursuant to block 720 may vary. In some embodiments, a determination may be made pursuant to block 720 to record all candidate pixels for which a strength score has been generated (i.e., all features). In such instances, the method may proceed from block 720 to block 417 of FIG. 4 for all detected features.

Alternatively, in some embodiments the outcome of block 720 may depend on whether a strength score of a feature exceeds a minimum strength threshold. If so, the method may proceed from block 720 to block 419 of FIG. 4, pursuant to which features having a strength score exceeding the minimum strength threshold may be recorded. If a strength score of a feature is below the minimum strength threshold, however, the method may proceed to block 419 of FIG. 4.

The foregoing discussion has focused on feature detection and the performance of feature detection operations on image data using a sliding window, e.g., using FAST corner detection. As noted above however, SLAM HWA 211 may not be limited to the performance of feature detection operations alone. Indeed as shown in FIG. 2B, SLAM HWA 211 may include optional feature tracking component 217.

Another aspect of the present disclosure therefore relates to technologies for performing feature tracking. Such technologies include systems, devices and methods for performing feature tracking, as discussed below. Such systems may suitable for use in computer vision applications such as visual SLAM, or other applications in which the detection and/or tracking of features within image data may be desired.

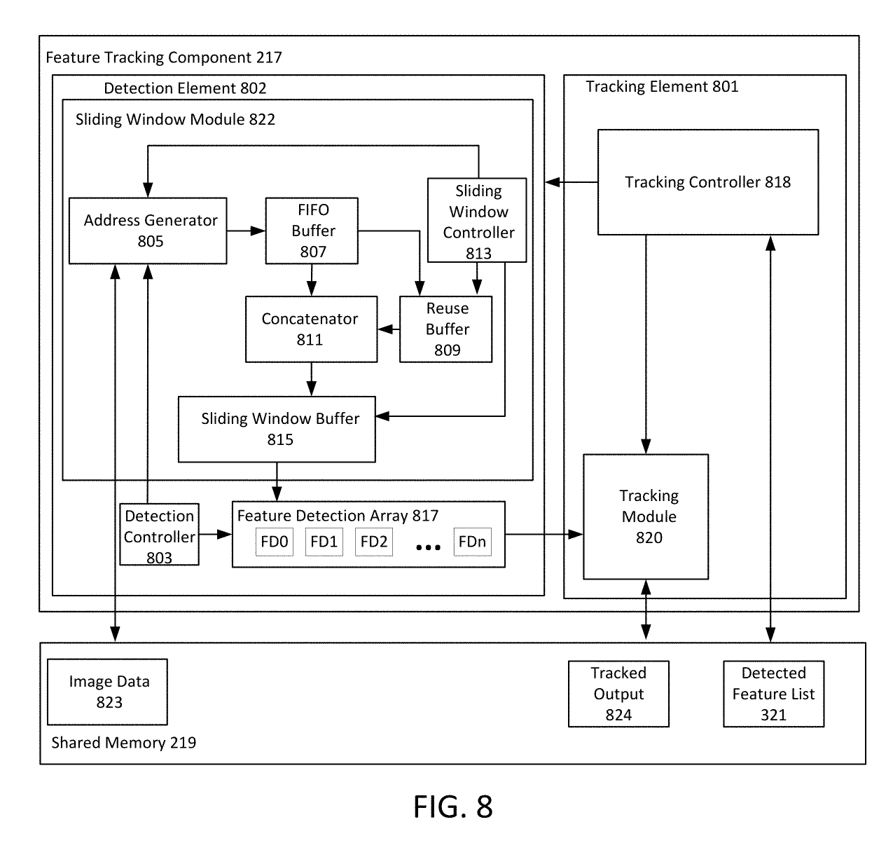

Reference is therefore made to FIG. 8, which depicts one example of a feature tracking component 217 consistent with the present disclosure. It is noted that while feature tracking component 217 is described herein and depicted in the FIGS. in the context of its use in SLAM HWA 211 (e.g., in conjunction with feature detection component 215), it should be understood that tracking component 217 may be used in other contexts. For example, tracking component 217 may be used independently of SLAM HWA 211, and may be suitable for tracking features detected by any suitable featured detection methodology.

As shown in FIG. 8, feature tracking component 217 includes a tracking element 801 and a detection element 802. Tracking element 801 includes a tracking controller 818 and tracking module 820. Detection element 802 includes detection controller 803, feature detection array 817, and sliding window module 822. Sliding window module 822 includes address generator 805, FIFO buffer 807, reuse buffer 809, concatenator 811, sliding window controller 813, and sliding window buffer 815. The nature and function of the components of detection element 802 is generally the same as the corresponding components of feature detection component 215 described above. A detailed description of the operation of the components of detection element 802 is therefore not reiterated in the interest of brevity.

In general, feature tracking component 217 is configured to track one or more detected features using image data, e.g., provided by an image sensor and/or an ISP. The tracked features may be stored in a detected feature list such as detected feature list 321 stored in a shared memory of a SLAM HWA, as shown in FIGS. 3 and 8.

To perform feature tracking, tracking controller 818 of tracking element 801 is generally configured to select one or more detected features for tracking, e.g., from detected feature list 321. In embodiments, the detected feature list 321 may include a lookup table or other recordation list that includes a plurality of feature identifiers, wherein each feature identifier is associated with pixel coordinates of a candidate pixel classified as a feature (e.g., by detection component 315), pixel coordinates of pixels in the candidate pixel's corresponding pixel neighborhood, and supplemental information in the form of intensity information for the candidate pixel and the pixels in the candidate pixel's corresponding neighborhood. The supplemental information may further include a strength score associated with a feature, as described above. Entries within detected feature list 321 may be produced in response to operations by a feature detection component of the present disclosure, such as feature detection component 215.

In embodiments tracking controller 818 may be configured to determine a selection order. The selection order may specify an order in which features within detected feature list 321 are to be tracked and, thus, an order in which such features are to be selected for tracking. Tracking controller 818 may determine the selection order based at least in part on an order in which new image data 823 is provided (rastered) by an image sensor and/or an ISP, an order in which features in a detected feature list are expected to appear in new image data 823, the pixel coordinates of detected features within a detected feature list, or a combination thereof. In some embodiments, tracking controller 818 is configured to determine a selection order based at least in part on an order in which the features in a detected feature list are expected to appear in new image data, and/or pixel coordinates of the detected features in a detected feature list.

For example, in embodiments in which new image data 823 is rastered from top to bottom (or vice versa) by an image sensor and/or ISP, tracking controller 818 may be configured to determine a selection order based at least in part on the vertical (y) pixel coordinates associated with each feature identifier in feature detection list 321. For example, tracking controller 818 may determine a selection order in which features corresponding to feature identifier with the highest or lowest vertical coordinate(s) are tracked first. Alternatively or additionally, tracking controller 818 may also be configured to determine a selection order based at least in part on the vertical (y) pixel coordinates associated with each feature identifier in detected feature list 321, as well as based on a prediction of the location of a region of interest in which features in detected feature list 321 are anticipated to appear in new image data.

In any case tracking controller 818 may select features within detected feature list, e.g., in accordance with a selection order. Once a feature is selected for tracking, tracking controller 818 and/or tracking module 820 may generate a reference patch based on the pixel coordinates and intensity information of the candidate pixel corresponding to the selected feature and pixels in its corresponding pixel neighborhood. Generally, the reference patch is configured such that is it suitable for use as a reference patch in a cross-correlation process, such as but not limited to normalized cross correlation (NCC), Hamming distance over census transform of reference and test patches, Hamming distances over a binary feature descriptor of reference and test patches, combinations thereof, and the like. Without limitation, in embodiments some form of NCC is used by tracking element 801, in which case the reference patch is configured such that is suitable of use as a reference patch in an NCC process.

Tracking controller 818 may also be configured to identify one or more regions of interest within new image data (e.g., a new image frame provided by an image sensor and/or ISP). Generally, a region of interest is a portion of new image data at which the reference patch is predicted to appear, and may be represented as a set of pixel coordinates within new image data. In embodiments, tracking controller 818 may identify one or more regions of interest based at least in part on sensor data from one or more sensors (not shown) of a platform with which feature tracking component is used. For example, sensor data may be used by tracking controller 818 to determine an estimate of the movement of a detected feature relative to an image sensor (e.g., image sensor 201), e.g., by the application of extended Kalman filtering on sensor (e.g., gyroscope, accelerometer, etc.) data, the output of previous feature tracking operations, or another method. Based on that estimate, tracking controller 818 may deduce one or more regions of interest within new image data 823 provided by an image sensor and/or ISP, i.e., one or more portions of new image data 823 that are predicted to include the reference patch and, thus, the selected feature.

Having determined one or more regions of interest, tracking controller 818 may convey pixel coordinates of the region(s) of interest to detection component 802 or, more specifically, to sliding window controller 813 of sliding window module 822. As noted above, the nature and function of the components of detection component 802 are substantially similar to the nature and function of the elements of feature detection component 215 described above. That is like feature detection component 215, detection element 802 functions to perform feature detection operations (e.g., FAST corner detection) on image data using a sliding window. Instead of performing such operations on an entire image, however, detection element 802 may be configured to perform feature detection operations on only the region(s) of interest identified by tracking controller 818.

In instances where the regions of interest are relatively small, sliding window controller 813 may be configured to define relatively small threshold positions (e.g., VAdepth, HAwidth, etc.), so as to optimize the use of reuse data. Moreover, unlike some embodiments of feature detection component 215, all features detected by feature detection array may be output without iterative scoring. And still further the output of detection element 802 will include pixel coordinates of each detected feature and of pixels within its corresponding neighborhood, as well as intensity information for each of those pixels. Put in other terms, detection element 802 may output one or more test patches, wherein each test patch includes the pixel coordinates of a detected feature and pixels within its corresponding neighborhood, as well as the intensity of each of the candidate pixel classified as the detected feature and pixels within the corresponding neighborhood. Finally, as shown in FIG. 8, the output of detection element 802 (i.e., of feature detection array 817) is provided to tracking module 820.

Tracking module 820 is general configure to perform feature tracking operations using a reference patch and one or more test patches. In that regard tracking controller 818 may provide a reference patch of a feature selected for tracking to tracking module 820. In addition, tracking module may receive one or more test patches from detection element 802 or, more specifically, from feature detection array 817. Tracking module 820 may then determine whether one or more received test patches correspond to the reference patch and, therefore, correlates to the feature selected for tracking. For example, in embodiments tracking module 820 may utilize a template matching methodology to determine whether one or more received test patches correspond to a reference patch. Without limitation, in some embodiments tracking module 820 utilizes a normalized cross correlation (NCC) function to determine whether one or more received test patches correspond to a reference patch.

In that regard, equation (1) below gives a basic definition of one example of an NCC function that may be implemented by tracking module 820:

$$γ = \frac{{Σ}_{x , y} ( f ( x , y ) - {\overline{f}}_{u , v} ) ( t ( x - u , y - v ) - \overline{t} )}{\sqrt{{{Σ}_{x , y} ( f ( x , y ) - {\overline{f}}_{u , v} )}^{2} {{Σ}_{x , y} ( t ( x - u , y - v ) - \overline{t} )}^{2}}} \qquad ( 1 )$$

in which γ is the normalized cross correlation coefficient (also referred to herein as NCC score), f(x,y) is the intensity value of a test patch of the size (Mₓ×M_{y}) at the point (x,y) (where x is an element of the set {0, . . . , Mₓ−1} and y is an element of the set {0, . . . , M_{y}−1}, and t is the reference patch which has been shifted by u steps in the x direction and by v steps in the y direction. In (1), ƒ̅_{u,v} is the mean intensity value of f(x,y) within the area of the reference patch t shifted to (u,v), as calculated by equation (2) below:

$${\overline{f}}_{u , v} = \frac{1}{{N}_{x} {N}_{y}} {\sum }_{x = u}^{u + {N}_{x} - 1} {\sum }_{y = v}^{v + {N}_{y} - 1} f ( x , y ) . \qquad ( 2 )$$

With similar notation, t̅ is the mean intensity value of the reference patch t. The denominator in (1) is the variance of the zero mean image function ƒ(x,y)−ƒ̅ and the shifted zero mean template function t(x−y, y−v)−t̅.

In embodiments tracking module 820 may, using equation (1) above, calculate a NCC score for each test patch versus a given reference patch (i.e. for each test patch relative to a selected feature for tracking). Tracking module 820 may then determine whether any of the test patches provided by detection element 802 correspond to the selected feature, i.e., whether any test patch is a tracked feature. Tracking module may make this determination by comparing the NCC scores generated from the use of test patches. In embodiments, tracking module 802 may identify a test patch producing the highest NCC score as corresponding to the reference patch (i.e., to the selected feature). Alternatively, in embodiments tracking module 802 may compare NCC scores generated from the use of test patches to an NCC score threshold. Test patches producing NCC scores below the NCC score threshold may be discarded, and a test patch producing the highest NCC score above the NCC score threshold may be identified as corresponding to the reference patch, i.e., to a tracked feature. Tracking controller 818 may cause tracking module 820 to store a tracked feature in shared memory 219, such as in a data structure such as tracked output 824 or detected feature list 321. In embodiments, the tracked feature may include pixel coordinates and intensity information of a detected feature in the test patch identified as a tracked feature, as well as its corresponding pixel neighborhood. Tracking of the selected feature may then continue using the tracked feature as a selected feature, as discussed above.

Use of the NCC score threshold may limit or prevent tracking module 820 from erroneously identifying a test patch having a low NCC score as corresponding to a reference patch. This may be particularly useful in situations where tracking controller 818 identifies a region of interest within new image data 319 that does not in fact include the selected feature, or which includes one or more features that do not in fact correlate to the selected feature for tracking. In instances where none of the test patches from a region of interest exceed the NCC score threshold, tracking module 820 may determine that none of the test patches correspond to the reference patch and, thus, none of the test patches include the selected feature. In such instances, the tracking controller 818 may define a new region of interest for evaluation by detection element 802, may select another feature for tracking, or may cease feature tracking, as appropriate.

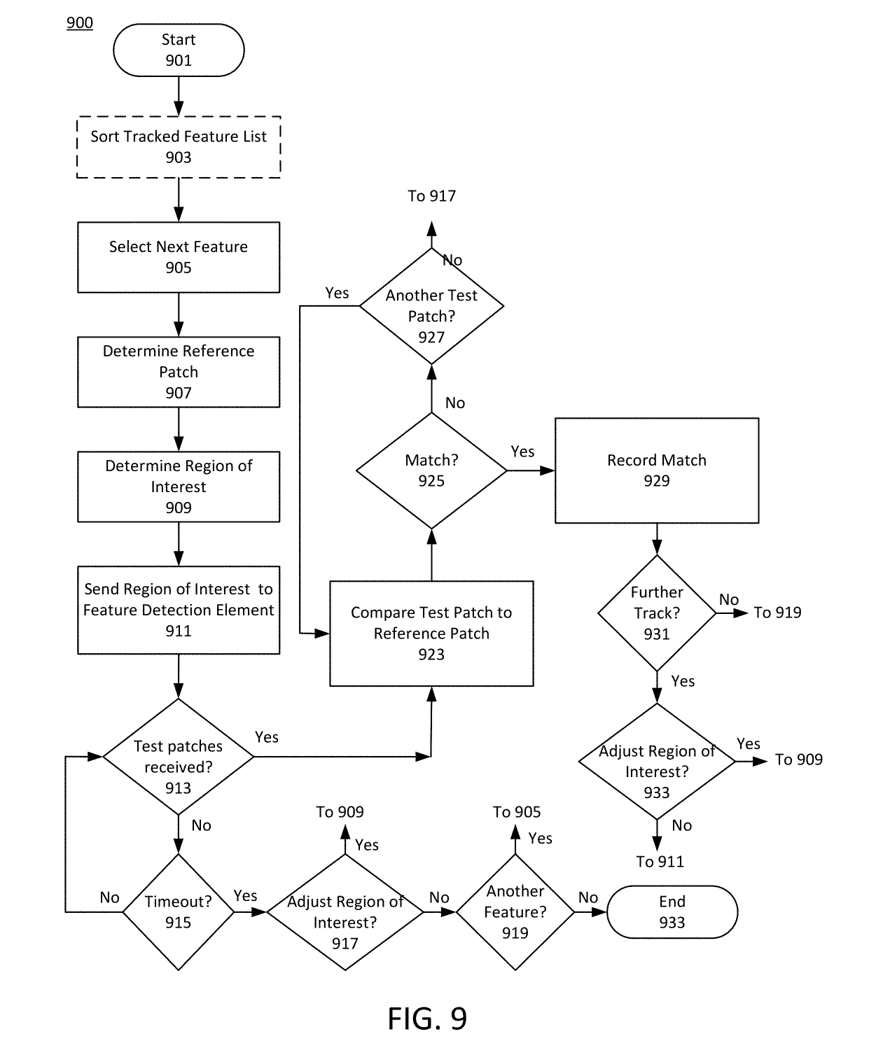

Another aspect of the present disclosure related to methods for performing feature tracking. Reference is therefore made to FIG. 9, which is a flow chart of example operations of one method of performing feature tracking consistent with the present disclosure. As shown method 900 begins at block 901. The method may then proceed to optional block 903, pursuant to which a tracked feature list including a plurality of detected features (e.g., from a detection component) may be sorted as discussed below. Following the operations of block 903 or if such operations are not required the method may proceed to block 905, pursuant to which a feature may be selected for tracking. As noted previously a feature may selected may be based in a manner that is consistent with a selection order, which in turn may be set based on sorting of the tracked feature list (block 903) or in another manner.

Once a feature has been selected the method may proceed to block 907, pursuant to which a reference patch may be determined. Determination of a reference patch may involve reading pixel coordinates and intensity information for a candidate pixel corresponding to the selected feature and its corresponding pixel neighborhood from a memory. Once a reference patch has been determined the method may proceed to block 909, pursuant to which a region of interest in new image data may be determined. Determination of a region of interest may involve determining (e.g., from application of Kalman filtering to sensor data or another method) the relative movement of an image sensor relative to when the selected feature was previously tracked and estimating a position within new image data that the tracked feature is anticipated to be located based on the determined relative movement. Of course, that is but one example of how a region of interest may be determined, and any suitable method of determining a region of interest may be used. In any event, the region of interest may correspond to a subset of pixel coordinates of new image data.

The method may then advance to block 911, pursuant to which the region of interest may be conveyed to a detection element, such as a detection element configured to perform feature tracking using a sliding window as described herein. As discussed above, the detection element may perform feature detection operations on the region of interest in new image data and output one or more test patches corresponding to features detected in the region of interest, if any.

The method may then proceed to block 913, pursuant to which a determination may be made as to whether any test patches have been received from the detection unit. If not, the method may proceed to block 915, pursuant to which a determination may be made as to whether a threshold time period has elapsed (timeout). If not, the method may loop back to block 913, but if so the method may advance from block 915 to block 917. Pursuant to block 917 a determination may be made as to whether the region of interest is to be adjusted. If so, the method may loop back to block 909, pursuant to which a new region of interest may be defined. But if not the method may advance to block 919. Pursuant to block 919, a determination may be made as to whether another feature is to be selected for tracking. If so, the method may loop back to block 905, but if not, the method may advance to block 933 and end.

Returning to block 913, if one or more test patches have been received the method may advance to block 923. Pursuant to block 923, the test patch and reference patch may be compared, e.g., using a patch matching function as noted above. Without limitation, the test patch and reference patch may be subject to normalized cross correlation (NCC), e.g., using equation 1 above or some other method (e.g., integer precision NCC as discussed later). The method may then proceed to block 925, pursuant to which a determination may be made as to whether any of the test patch(es) correspond to (match) the reference patch. In embodiments, the outcome of block 925 in some embodiments may depend on whether an NCC score of generated based on one of the test patches exceeds a minimum NCC score. That being said, if pursuant to block 925 it is determined that a test patch does not match (correspond) to the reference patch, the method may proceed to block 927, pursuant to which a determination may be made as to whether there is another test patch to be considered. If so, the method may loop top block 923, but if not, the method may proceed to block 917.

Returning to block 925, if a test patch is determined to correspond to a reference patch the method may proceed to block 929. Pursuant to block 929 the test patch determined to match the reference patch may be recorded as a tracked feature, e.g., in a shared memory. In embodiments, the tracked feature may be recorded in a tracked output and/or a detected feature list, i.e., one or more data structures in a computer readable memory.

The method may then advance from block 929 to block 931, pursuant to which a determination may be made as to whether the tracked feature is to be further tracked. If not, the method may proceed to block 919, but if so, the method may advance to block 933. Pursuant to block 933, a determination may be made as to whether an adjustment to the region of interest should be made. The outcome of block 933 may depend, for example, on whether sensor data suggests that the position of a tracked feature relative to an image sensor has changed (i.e., whether the image sensor has moved). If the region of interest is to be changed, the method may loop back to block 909, pursuant to which a new region of interest may be determined. But if the region of interest is not to be changed, the method may advance to block 911, pursuant to which a previous region of interest may be sent to a detection element. The method may then continue as discussed above until block 933 is reached.

As discussed above, in embodiments the feature tracking technologies of the present disclosure may use normalized cross correlation (NCC) to compare one or more test patches to a reference patch. In general the performance of NCC using a test patch and a reference patch involves the following three floating point calculations: 1) patch mean calculation—i.e., the computation of a patch mean for both the test patch and the reference patches (i.e., by summing the intensity of N pixels of each patch, followed by dividing the result by N); 2) patch normalization—i.e., the normalization of each of the reference patch and the test patch (i.e., by subtracting the test or reference patch mean from the intensity value of each pixel in the test patch or reference patch, respectively); and 3) patch cross correlation—i.e., cross correlation of the normalized test and reference patches (generally involving floating point multiplication and division operations). The output of floating point NCC (e.g., pursuant to equation (1) above) is a fractional NCC score that ranges from 0.0 to 1.0.

Although floating point precision NCC is useful for some applications, it can be costly in terms of latency, logic area, and power consumption. It may therefore be desirable in some applications to implement feature detection using NCC in a different manner. In that regard the inventors recognized one point of NCC patch matching is to find a “maxima” on the NCC score plane. Consequently, a modification/transform of the NCC score values that doesn't impact the relative position of a maximal point may still be useful for finding a maxima or best match between a reference patch and a test patch.

Another aspect of the present disclosure therefore relates to systems, devices, and methods for performing feature tracking operations using integer precision NCC. In general, the term “integer precision NCC” is used herein to refer to an NCC operation that compares at least one test patch to a reference patch, and which is at least partially performed with integer based computation. Without limitation, in embodiments integer precision NCC is an NCC operation that compares compare two patches and which is fully performed with integer based computation.

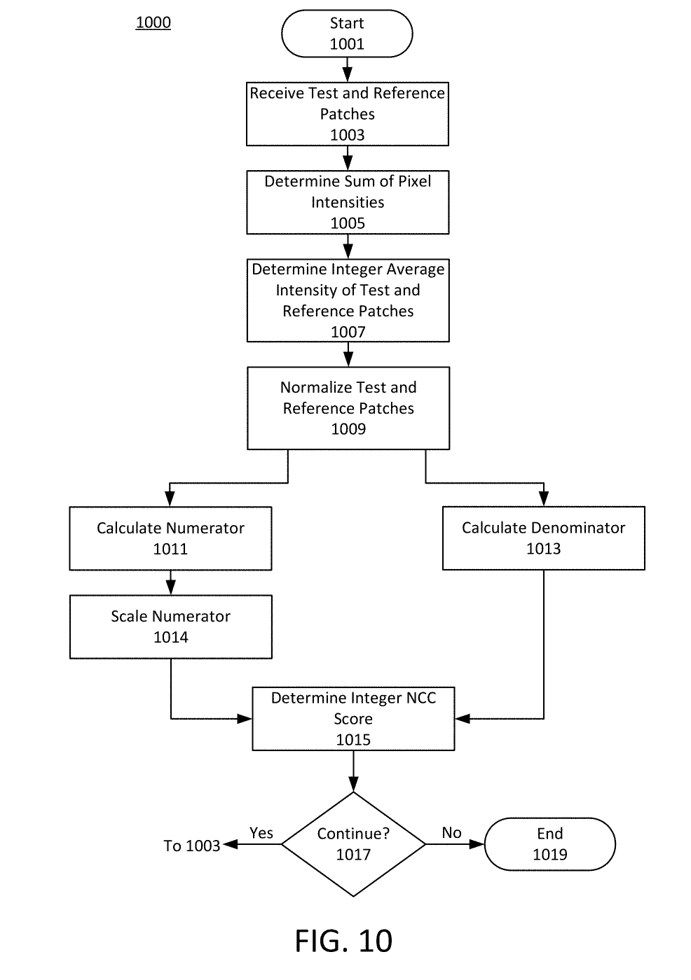

Reference is therefore made to FIG. 10, which is a flow diagram of example operations in accordance with one method of performing feature tracking using integer precision NCC. The operations of FIG. 10 may be performed, for example, as part of or in replacement of the operations of block 923 of the method of FIG. 9. The method may be implemented independently as well, however, as described below.

As shown, method 1000 begins at block 1001. The method may then proceed to block 1003, pursuant to which one or more test patches and a reference patch are received. The test patch(es) and reference patch may be determined, for example, in the same manner as blocks 907 and 913 of FIG. 9. Once the test patch(es) and reference patch are received the method may advance to block 1005, pursuant to which the sum of the pixel intensities of all of the pixels in the test patch(es) may be determined, and the sum of the pixel intensities of all of the pixels in the reference patch may be determined.

The method may then proceed to block 1007, pursuant to which an integer average intensity of both the test patch(es) and the reference patch may be determined. Determining an integer average intensity may include performing integer constant division on the sum of the pixel intensities of the test patch(es) and the sum of the pixel intensities of the test patch(es) and the sum of the pixel intensities of the reference patch. In embodiments, performing integer constant division may be implemented using scale multiplication with unbiased nearest integer rounding to determine an integer average pixel intensity of the test patch(es) and an integer average intensity of the reference patch.

The method may then proceed to block 1009, pursuant to which the test and reference patches may be normalized to produce normalized test and normalized reference patches. In embodiments, normalization of each test patch may be performed by subtracting the integer average intensity of the test patch from the intensity of each of its pixels. Likewise, normalization of the reference patch may be performed by subtracting the integer average intensity of the reference patch from the intensity of each of its pixels.

Following block 1009, the method may proceed to blocks 1011 and 1013. Pursuant to block 1011, the numerator term of the NCC algorithm (e.g., of equation (1) above) may be determined. Determination of the numerator term may involve, for example, multiplying integer values of the intensity of pixels from the test and reference patches pair wise (i.e., pixel (0,0) of the reference patch is multiplied with pixel (0,0) of the test patch, pixel (0,1) of the reference patch is multiplied with pixel (0,1) of the test patch etc. . . . ) and the resulting product terms are added together to compute the numerator. For convenience, such operations are referred to herein as “multiply-accumulating.” The numerator may then be scaled by an appropriate integer scalar to produce a scaled numerator that is within a desired integer value range, e.g., a width and/or number of bits that are desired in a final integer NCC score. In embodiments, the integer scalar is 2¹⁰, such that the final integer NCC score is a 10 bit value.

Concurrently or at a different period of time, the denominator term of the NCC algorithm (e.g. of equation (1) above) may be determined pursuant to block 1013. Like block 1011, determination of the denominator term of the NCC algorithm may be determined by multiply accumulating the test and reference patches pixel pair wise.

The method may then proceed to block 1015, pursuant to which an integer NCC score may be determined. Determination of an integer NCC score may involve, for example dividing the scaled numerator term by the denominator term. Like a floating point precision NCC score, the integer NCC score may be indicative of the degree to which a test patch and a reference patch are similar, with higher integer NCC scores being indicative of a greater degree of similarity. In embodiments, the integer NCC range may be significantly greater than the 0-1.0 range of NCC scores produced by floating point NCC. For example, in some embodiments the integer NCC score may range from 0 to about 2000, such as from 0 to about 1500, or even from 0 to about 1023. Such ranges are of enumerated for the sake of example only, and any suitable integer NCC score range may be used.

Put in other terms, in embodiments integer precision NCC operations may be performed to compare a reference patch to a test patch. In such embodiments, an NCC function identical to equation (1) may be applied using a test and a reference patch, except that each floating point operation of equation (1) is replaced with a corresponding integer operation.

Following the operations of block 1015 the method may proceed to block 1017, pursuant to which a determination may be made as to whether calculation of an integer NCC score is to continue. The outcome of block 1017 may depend, for example, on whether there are additional test patches to compare to a reference patch. If so the method may loop back to block 1003, but if not the method may proceed to block 1019 and end. Alternatively in instances where the method of FIG. 10 is being used in the context of a feature tracking component, the method may proceed from block 1017 to block 925 of the method of FIG. 9.

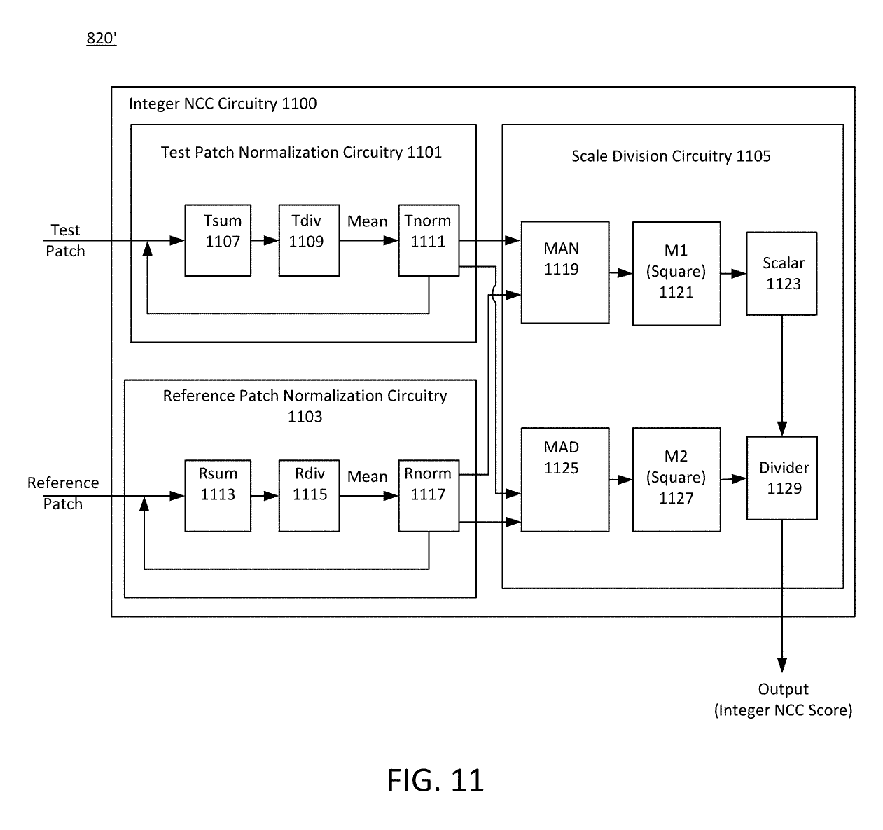

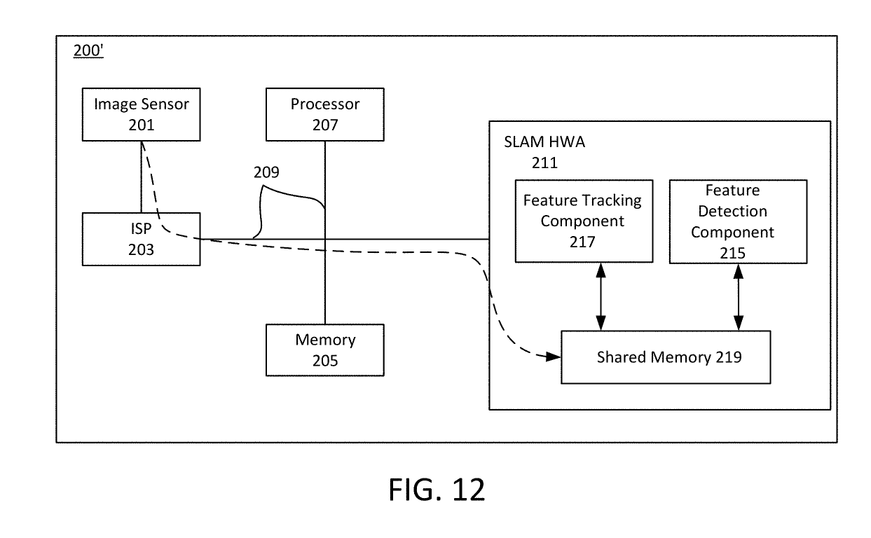

Reference is now made to FIG. 11, which is a block diagram of one example of a system for performing integer precision NCC. It is noted that the following discussion focuses on the use of the system shown in FIG. 11 in the context of a tracking module in a tracking element consistent with the present disclosure, e.g., tracking element 801 of FIG. 8. It should be understood that such description is for the sake of example only, and that the system of FIG. 11 may be used independently or as an element of another suitable system.

As shown in FIG. 11 system 820′ includes integer NCC circuitry 1100, which is generally configured to produce an integer NCC score consistent with the present disclosure, e.g., as described above in connection with FIG. 10. Integer NCC circuitry 11 includes test patch normalization circuitry (TPNC) 1101, reference patch normalization circuitry (RPNC) 1103, and scale division circuitry (SDC) 1105. In general, TPNC 1101 is configured to determine a integer precision normalized test patch, and RPNC is configured to determine a integer precision normalized reference patch. Scale division circuitry 1105 is generally configured to determine a integer scaled numerator term and an integer denominator term for an integer NCC function, and to produce an integer NCC score by dividing the integer scaled numerator term by the integer denominator term.

More specifically, a test patch may be input to TPNC 1101. The test patch may include pixel coordinates for a detected feature and its corresponding neighborhood in region of interest, as well as intensity information for the detected feature and pixels in the corresponding neighborhood. As shown, the test patch may be first operated on by test patch summation circuitry (Tsum 1107), which functions to calculate a sum of the pixel intensities of the test patch. The resulting sum is provided to test divider circuitry 1109, which is configured to calculate an integer average intensity of the test patch, e.g., by performing integer constant division on the sum provided by Tsum 1107 using scale multiplication with unbiased integer rounding. The resulting integer average intensity of the test patch is then provided to test patch normalization circuitry (Tnorm 1111), which normalizes the test patch by subtracting the integer average intensity from the intensity of each pixel in the test patch, thereby producing a normalized test patch.

As also shown in FIG. 11 a reference patch may be input to RPNC 1103. The reference patch may include pixel coordinates for a feature selected for tracking and its corresponding neighborhood in region of interest, as well as intensity information for the selected feature and pixels in the corresponding neighborhood. As shown, the reference patch may be first operated on by reference patch summation circuitry (Rsum 1113), which functions to calculate a sum of the pixel intensities of the reference patch. The resulting sum is provided to reference divider circuitry 1115, which is configured to calculate an integer average intensity of the reference patch, e.g., by performing integer constant division on the sum provided by Rsum 1113 using scale multiplication with unbiased integer rounding. The resulting integer average intensity of the reference patch is then provided to reference patch normalization circuitry (Rnorm 1117), which normalizes the reference patch by subtracting the integer average intensity from the intensity of each pixel in the reference patch, thereby producing a normalized reference patch.

As further shown in FIG. 11, the normalized reference and normalized test patches are provided to multiply-accumulator numerator (MAN) circuitry 1119 and multiply-accumulator denominator (MAD) circuitry 1125. MAN 1119 may be in the form of a multiply-adder tree that is configured to multiply accumulate the normalized reference and test patches pixel pair wise for the numerator term of the integer NCC algorithm. A square of the output of MAN 1119 is generated by first multiplier circuitry M1 (1121), and the result is scaled by an integer value by scalar 1123, so as to produce a scaled integer numerator term. MAD 1125 may be in the form of a multiply-adder tree that is configured to multiply accumulate the normalized reference and test patches pixel pair wise for the denominator term of the integer NCC algorithm. The square of the resulting output is then determined by second multiplier circuitry M2 (1127), thereby producing the denominator term for the integer NCC algorithm. The scaled numerator and denominator terms are then provided from scalar circuitry 1123 and second multiplier circuitry 1127 to divider circuitry 1129. Divider circuitry is configured to divide the scaled numerator term by the denominator term, and producing and outputting an integer NCC score.

As discussed above with regard to FIG. 1A, visual SLAM is often implemented in software executed by a general purpose processor. In such instances, image data for processing is often produced by an image sensor and/or an ISP and saved to system RAM or longer terms storage (e.g., a hard drive, solid state drive, etc.) before it is worked upon by the processor. That concept is shown in FIG. 1A, which shows data flow 111 progressing from image sensor 101 to ISP 103 and then to memory 105, after which it progresses to processor 107. In embodiments using a SLAM HWA (e.g., FIG. 2A), a similar data flow may be used, except that image data may be stored to system memory 205, after which it is transferred to SLAM HWA 211 for processing. Although useful, the writing of image data to system memory 205 prior to the operations of SLAM HWA can increase latency and may entail performance of a large number of read/write operations as image data is written to and read from memory 205 to the shared memory of SLAM HWA 211.

With the foregoing in mind another aspect of the present disclosure relates to technologies for performing on-the-fly feature detection and/or tracking, also referred to herein as “real time” feature detection and/or tracking. In general, such technologies avoid the need to write image data to external system memory (e.g., memory 205) prior to the performance of feature detection and tracking operations. Rather, image data from an image sensor 201 and/or ISP 203 may be transferred (via bus 209) director to shared memory 219 of SLAM HWA 211. In such instances, feature detection and/or tracking operations may begin when a threshold amount of image data is received in shared memory 219. In embodiments, the threshold amount of data may be set by one or more thresholds applied by a sliding window controller of feature detection component 215, i.e., sliding window controller 313 as discussed above.

For example and as discussed previously, in embodiments the sliding window controller may set a threshold Vadepth and/or HAwidth. In real-time tracking embodiments, the threshold Vadepth/HAwidth may not only affect how a sliding window moves and how much data is reused during feature detection, it may also affect when feature detection operations begin by specifying a minimum amount of image data that needs to be present in shared memory 219 before feature detection operations begin.

In general, larger VAdepth/HAwidth values specify that a larger minimum amount of image data must be present in shared memory 219 prior to the initiation of feature tracking operations, but at the cost of increased latency. In contrast, smaller Vadepth/HAwidth values specify that a smaller minimum amount of image data must be present in shared memory 219 prior to the initiation of feature tracking operations, but may risk the occurrence of a buffer starvation condition (when feature tracking operations are performed on image data within shared memory 219 at a faster rate than image data is provided to shared memory 219. Therefore in embodiments the sliding window controller may be configured to set a Vadepth and/or HAwidth to avoid a buffer starvation condition (i.e., where image data from shared memory 219 is analyzed faster than new data can be replenished), while at the same time achieving a desired amount of latency. This may be accomplished, for example, by setting Vadepth and/or HAwidth based at least in part on a rate at which new image data is provided to shared memory 219, and a rate at which SLAM HWA 211 can perform feature detection and processing operations. Without limitation, in some embodiments a sliding window controller of feature detection component 215 sets a Vadepth of 32 rows of image data.

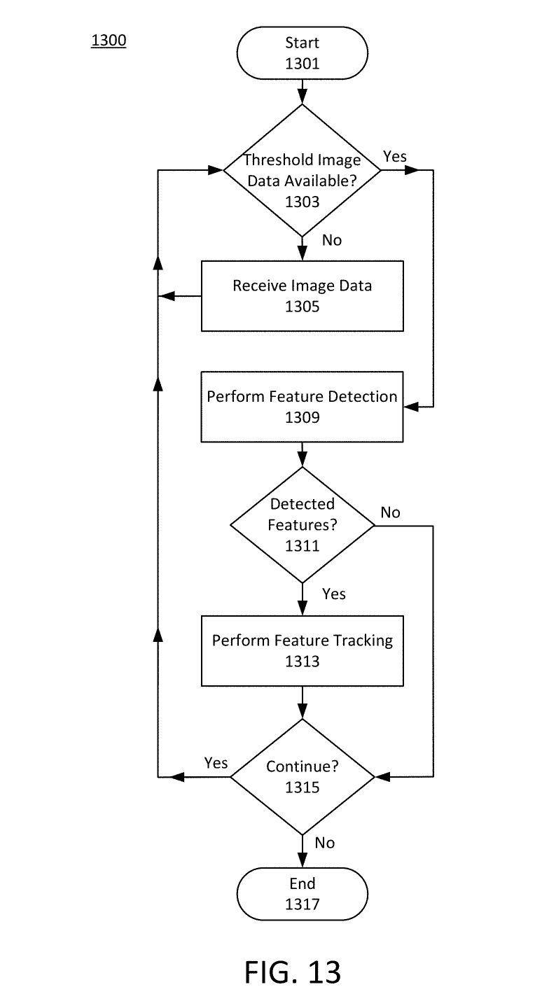

Another aspect of the present disclosure relates to methods for performing real time feature detection and tracking, e.g., using a SLAM HWA consistent with the present disclosure. In that regard reference is made to FIG. 13, which is a flow diagram of example operations of one example of a method of performing real-time feature detection and tracking consistent with the present disclosure. As shown method 1300 begins at block 1301. The method may then proceed to block 1303, pursuant to which a determination may be made as to whether a threshold amount of image data is available (e.g., in shared memory 219). As noted, the threshold amount of image data may be set based on one or more threshold positions (Vadepth, HAwidth, etc.) set by a sliding window controller. If a threshold amount of data has not been received the method may advance to block 1305, pursuant to which image data may be received, after which the method loops back to block 1303. If a threshold amount of image data has been received, however, the method may proceed to block 1309.

Pursuant to block 1309 feature detection operations may be performed using image data in the shared memory. Performance of the feature detection operations may be the same as previously described above in connection with FIGS. 3-6E. The method may then proceed to block 1309, pursuant to which a determination may be made as to whether any features were detected. If not, the method may proceed to block 1313. But when one or more features are detected method may advance to block 1311. Pursuant to block 1311, feature tracking operations may be performed using a detected feature (and its pixel neighborhood) as a reference patch, as discussed above in connection with FIGS. 7-11. The method may then proceed to block 1313.

Pursuant to block 1315, a determination may be made as to whether the method is to continue. If so, the method may loop back to block 1303, but if not, the method may proceed to block 1315 and end.

Embodiments of the methods described herein may be implemented in an apparatus (e.g. a computing device) that includes one or more computer readable storage mediums having stored thereon, individually or in combination, instructions that when executed by one or more processors perform the methods described herein. Here, the processor may include, for example, a system CPU (e.g., core processor) and/or programmable circuitry. Thus, it is intended that operations according to the methods described herein may be distributed among one or a plurality of physical devices, such as processing structures at one or several different physical locations. Also, it is intended that the method operations may be performed individually or in a sub combination, as would be understood by one skilled in the art. Thus, not all of the operations of each of the flow charts need to be performed, and the present disclosure expressly intends that all sub combinations of such operations are enabled as would be understood by one of ordinary skill in the art.

The computer readable storage medium may include any type of tangible medium, for example, any type of disk including floppy disks, optical disks, compact disk read-only memories (CD-ROMs), compact disk rewritables (CD-RWs), digital versatile disks (DVDs) and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions.

### EXAMPLES

The following examples represent additional non-limiting embodiments of the present disclosure.

### Example 1

According to this example there is provided a computer implemented method for detecting features in a digital image, including the following computer implemented operations: defining a first sliding window encompassing first working data, the first working data including a first portion of image data of the digital image; performing first feature detection operations on one or more first candidate pixels in the first working data in the sliding window buffer to classify whether the one or more first candidate pixels is or is not a feature; defining a second sliding window encompassing second working data, the second working data including reuse data and new data; and performing second feature detection operations on one or more second candidate pixels within the second working data to classify whether the one or more second candidate pixels is or is not a feature; wherein the reuse data includes a portion of the first working data, and the new data includes image data of the digital image that was not included in the first working data.

### Example 2

This example includes any or all of the features of example 1, wherein defining the second sliding window includes applying a first offset to pixel coordinates of pixels included in the first working data, such that the second sliding window is offset from the first sliding window in a first direction.

### Example 3

This example includes any or all of the features of example 2, wherein the first offset is selected from the group consisting of a vertical offset, a horizontal offset, and a diagonal offset.

### Example 4

This example includes any or all of the features of example 3, wherein the offset is a vertical offset and the reuse data includes vertical reuse data, the vertical reuse data being one or more pixel rows of the first working data.

### Example 5

This example includes any or all of the features of example 4, wherein: the first feature detection operations are performed when the first working data is present in a sliding window buffer; the vertical reuse data is an uppermost or lowermost set of pixel rows of the first working data in the sliding window buffer; and defining the second sliding window includes concatenating an uppermost or lowermost pixel row of the new data with the vertical reuse data in the sliding window buffer, such that the second working data is present in the sliding window buffer.

### Example 6

This example includes any or all of the features of example 4, wherein: the first feature detection operations are performed when the first working data is present in a sliding window buffer; and the vertical reuse data includes one or more pixel rows of the first working data stored in a reuse buffer; and defining the second sliding window includes concatenating an uppermost or lowermost pixel row of the new data with the vertical reuse data in the reuse buffer, such that the second working data is present in the sliding window buffer.

### Example 7

This example includes any or all of the features of example 3, wherein the first offset is a horizontal offset and the reuse data includes horizontal reuse data, the horizontal reuse data being one or more pixel columns of the first working data.

### Example 8

This example includes any or all of the features of example 7, wherein: the first feature detection operations are performed when the first working data is present in a sliding window buffer; and the horizontal reuse data is a rightmost of leftmost set of pixel columns of the first working data in the sliding window buffer and defining the second sliding window includes concatenating a leftmost or rightmost pixel column of the new data with the horizontal reuse data in the sliding window buffer, such that the second working data is present in the sliding window buffer.

### Example 9

This example includes any or all of the features of example 7, wherein: the first feature detection operations are performed when the first working data is present in a sliding window buffer; and the horizontal reuse data includes one or more pixel columns of the first working data stored in a reuse buffer; and defining the second sliding window includes concatenating a leftmost or rightmost pixel column of the new data with the horizontal reuse data in the reuse buffer, such that the second working data is present in the sliding window buffer.

### Example 10

This example includes any or all of the features of example 2, wherein: the first sliding window has a first sliding window width (SW1W) and a first sliding window height (SW1H); the first offset is a diagonal offset including a vertical offset component and a horizontal offset component; and at least one of the vertical offset component and the horizontal offset component is smaller than SW1H or SW1W, respectively.

### Example 11

This example includes any or all of the features of example 1, wherein defining the second sliding window includes: determining whether the first sliding window has reached a threshold position within the digital image; when the first sliding window has not reached the threshold position, applying a first offset to pixel coordinates of pixels included in the first working data, such that the second sliding window is offset from the first sliding window in a first direction; and when the first sliding window has reached the threshold position, applying a second offset to pixel coordinates of pixels included in the first working data, such that the second sliding window is offset from the first sliding window in a second direction that is different from the first direction.

### Example 12

This example includes any or all of the features of example 11, wherein the threshold position is selected from the group consisting of a threshold position along a vertical axis of the digital image (VAdepth), a threshold position along a horizontal axis of the digital image (HAwidth), an edge of the digital image, and combinations thereof.

### Example 13

This example includes any or all of the features of example 1, wherein: the first working data includes a plurality of first candidate pixels; the second working data includes a plurality of second candidate pixels that are different from the first candidate pixels; performing the first feature detection operations includes performing features from accelerated segment test (FAST) operations on each of the plurality of first candidate pixels, so as to classify each of the first candidate pixels as a feature or as not a feature; and performing the second feature detection operations includes performing FAST operations on each of the plurality of second candidate pixels, so as to classify each of the second candidate pixels as a feature or as not a feature.

### Example 14

This example includes any or all of the features of example 13, wherein the FAST operations comprise determining whether the one of the following relationships is met by a threshold number n of pixels on a periphery of a Bresenham circle bounding a candidate pixel: (1) I>Ip+t; or (2) I<Ip−t; wherein: I is an intensity of a pixel on the periphery of the Bresenham circle, Ip is an intensity of the single candidate pixel and t is a first threshold; and the single candidate pixel is classified as a feature only when a threshold number n of pixels on the periphery of the Bresenham circle satisfy relationship (1) or relationship (2).

### Example 15

This example includes any or all of the features of example 14, wherein when a candidate pixel is classified as a feature using a first threshold, t, the method further includes: increasing the first threshold (t1) to a second threshold (t2); determining whether a threshold number n of pixels on the Bresenham circle satisfy relationship (1) or relationship (2) using the second threshold (t2); and when a threshold number n of pixels on the Bresenham circle do not satisfy relationship (1) or relationship (2) using the second threshold (t2); determining a strength score for the candidate pixel, the strength score indicating a degree of confidence with which the candidate pixel under consideration is a feature.

### Example 16

This example includes any or all of the features of example 1, wherein the first working data is present in a sliding window buffer, and the method further includes: receiving only the new data in a first in, first out (FIFO) buffer; storing at least a portion of the new data in a reuse buffer; conveying all of the new data in the FIFO to the sliding window buffer; and concatenating the new data with the reuse data, such that the second working data is present in the sliding window buffer.

### Example 17

This example includes any or all of the features of example 16, and further includes discarding a first portion of the first working data from the sliding window buffer, such that a second portion of the first working data remains within the sliding window buffer, wherein: the concatenating includes linking the new data with the second portion of the first working data.

### Example 18

This example includes any or all of the features of example 17, wherein: defining the second sliding window includes applying a first offset to pixel coordinates of pixels included in the first working data, such that the second sliding window is offset from the first sliding window in a first direction; and the first portion of the first working data corresponds to the first offset.

### Example 19

This example includes any or all of the features of example 18, and further includes shifting the second portion of the first working data within the sliding window buffer by an amount that corresponds to the first offset.

### Example 20

This example includes any or all of the features of example 13, wherein the first and second feature detection operations are performed by a feature detection array, the feature detection array including a plurality of feature detection processors, wherein each of the plurality of feature detection processors is configured to perform the FAST operations on a respective one of the plurality of first candidate pixels or the second candidate pixels in parallel.

### Example 21

According to this example there is provided at least one computer readable medium including instructions for detecting features in a digital image, wherein the instructions when executed by a computing device result in performance of the following operations including: defining a first sliding window encompassing first working data, the first working data including a first portion of image data of the digital image; performing first feature detection operations on one or more first candidate pixels in the first working data in the sliding window buffer to classify whether the one or more first candidate pixels is or is not a feature; defining a second sliding window encompassing second working data, the second working data including reuse data and new data; and performing second feature detection operations on one or more second candidate pixels within the second working data to classify whether the one or more second candidate pixels is or is not a feature; wherein the reuse data includes a portion of the first working data, and the new data includes image data of the digital image that was not included in the first working data.

### Example 22

This example includes any or all of the features of example 21, wherein defining the second sliding window includes applying a first offset to pixel coordinates of pixels included in the first working data, such that the second sliding window is offset from the first sliding window in a first direction.

### Example 23

This example includes any or all of the features of example 22, wherein the first offset is selected from the group consisting of a vertical offset, a horizontal offset, and a diagonal offset.

### Example 24

This example includes any or all of the features of example 23, wherein the offset is a vertical offset and the reuse data includes vertical reuse data, the vertical reuse data being one or more pixel rows of the first working data.

### Example 25

This example includes any or all of the features of example 24, wherein:

the first feature detection operations are performed when the first working data is present in a sliding window buffer; the vertical reuse data is an uppermost or lowermost set of pixel rows of the first working data in the sliding window buffer; and defining the second sliding window includes concatenating an uppermost or lowermost pixel row of the new data with the vertical reuse data in the sliding window buffer, such that the second working data is present in the sliding window buffer.

### Example 26

This example includes any or all of the features of example 24, wherein:

the first feature detection operations are performed when the first working data is present in a sliding window buffer; and the vertical reuse data includes one or more pixel rows of the first working data stored in a reuse buffer; and defining the second sliding window includes concatenating an uppermost or lowermost pixel row of the new data with the vertical reuse data in the reuse buffer, such that the second working data is present in the sliding window buffer.

### Example 27

This example includes any or all of the features of example 23, wherein the first offset is a horizontal offset and the reuse data includes horizontal reuse data, the horizontal reuse data being one or more pixel columns of the first working data.

### Example 28

This example includes any or all of the features of example 27, wherein:

the first feature detection operations are performed when the first working data is present in a sliding window buffer; and the horizontal reuse data is a rightmost of leftmost set of pixel columns of the first working data in the sliding window buffer and defining the second sliding window includes concatenating a leftmost or rightmost pixel column of the new data with the horizontal reuse data in the sliding window buffer, such that the second working data is present in the sliding window buffer.

### Example 29

This example includes any or all of the features of example 27, wherein:

the first feature detection operations are performed when the first working data is present in a sliding window buffer; and the horizontal reuse data includes one or more pixel columns of the first working data stored in a reuse buffer; and defining the second sliding window includes concatenating a leftmost or rightmost pixel column of the new data with the horizontal reuse data in the reuse buffer, such that the second working data is present in the sliding window buffer.

### Example 30

This example includes any or all of the features of example 22, wherein: the first sliding window has a first sliding window width (SW1W) and a first sliding window height (SW1H); the first offset is a diagonal offset including a vertical offset component and a horizontal offset component; and at least one of the vertical offset component and the horizontal offset component is smaller than SW1H or SW1W, respectively.

### Example 31

This example includes any or all of the features of example 21, wherein defining the second sliding window includes: determining whether the first sliding window has reached a threshold position within the digital image; when the first sliding window has not reached the threshold position, applying a first offset to pixel coordinates of pixels included in the first working data, such that the second sliding window is offset from the first sliding window in a first direction; and when the first sliding window has reached the threshold position, applying a second offset to pixel coordinates of pixels included in the first working data, such that the second sliding window is offset from the first sliding window in a second direction that is different from the first direction.

### Example 32

This example includes any or all of the features of example 31, wherein the threshold position is selected from the group consisting of a threshold position along a vertical axis of the digital image (VAdepth), a threshold position along a horizontal axis of the digital image (HAwidth), an edge of the digital image, and combinations thereof.

### Example 33

This example includes any or all of the features of example 21, wherein: the first working data includes a plurality of first candidate pixels; the second working data includes a plurality of second candidate pixels that are different from the first candidate pixels; performing the first feature detection operations includes performing features from accelerated segment test (FAST) operations on each of the plurality of first candidate pixels, so as to classify each of the first candidate pixels as a feature or as not a feature; and performing the second feature detection operations includes performing FAST operations on each of the plurality of second candidate pixels, so as to classify each of the second candidate pixels as a feature or as not a feature.

### Example 34

This example includes any or all of the features of example 33, wherein the FAST operations comprise determining whether the one of the following relationships is met by a threshold number n of pixels on a periphery of a Bresenham circle bounding a candidate pixel: (1) I>Ip+t; or (2) I<Ip−t; wherein: I is an intensity of a pixel on the periphery of the Bresenham circle, Ip is an intensity of the single candidate pixel and t is a first threshold; and the single candidate pixel is classified as a feature only when a threshold number n of pixels on the periphery of the Bresenham circle satisfy relationship (1) or relationship (2).

### Example 35

This example includes any or all of the features of example 34, wherein when a candidate pixel is classified as a feature using a first threshold, t, the instructions when executed further result in performance of the following operations including: increasing the first threshold (t1) to a second threshold (t2); determining whether a threshold number n of pixels on the Bresenham circle satisfy relationship (1) or relationship (2) using the second threshold (t2); and when a threshold number n of pixels on the Bresenham circle do not satisfy relationship (1) or relationship (2) using the second threshold (t2); determining a strength score for the candidate pixel, the strength score indicating a degree of confidence with which the candidate pixel under consideration is a feature.

### Example 36

This example includes any or all of the features of example 21, wherein the first working data is present in a sliding window buffer, and the instructions when executed further result in the performance of the following operations including: receiving new data in a first in, first out (FIFO) buffer; and storing at least a portion of the new data in a reuse buffer; and conveying all of the new data in the FIFO to the sliding window buffer; and concatenating the new data with the reuse data, such that the second working data is present in the sliding window buffer.

### Example 37

This example includes any or all of the features of example 36, wherein the instructions when executed further result in performance of the following operations including: discarding a first portion of the first working data from the sliding window buffer, such that a second portion of the first working data remains within the sliding window buffer, wherein: the concatenating includes linking the new data with the second portion of the first working data.

### Example 38

This example includes any or all of the features of example 37, wherein: defining the second sliding window includes applying a first offset to pixel coordinates of pixels included in the first working data, such that the second sliding window is offset from the first sliding window in a first direction; and the first portion of the first working data corresponds to the first offset.

### Example 39

This example includes any or all of the features of example 38, wherein the instructions when executed further result in performance of the following operations including: shifting the second portion of the first working data within the sliding window buffer by an amount that corresponds to the first offset.

### Example 40

This example includes any or all of the features of example 39, wherein the first and second feature detection operations are performed by a feature detection array of the computing device, the feature detection array including a plurality of feature detection processors, wherein each of the plurality of feature detection processors is configured to perform the FAST operations on a respective one of the plurality of first candidate pixels or the second candidate pixels in parallel.

### Example 41

According to this example there is provided a simultaneous location and monitoring hardware accelerator (SLAM HWA), including: a feature detection component including: a sliding window buffer; and a sliding window controller; wherein: the sliding window controller is configured to: cause the performance of first feature detection operations on one or more first candidate pixels within first working data within the sliding window buffer to classify whether the one or more first candidate pixels is or is not a feature, the first working data including image data of a digital image encompassed by a first sliding window; define a second sliding window that is offset from the first sliding window encompasses second working data, the second working data including reuse data and new data; and cause the performance of second feature detection operations on one or more second candidate pixels within the second working data to classify whether the one or more second candidate pixels is or is not a feature; the reuse data includes a portion of the first working data; and the new data includes image data of the digital image that was not included in the first working data.

### Example 42

This example includes any or all of the features of example 41, wherein the sliding window controller is configured to define the second sliding window at least in part by applying a first offset to pixel coordinates of pixels included in the first working data, such that the second sliding window is offset from the first sliding window in a first direction.

### Example 43

This example includes any or all of the features of example 42, wherein the first offset is selected from the group consisting of a vertical offset, a horizontal offset, and a diagonal offset.

### Example 44

This example includes any or all of the features of example 43, wherein the offset is a vertical offset and the reuse data includes vertical reuse data, the vertical reuse data being one or more pixel rows of the first working data.

### Example 45

This example includes any or all of the features of example 44, wherein: the feature detection component further includes a feature detection array including a plurality of feature detection processors; the feature detection array is configured to perform the first feature detection operations when the first working data is present in a sliding window buffer; the vertical reuse data is an uppermost or lowermost set of pixel rows of the first working data in the sliding window buffer; and the sliding window controller is configured to cause an uppermost or lowermost pixel row of the new data to be concatenated with the vertical reuse data in the sliding window buffer, such that the second working data is present in the sliding window buffer.

### Example 46

This example includes any or all of the features of example 44, wherein: the feature detection component further includes a reuse buffer and a feature detection array including a plurality of feature detection processors; the feature detection array is configured to perform the first feature detection operations when the first working data is present in a sliding window buffer; and the vertical reuse data includes one or more pixel rows of the first working data stored in the reuse buffer; and the sliding window controller is configured to cause an uppermost or lowermost pixel row of the new data to be concatenated with the vertical reuse data in the reuse buffer, such that the second working data is present in the sliding window buffer.

### Example 47

This example includes any or all of the features of example 43, wherein the first offset is a horizontal offset and the reuse data includes horizontal reuse data, the horizontal reuse data being one or more pixel columns of the first working data.

### Example 48

This example includes any or all of the features of example 47, wherein: the feature detection component further includes a feature detection array including a plurality of feature detection processors; the feature detection array is configure to perform the first feature detection operations when the first working data is present in a sliding window buffer; and the horizontal reuse data is a rightmost of leftmost set of pixel columns of the first working data in the sliding window buffer; and the sliding window controller is configured to cause a leftmost or rightmost pixel column of the new data to be concatenated with the horizontal reuse data in the sliding window buffer, such that the second working data is present in the sliding window buffer.

### Example 49

This example includes any or all of the features of example 47, wherein: the feature detection array further includes a reuse buffer and a feature detection array including a plurality of feature detection processors; the feature detection array is configure to perform the first feature detection operations when the first working data is present in a sliding window buffer; the horizontal reuse data is a rightmost of leftmost set of pixel columns of the first working data in the reuse buffer and the sliding window controller is configured to cause a leftmost or rightmost pixel column of the new data with the horizontal reuse data in the reuse buffer, such that the second working data is present in the sliding window buffer.

### Example 50

This example includes any or all of the features of example 42, wherein: the first sliding window has a first sliding window width (SW1W) and a first sliding window height (SW1H); the first offset is a diagonal offset including a vertical offset component and a horizontal offset component; and at least one of the vertical offset component and the horizontal offset component is smaller than SW1H or SW1W, respectively.

### Example 51

This example includes any or all of the features of example 41, wherein the sliding window controller is further configured to: determine whether the first sliding window has reached a threshold position within the digital image; apply, when the first sliding window has not reached the threshold position, a first offset to pixel coordinates of pixels included in the first working data, such that the second sliding window is offset from the first sliding window in a first direction; and apply, when the first sliding window has reached the threshold position, a second offset to pixel coordinates of pixels included in the first working data, such that the second sliding window is offset from the first sliding window in a second direction that is different from the first direction.

### Example 52

This example includes any or all of the features of example 51, wherein the threshold position is selected from the group consisting of a threshold position along a vertical axis of the digital image (VAdepth), a threshold position along a horizontal axis of the digital image (HAwidth), an edge of the digital image, and combinations thereof.

### Example 53

This example includes any or all of the features of example 52, wherein: the first working data includes a plurality of first candidate pixels; the second working data includes a plurality of second candidate pixels that are different from the first candidate pixels; the SLAM HWA further includes a feature detection array including a plurality of feature detection processors, the feature detection array configured to perform the first feature detection operations and the second feature detection operations; the first feature detection operations comprise performing features from accelerated segment test (FAST) operations on each of the plurality of first candidate pixels, so as to classify each of the first candidate pixels as a feature or as not a feature; and the second feature detection operations includes performing FAST operations on each of the plurality of second candidate pixels, so as to classify each of the second candidate pixels as a feature or as not a feature.

### Example 54

This example includes any or all of the features of example 53, wherein the FAST operations comprise determining whether the one of the following relationships is met by a threshold number n of pixels on a periphery of a Bresenham circle bounding a candidate pixel: (1) I>Ip+t; or (2) I<Ip−t; wherein: I is an intensity of a pixel on the periphery of the Bresenham circle, Ip is an intensity of the single candidate pixel and t is a first threshold; and the single candidate pixel is classified as a feature only when a threshold number n of pixels on the periphery of the Bresenham circle satisfy relationship (1) or relationship (2).

### Example 55

This example includes any or all of the features of example 54, wherein when a candidate pixel is classified as a feature using a first threshold, t, at least one feature detection processor of the feature detection array is configured to: increase the first threshold (t1) to a second threshold (t2); determine whether a threshold number n of pixels on the Bresenham circle satisfy relationship (1) or relationship (2) using the second threshold (t2); and determine, when a threshold number n of pixels on the Bresenham circle do not satisfy relationship (1) or relationship (2) using the second threshold (t2), a strength score for the candidate pixel, the strength score indicating a degree of confidence with which the candidate pixel under consideration is a feature.

### Example 56

This example includes any or all of the features of example 41, wherein: the feature detection component further includes an address generator, a first in, first out (FIFO) buffer and a reuse buffer; and the sliding window controller is further configured to cause: the address generator to provide only the new data to the FIFO buffer; the storage of at least a portion of the new data in the reuse buffer; the provision of all of the new data in the FIFO to the sliding window buffer; and the new data to be concatenated with the reuse data, such that the second working data is present in the sliding window buffer.

### Example 57

This example includes any or all of the features of example 56, wherein: the sliding window buffer is configured, in response to receipt of a reuse control signal from the sliding window controller, to discard a first portion of the first working data, such that a second portion of the first working data remains within the sliding window buffer; and the sliding window controller is configured to cause the new data to be concatenated with the second portion of the first working data at least in part by linking the second portion of the first working data with the new data.

### Example 58

This example includes any or all of the features of example 57, wherein: the sliding window controller is configured to define the second sliding window at least in part by applying a first offset to pixel coordinates of pixels included in the first working data, such that the second sliding window is offset from the first sliding window in a first direction; and the first portion of the first working data corresponds to the first offset.

### Example 59

This example includes any or all of the features of example 57, wherein the sliding window buffer is further configured, in response to receipt of the reuse control signal, to shift the second portion of the first working data by an amount that corresponds to the first offset.

### Example 60

This example includes any or all of the features of example 53, wherein the feature detection array is configured to perform the FAST operations on the plurality of first candidate pixels or the plurality of second candidate pixels in parallel.

### Example 61

This example includes any or all of the features of example 40, and further includes a feature tracking component and a shared memory, wherein: the shared memory is communicatively coupled to the feature tracking component and the feature detection component; the feature detection component is configured to record one or more detected features in a detected feature list in the shared memory; and the feature tracking component is configured to: identify a selected feature for tracking the detected feature list; and track the selected feature in new image data received in the shared memory.

### Example 62

This example includes any or all of the features of example 61, wherein: the feature detection list includes a plurality of detected features, each of the detected features including pixel coordinates of a corresponding candidate pixel, the pixel coordinates including a vertical (y) coordinate and a horizontal (x) coordinate; the feature tracking component is configured to identify the selected feature for tracking based at least in part on the y coordinate of its coo responding candidate pixel.

### Example 63

This example includes any or all of the features of example 61, wherein: the feature tracking component is configured to track a plurality of features in the detected feature list in accordance with a selection order; and the selection order is based at least in part on an order in which the new image data is provided to the shared memory, an order in which detected features in the detected feature list are expected to occur in the new image data, the pixel coordinates of detected features within the detected feature list, or a combination thereof.

### Example 64

This example includes any or all of the features of example 61, wherein the feature tracking component is to track the selected feature using a normalized cross correlation (NCC) function.

### Example 65

This example includes any or all of the features of example 64, wherein the NCC function is an integer precision NCC function.

### Example 66

According to this example there is provided a computer implemented method for tracking features in image data, including: selecting a feature for tracking from a plurality of features stored in a feature detection list; determining a reference patch from the selected feature; determining a region of interest in new image data; performing feature detection operations to identify at least one test patch within the region of interest, the at least one test patch including a candidate pixel classified as a feature; comparing the reference patch to the test patch using a normalized cross correlation (NCC) so as to generate an NCC score, wherein the NCC score is indicative of a degree to which the reference patch and the test patch are similar.

### Example 67

This example includes any or all of the features of example 66, wherein: each of the a plurality of features stored in a feature detection list is associated with pixel coordinates of a corresponding single candidate pixel classified as a feature, the pixel coordinates including a vertical (Y) coordinate and a horizontal (X) coordinate; and selecting a feature for tracking includes selecting one of the plurality of features based at least in part on its corresponding Y coordinate.

### Example 68

This example includes any or all of the features of example 67, and further includes sorting the plurality of features in the feature detection list by their corresponding Y coordinate prior to selecting one of the plurality of features for tracking.

### Example 69

This example includes any or all of the features of example 66, and further includes: determining a predicted order in which detected features in the feature detection list are to appear in the new image data; determining a selection order based at least in part on the predicted order; and selecting one of the features for tracking based at least in part on the selection order.

### Example 70

This example includes any or all of the features of example 66, wherein the NCC function is selected from the group consisting of a floating point precision NCC function and an integer precision NCC function.

### Example 71

This example includes any or all of the features of example 70, wherein the NCC function is an integer precision NCC function.

### Example 72

This example includes any or all of the features of example 66, and further includes: comparing the NCC score to a score threshold; and when the NCC score is greater than or equal to the score threshold, identifying the test patch as corresponding to the selected feature for tracking.

### Example 73

According to this example there is provided at least one computer readable medium including instructions for tracking features in image data, wherein the instructions when executed by a computing device result in performance of the following operations including: selecting a feature for tracking from a plurality of features stored in a feature detection list; determining a reference patch from the selected feature; determining a region of interest in new image data; performing feature detection operations to identify at least one test patch within the region of interest, the at least one test patch including a candidate pixel classified as a feature; comparing the reference patch to the test patch using a normalized cross correlation (NCC) so as to generate an NCC score, wherein the NCC score is indicative of a degree to which the reference patch and the test patch are similar.

### Example 74

This example includes any or all of the features of example 73, wherein: each of the a plurality of features stored in a feature detection list is associated with pixel coordinates of a corresponding single candidate pixel classified as a feature, the pixel coordinates including a vertical (Y) coordinate and a horizontal (X) coordinate; and selecting a feature for tracking includes selecting one of the plurality of features based at least in part on its coordinate.

### Example 75

This example includes any or all of the features of example 74, wherein the instructions when executed further result in performance of the following operations including: sorting the plurality of features in the feature detection list by their corresponding Y coordinate prior to selecting one of the plurality of features for tracking.

### Example 76

This example includes any or all of the features of example 73, wherein the instructions when executed further result in performance of the following operations including: determining a predicted order in which detected features in the feature detection list are to appear in the new image data; determining a selection order based at least in part on the predicted order; and selecting one of the features for tracking based at least in part on the selection order.

### Example 77

This example includes any or all of the features of example 73, wherein the NCC function is selected from the group consisting of a floating point precision NCC function and an integer precision NCC function.

### Example 78

This example includes any or all of the features of example 77, wherein the NCC function is an integer precision NCC function.

### Example 79

This example includes any or all of the features of example 73, wherein the instructions when executed further result in performance of the following operations including: comparing the NCC score to a score threshold; and when the NCC score is greater than or equal to the score threshold, identifying the test patch as corresponding to the selected feature for tracking.

### Example 80

According to this example there is provided a simultaneous location and monitoring hardware accelerator (SLAM HWA), including: a shared memory; and a feature tracking component including detection element and a tracking element, the tracking element including a tracking controller and a tracking module; wherein: the tracking controller is configured to: select a feature for tracking from a plurality of features stored in a feature detection list in the shared memory determine reference patch from the selected feature for tracking; and determine a region of interest in new image data received within the shared memory; cause the detection element to perform feature detection operations to identify at least one test patch within the region of interest, the at least one test patch including a candidate pixel classified as a feature; and cause the tracking module to compare the reference patch to the test patch using a normalized cross correlation (NCC) function and to generate an NCC score, wherein the NCC score is indicative of a degree to which the reference patch and the test patch are similar.

### Example 81

This example includes any or all of the features of example 80, wherein: each of the a plurality of features stored in a feature detection list is associated with pixel coordinates of a corresponding single candidate pixel classified as a feature, the pixel coordinates including a vertical (Y) coordinate and a horizontal (X) coordinate; and the tracking controller is further configured to select the feature for tracking based at least in part on its corresponding Y coordinate.

### Example 82

This example includes any or all of the features of example 81, wherein the tracking controller is further configured to sort the plurality of features in the feature detection list by their corresponding Y coordinate prior to selecting one of the plurality of features for tracking.

### Example 83

This example includes any or all of the features of example 80, wherein the tracking controller is further configured to: determine a predicted order in which detected features in the feature detection list are to appear in the new image data; determine a selection order based at least in part on the predicted order; and select the feature for tracking based at least in part on the selection order.

### Example 84

This example includes any or all of the features of example 80, wherein the NCC function is selected from the group consisting of a floating point precision NCC function and an integer precision NCC function.

### Example 85

This example includes any or all of the features of example 84, wherein the NCC function is an integer precision NCC function.

### Example 86

This example includes any or all of the features of example 80, wherein the tracking module is further configured to: compare the NCC score to a score threshold; and when the NCC score is greater than or equal to the score threshold, identify the test patch as corresponding to the selected feature for tracking.

### Example 87

This example includes any or all of the features of example 78, wherein the tracking module includes: test patch normalization circuitry to calculate an integer precision normalized test patch; reference patch normalization circuitry to calculate an integer precision normalized reference patch; and scale division circuitry configured to: compute a integer scaled numerator term of a integer precision NCC function; compute an integer denominator term of the integer precision NCC function; and produce an integer NCC score by dividing the integer scaled numerator by the integer denominator.

### Example 88

According to this example there is provided at least one computer readable medium comprising instructions which when executed result in performance of the computer implemented method of any one of examples 1 to 20.

### Example 89

According to this example there is provided at least one computer readable medium comprising instructions which when executed result in performance of the computer implemented method of any one of examples 66 to 72.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. A computer implemented method for detecting features in a digital image, comprising the following computer implemented operations:
defining a first sliding window encompassing first working data, the first working data comprising a first portion of image data of the digital image;
performing first feature detection operations on one or more first candidate pixels in the first working data in the sliding window buffer to classify whether said one or more first candidate pixels is or is not a feature;
defining a second sliding window encompassing second working data, the second working data comprising reuse data and new data; and
performing second feature detection operations on one or more second candidate pixels within the second working data to classify whether said one or more second candidate pixels is or is not a feature;
wherein said reuse data comprises a portion of the first working data, and said new data comprises image data of the digital image that was not included in the first working data.

2. The computer implemented method of claim 1, wherein:
defining said second sliding window comprises applying a first offset to pixel coordinates of pixels included in the first working data, such that the second sliding window is offset from the first sliding window in a first direction; and
the first offset is selected from the group consisting of a vertical offset, a horizontal offset, and a diagonal offset.

3. The computer implemented method of claim 2, wherein:
the offset is a vertical offset and the reuse data comprises vertical reuse data, the vertical reuse data being one or more pixel rows of said first working data;
said first feature detection operations are performed when said first working data is present in a sliding window buffer;
said vertical reuse data is an uppermost or lowermost set of pixel rows of said first working data in said sliding window buffer; and
defining said second sliding window comprises concatenating an uppermost or lowermost pixel row of said new data with said vertical reuse data in said sliding window buffer, such that said second working data is present in said sliding window buffer.

4. The computer implemented method of claim 2, wherein:
the first offset is a horizontal offset and the reuse data comprises horizontal reuse data, the horizontal reuse data being one or more pixel columns of the first working data;
said first feature detection operations are performed when said first working data is present in a sliding window buffer; and
said horizontal reuse data is a rightmost of leftmost set of pixel columns of said first working data in said sliding window buffer and
defining said second sliding window comprises concatenating a leftmost or rightmost pixel column of said new data with said horizontal reuse data in said sliding window buffer, such that said second working data is present in said sliding window buffer.

5. The computer implemented method of claim 1, wherein defining said second sliding window comprises:
determining whether the first sliding window has reached a threshold position within the digital image;
when the first sliding window has not reached the threshold position, applying a first offset to pixel coordinates of pixels included in the first working data, such that the second sliding window is offset from the first sliding window in a first direction; and
when the first sliding window has reached the threshold position, applying a second offset to pixel coordinates of pixels included in the first working data, such that the second sliding window is offset from the first sliding window in a second direction that is different from the first direction.

6. The computer implemented method of claim 1, wherein:
the first working data includes a plurality of first candidate pixels;
the second working data includes a plurality of second candidate pixels that are different from the first candidate pixels;
performing said first feature detection operations comprises performing features from accelerated segment test (FAST) operations on each of said plurality of first candidate pixels, so as to classify each of the first candidate pixels as a feature or as not a feature; and
performing said second feature detection operations comprises performing FAST operations on each of said plurality of second candidate pixels, so as to classify each of the second candidate pixels as a feature or as not a feature.
wherein said FAST operations comprise determining whether the one of the following relationships is met by a threshold number n of pixels on a periphery of a Bresenham circle bounding a candidate pixel:
I>Iₚ+t; or (1)
I<Iₚ−t; (2)
wherein:
I is an intensity of a pixel on the periphery of the Bresenham circle, Iₚ is an intensity of the single candidate pixel and t is a first threshold; and
the single candidate pixel is classified as a feature only when a threshold number n of pixels on the periphery of the Bresenham circle satisfy relationship (1) or relationship (2).

7. The computer implemented method of claim 1, wherein said first working data is present in a sliding window buffer, and the method further comprises:
receiving only said new data in a first in, first out (FIFO) buffer; and
storing at least a portion of the new data in a reuse buffer; and
conveying all of the new data in the FIFO to the sliding window buffer; and
concatenating the new data with said reuse data, such that said second working data is present in said sliding window buffer.

8. The computer implemented method of claim 7, further comprising discarding a first portion of the first working data from the sliding window buffer, such that a second portion of the first working data remains within the sliding window buffer, wherein: the concatenating includes linking the new data with the second portion of the first working data.

9. A simultaneous location and monitoring hardware accelerator (SLAM HWA), comprising:
a feature detection component comprising:
a sliding window buffer; and
a sliding window controller;
wherein:
the sliding window controller is configured to:
cause the performance of first feature detection operations on one or more first candidate pixels within first working data within the sliding window buffer to classify whether said one or more first candidate pixels is or is not a feature, the first working data comprising image data of a digital image encompassed by a first sliding window;
define a second sliding window that is offset from the first sliding window encompasses second working data, the second working data comprising reuse data and new data; and
cause the performance of second feature detection operations on one or more second candidate pixels within the second working data to classify whether said one or more second candidate pixels is or is not a feature;
said reuse data comprises a portion of the first working data; and
said new data comprises image data of the digital image that was not included in the first working data.

10. The SLAM HWA of claim 9, wherein:
said sliding window controller is configured to define said second sliding window at least in part by applying a first offset to pixel coordinates of pixels included in the first working data, such that the second sliding window is offset from the first sliding window in a first direction; and
the first offset is selected from the group consisting of a vertical offset, a horizontal offset, and a diagonal offset.

11. The SLAM HWA of claim 10, wherein:
the offset is a vertical offset and the reuse data comprises vertical reuse data, the vertical reuse data being one or more pixel rows of said first working data;
the feature detection component further comprises a feature detection array comprising a plurality of feature detection processors;
the feature detection array is configured to perform said first feature detection operations when said first working data is present in a sliding window buffer;
said vertical reuse data is an uppermost or lowermost set of pixel rows of said first working data in said sliding window buffer; and
said sliding window controller is configured to cause an uppermost or lowermost pixel row of said new data to be concatenated with said vertical reuse data in said sliding window buffer, such that said second working data is present in said sliding window buffer.

12. The SLAM HWA of claim 11, wherein:
the feature detection component further comprises a reuse buffer and a feature detection array comprising a plurality of feature detection processors;
said feature detection array is configured to perform said first feature detection operations when said first working data is present in a sliding window buffer; and
said vertical reuse data comprises one or more pixel rows of said first working data stored in said reuse buffer; and
said sliding window controller is configured to cause an uppermost or lowermost pixel row of said new data to be concatenated with said vertical reuse data in said reuse buffer, such that said second working data is present in said sliding window buffer.

13. The SLAM HWA of claim 9, wherein:
the first offset is a horizontal offset and the reuse data comprises horizontal reuse data, the horizontal reuse data being one or more pixel columns of the first working data;
the feature detection component further comprises a feature detection array comprising a plurality of feature detection processors;
said feature detection array is configure to perform said first feature detection operations when said first working data is present in a sliding window buffer; and
said horizontal reuse data is a rightmost of leftmost set of pixel columns of said first working data in said sliding window buffer; and
said sliding window controller is configured to cause a leftmost or rightmost pixel column of said new data to be concatenated with said horizontal reuse data in said sliding window buffer, such that said second working data is present in said sliding window buffer.

14. The SLAM HWA of claim 13, wherein:
the feature detection array further comprises a reuse buffer and a feature detection array comprising a plurality of feature detection processors;
said feature detection array is configure to perform said first feature detection operations when said first working data is present in a sliding window buffer;
said horizontal reuse data is a rightmost of leftmost set of pixel columns of said first working data in said reuse buffer and
said sliding window controller is configured to cause a leftmost or rightmost pixel column of said new data with said horizontal reuse data in said reuse buffer, such that said second working data is present in said sliding window buffer.

15. The SLAM HWA of claim 9, wherein:
the first working data includes a plurality of first candidate pixels;
the second working data includes a plurality of second candidate pixels that are different from the first candidate pixels;
the SLAM HWA further comprises a feature detection array comprising a plurality of feature detection processors, the feature detection array configured to perform said first feature detection operations and said second feature detection operations;
said first feature detection operations comprise performing features from accelerated segment test (FAST) operations on each of said plurality of first candidate pixels, so as to classify each of the first candidate pixels as a feature or as not a feature; and
said second feature detection operations comprises performing FAST operations on each of said plurality of second candidate pixels, so as to classify each of the second candidate pixels as a feature or as not a feature.
wherein said FAST operations comprise determining whether the one of the following relationships is met by a threshold number n of pixels on a periphery of a Bresenham circle bounding a candidate pixel:
I>Iₚ+t; or (1)
I<Iₚ−t; (2)
wherein:
I is an intensity of a pixel on the periphery of the Bresenham circle, Iₚ is an intensity of the single candidate pixel and t is a first threshold; and
the single candidate pixel is classified as a feature only when a threshold number n of pixels on the periphery of the Bresenham circle satisfy relationship (1) or relationship (2).

16. The SLAM HWA of claim 9, wherein:
the feature detection component further comprises an address generator, a first in, first out (FIFO) buffer and a reuse buffer; and
the sliding window controller is further configured to cause:
the address generator to provide only said new data to said FIFO buffer;
the storage of at least a portion of the new data in the reuse buffer;
the provision of all of the new data in the FIFO to the sliding window buffer; and
the new data to be concatenated with said reuse data, such that said second working data is present in said sliding window buffer.

17. The SLAM HWA of claim 16, wherein:
the sliding window buffer is configured, in response to receipt of a reuse control signal from the sliding window controller, to discard a first portion of the first working data, such that a second portion of the first working data remains within the sliding window buffer; and
the sliding window controller is configured to cause the new data to be concatenated with said second portion of the first working data at least in part by linking the second portion of the first working data with the new data.

18. The SLAM HWA of claim 17, wherein:
the sliding window controller is configured to define said second sliding window at least in part by applying a first offset to pixel coordinates of pixels included in the first working data, such that the second sliding window is offset from the first sliding window in a first direction; and
the first portion of the first working data corresponds to the first offset.

19. The SLAM HWA of claim 17, wherein the sliding window buffer is further configured, in response to receipt of the reuse control signal, to shift the second portion of the first working data by an amount that corresponds to the first offset.

20. The SLAM HWA of claim 16, wherein the feature detection array is configured to perform said FAST operations on said plurality of first candidate pixels or said plurality of second candidate pixels in parallel.

21. The SLAM HWA of claim 9, further comprising a feature tracking component and a shared memory, wherein:
the shared memory is communicatively coupled to the feature tracking component and the feature detection component;
the feature detection component is configured to record one or more detected features in a detected feature list in said shared memory; and
the feature tracking component is configured to:
identify a selected feature for tracking said detected feature list; and
track said selected feature in new image data received in said shared memory.

22. The SLAM HWA of claim 21, wherein:
said feature detection list comprises a plurality of detected features, each of the detected features comprising pixel coordinates of a corresponding candidate pixel, the pixel coordinates including a vertical (y) coordinate and a horizontal (x) coordinate;
the feature tracking component is configured to identify the selected feature for tracking based at least in part on the y coordinate of its coo responding candidate pixel.

23. The SLAM HWA of claim 21, wherein:
said feature tracking component is configured to track a plurality of features in said detected feature list in accordance with a selection order; and
the selection order is based at least in part on an order in which the new image data is provided to the shared memory, an order in which detected features in the detected feature list are expected to occur in the new image data, the pixel coordinates of detected features within the detected feature list, or a combination thereof.

24. The SLAM HWA of claim 21, wherein said feature tracking component is to track said selected feature using a normalized cross correlation (NCC) function.

25. The SLAM HWA of claim 24, wherein said NCC function is an integer precision NCC function.
